(19) United States
(12) Patent Application Publication
(10) Pub. No.: US 2026/0336111 A1
(43) Pub. Date: Oct. 29, 2026

(54) SYSTEMS, METHODS, APPARATUSES, AND DEVICES FOR PERFORMING TASKS USING SKILL SHARING

(71) Applicant: Prasad Prafull Karnik, Ladera Ranch, CA (US)

(72) Inventor: Prasad Prafull Karnik, Ladera Ranch, CA (US)

(21) Appl. No.: 19/657,004

(22) Filed: Apr. 24, 2026

Related U.S. Application Data
(60) Provisional application No. 63/793,712, filed on Apr. 24, 2025.

(51) Int. Cl. B25J 9/16

(52) U.S. Cl. CPC B25J 9/1661; B25J 9/163

(57) ABSTRACT

A method for performing tasks using skill sharing. The method include detecting, using sensors, an environment of robotic assistance devices, obtaining, using a processing device, sensor inputs from the sensors, obtaining, using the processing device, control logic data of control logics associated with a task, adapting, using the processing device, the control logic data based on the sensor inputs, generating, using the processing device, task command data associated with the task based on the adapting and the detecting, actuating, using one or more actuators, mechanical appendages of the robotic assistance devices based on the task command data, and performing, using the one or more mechanical appendages, one or more task operations associated with the task based on the actuating of the mechanical appendages.

### REFERENCE TO RELATED APPLICATIONS

This application claims the benefit of U.S. Provisional Patent Application No. 63/793,712, titled “Robotic Assistance Devices Facilitating Performance of a Manipulation Task”, filed Apr. 24, 2025, which is incorporated by reference herein in its entirety.

### FIELD OF DISCLOSURE

The present disclosure relates to robots. More specifically, the present disclosure relates to systems, methods, apparatuses, and devices for performing tasks using skill sharing.

### BACKGROUND

Robotic systems are often configured for a specific hardware platform, workspace arrangement, and sensing configuration. As a result, a task representation produced for one platform may be unsuitable for direct use on another platform having different geometry, different sensing modalities, different end-effectors, different workspace constraints, or different environmental conditions. In many existing workflows, a human engineer manually reprograms or retunes the transferred behavior to account for those differences. This can increase deployment time, reduce repeatability, and make large-scale use of robotic task transfer difficult.

Another issue in existing systems is that the information used to create or refine robotic behavior is frequently incomplete, inconsistently structured, or difficult to reuse. A demonstration recording, a teleoperation trace, a narrated procedure, a perception stream, or a virtual authoring session may all contain useful task information, but such information is commonly stored in source-specific formats that are difficult to normalize into a common representation suitable for automated adaptation and validation. Without a common machine-usable representation, downstream robotic systems may have difficulty determining required objects, required tools, expected completion states, acceptable tolerances, or safety conditions.

Existing systems may also provide limited support for reproducibility and controlled iteration. When a robot task fails, degrades, or must be modified for a new environment, it is often difficult to determine which inputs, assumptions, parameter settings, or code changes caused the result. Similarly, some systems lack structured support for validation, rollback, promotion of trusted versions, or comparison of performance across successive task revisions. These limitations can impede safe deployment and make improvement of robot-executable artifacts more difficult.

Given these limitations, there is a clear need for systems that can seamlessly adapt to dynamic environments, allowing for efficient navigation, precise task execution, and robust handling of unexpected changes. The development of such systems would enhance the usability and effectiveness of automation in various settings, addressing the shortcomings of current technologies and providing more reliable solutions for users.

Therefore, there is a need for improved systems, methods, apparatuses, and devices for performing tasks using skill sharing for performing tasks using skill sharing that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a system for performing tasks using skill sharing. Further, the system may include one or more robotic assistance devices. Further, one or more robotic assistance devices may include a body. Further, one or more robotic assistance devices may include one or more sensors coupled to the body. Further, the one or more sensors may be configured for detecting an environment of the one or more robotic assistance devices. Further, one or more robotic assistance devices may include a processing device coupled to the body. Further, the processing device may be communicatively coupled with the one or more sensors. Further, the processing device may be further configured for obtaining one or more sensor inputs from the one or more sensors. Further, the processing device may be further configured for obtaining one or more control logic data of one or more control logics associated with a task. Further, the processing device may be further configured for adapting the one or more control logic data based on the one or more sensor inputs. Further, the processing device may be further configured for generating a task command data associated with the task based on the adapting and the detecting. Further, one or more robotic assistance devices may include one or more mechanical appendages coupled to the body. Further, the one or more mechanical appendages may be configured for performing one or more task operations associated with the task. Further, one or more robotic assistance devices may include one or more actuators coupled to the body. Further, the one or more actuators may be operatively coupled with the one or more mechanical appendages. Further, the one or more actuators may be configured for actuating the one or more mechanical appendages based on the task command data. Further, the performing of the one or more task operations may be based on the actuating of the one or more mechanical appendages.

The present disclosure provides a method for performing tasks using skill sharing. Further, the method may include detecting, using one or more sensors, an environment of one or more robotic assistance devices. Further, the method may include obtaining, using a processing device, one or more sensor inputs from the one or more sensors. Further, the method may include obtaining, using the processing device, one or more control logic data of one or more control logics associated with a task. Further, the method may include adapting, using the processing device, the one or more control logic data based on the one or more sensor inputs. Further, the method may include generating, using the processing device, a task command data associated with the task based on the adapting and the detecting. Further, the method may include actuating, using one or more actuators, one or more mechanical appendages of the one or more robotic assistance devices based on the task command data. Further, the method may include performing, using the one or more mechanical appendages, one or more task operations associated with the task based on the actuating of the one or more mechanical appendages.

The present disclosure provides a non-transitory computer-readable medium storing instructions for performing tasks using skill sharing. Further, the instructions, when executed by a processing device of one or more robotic assistance devices, cause the processing device to obtain one or more sensor inputs from one or more sensors coupled to a body of the one or more robotic assistance devices. Further, the one or more sensors may be configured for detecting an environment of the one or more robotic assistance devices. Further, the instructions, when executed by a processing device of one or more robotic assistance devices, cause the processing device to obtain one or more control logic data of one or more control logics associated with a task. Further, the instructions, when executed by a processing device of one or more robotic assistance devices, cause the processing device to adapt the one or more control logic data based on the one or more sensor inputs. Further, the instructions, when executed by a processing device of one or more robotic assistance devices, cause the processing device to generate task command data associated with the task based on the adapting and the detecting of the environment. Further, the instructions, when executed by a processing device of one or more robotic assistance devices, cause the processing device to control one or more actuators coupled to the body and operatively coupled with one or more mechanical appendages coupled to the body to actuate the one or more mechanical appendages based on the task command data. Further, one or more task operations associated with the task may be performed based on the actuating of the one or more mechanical appendages.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate the explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram of a machine-learning system 300 for implementing various embodiments of this disclosure, in accordance with some embodiments.

FIG. 4 illustrates a front view of a robotic assistance device 400, in accordance with some embodiments.

FIG. 5 illustrates a top view of the robotic assistance device 400, in accordance with some embodiments.

FIG. 6 illustrates a first configuration associated with the attachment of one or more mechanical appendages 606 in a robotic assistance device 600, in accordance with some embodiments.

FIG. 7 illustrates a second configuration associated with the attachment of one or more mechanical appendages 704 in a robotic assistance device 700, in accordance with some embodiments.

FIG. 8 illustrates a robotic assistance device 800, in accordance with some embodiments.

FIG. 9 illustrates a task command generation flow 900 associated with robotic assistance devices, in accordance with some embodiments.

FIG. 10 illustrates a ROS code generation flow 1000 associated with robotic assistance devices, in accordance with some embodiments.

FIG. 11 illustrates a closed-loop grasping feedback flow 1100 associated with robotic assistance devices, in accordance with some embodiments.

FIG. 12A illustrates a block diagram of a system 1200 for performing tasks using skill sharing, in accordance with some embodiments.

FIG. 12B illustrates a block diagram of one or more robotic assistance devices 1202 included in the system 1200 for performing tasks using skill sharing, in accordance with some embodiments.

FIG. 13 illustrates a block diagram of the system 1200 for performing tasks using skill sharing, in accordance with some embodiments.

FIG. 14 illustrates a block diagram of the system 1200 for performing tasks using skill sharing, in accordance with some embodiments.

FIG. 15 illustrates a flowchart of a method 1500 for performing tasks using skill sharing, in accordance with some embodiments.

FIG. 16 illustrates a governed skill-transfer kernel, in accordance with some embodiments.

FIG. 17 illustrates a skill-package and event-log structure, in accordance with some embodiments.

FIG. 18 illustrates a media/documentation ingestion flow, in accordance with some embodiments.

FIG. 19 illustrates a validation-gate flow, in accordance with some embodiments.

FIG. 20 illustrates a versioned lifecycle, in accordance with some embodiments.

FIG. 21 illustrates offline media and QR/NFC pointer transfer, in accordance with some embodiments.

FIG. 22 illustrates a cooperative multi-robot execution flow, in accordance with some embodiments.

FIG. 23 illustrates a managed-ecosystem flow, in accordance with some embodiments.

FIG. 24 illustrates robot-to-human training, monitoring, and write-back, in accordance with some embodiments.

FIG. 25 illustrates an imaging-guided procedure flow, in accordance with some embodiments.

FIG. 26 illustrates a skill-kit and challenge-suite flow, in accordance with some embodiments.

FIG. 27 illustrates dual-camera endpoint computation and occlusion handling, in accordance with some embodiments.

FIG. 28 illustrates a pushback or resistance safety flow, in accordance with some embodiments.

FIG. 29 illustrates a tooling and attachment flow, in accordance with some embodiments.

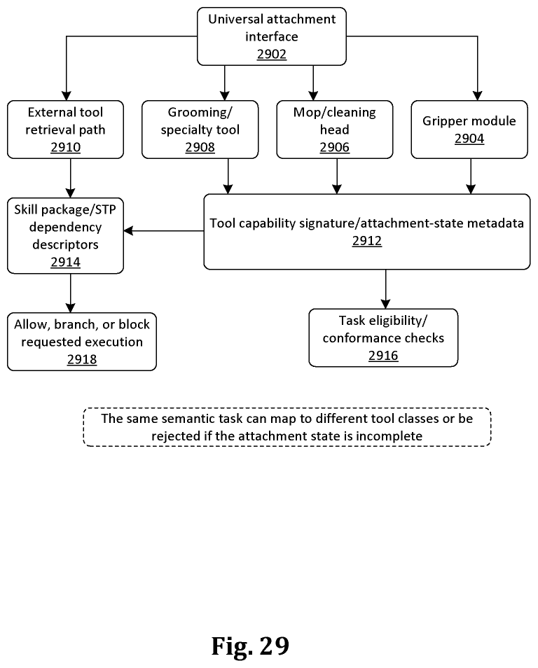

FIG. 30 illustrates a hardware-profile summary, in accordance with some embodiments.

FIG. 31 illustrates hybrid-source skill formation with provenance-aware merge, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one,” and/or “one or more,” but do not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems, computing devices, or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, computing devices, electronic devices, or computational circuits that manipulate such signals in memory elements, registers, buffers, or storage media.

The disclosure contemplates implementations in which artificial intelligence systems perform perception, synthesis, inference, prediction, or generation of information and/or data using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. The model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and checkpointing of intermediate states. Training datasets may include real-world data, synthetic data (i.e., data artificially generated rather than directly collected from physical real-world observation), simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions, including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. The computing device may include these storage systems. Storage media may contain instructions, configurations, or data structures that, when accessed by the computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through application programming interfaces (APIs). Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of, indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The machine learning models may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce the variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment that may include a combination of client devices, servers, distributed computing clusters, databases, external data sources, network nodes, and interface endpoints. Further, the computing environment may support artificial intelligence workloads, including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Machine learning models may adjust their internal parameters through supervised, unsupervised, or reinforcement-based processes, allowing automatic electronic improvements to their performance based on input data and observed outcomes.

Further, the disclosure provides a machine-learning architecture that may include engines or modules such as a data input engine, a data retrieval engine, a data transform engine, a featurization engine, a modeling engine, a generative engine, a validation engine, a feedback engine, and a refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation which may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols, including HTTP, HTTPS, MQTT, CoAP, or any other suitable communication framework. Communication channels may include local networks, wide-area networks, personal-area networks, or global communication systems, potentially utilizing secure, encrypted sessions such as SSL-based channels.

Further, the disclosure may provide an algorithm, process, or flow diagram that may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, system performance, or configuration parameters.

Further, the described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings, therefore, provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices may include computing platforms equipped with data processing hardware and memory hardware. The servers may include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior. Further, the system includes a modeling engine that manages one or more training processes for one or more models. Moreover, the modeling engine can select model architectures, initialize parameters, and apply training algorithms such as supervised learning, semi supervised learning, unsupervised learning, reinforcement learning, or combinations thereof. The modeling engine can also manage hyperparameters, training schedules, and evaluation procedures across epochs or passes through the data. Further, the system may include a generative response engine or an inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria. Further, the system may include a feedback engine that collects explicit or implicit feedback signals, such as user ratings, corrective edits, or outcome metrics derived from downstream tasks. Furthermore, the system may include a refinement engine that uses the feedback to adjust model parameters, routing logic, or policies, for example, by performing additional training steps, updating reward models, or modifying configuration parameters.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer readable media. Program instructions, when executed by the processors, cause the processors to perform the operations described herein.

Instructions can be delivered to computing devices in various ways, such as pre-installation, physical distribution of media, or transmission over networks. Instructions received over a network can be stored in memory or persistent storage and then executed by one or more processors. Dedicated hardware logic, such as application-specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation-specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated.

In general, the method(s) disclosed herein may be performed by at least one computing device. Further, the at least one computing device may be and/or may include at least one server (i.e., at least one server computer). Further, the at least one computing device may be and/or may include a communication device, a processing device, and a storage device. For example, in some embodiments, the method may be performed by the at least one server in communication with at least one client device over a communication network such as, for example, the Internet. In some other embodiments, the method may be performed by one or more of at least one server computer, at least one client device, at least one network device, at least one sensor, and at least one actuator. Examples of the at least one client device, and/or the at least one server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on.

### Overview

The present disclosure describes a system for transferring robotic skills. Further, the system may include a communication interface. Further, the system may include one or more processors and a memory storing instructions that, when executed by the one or more processors, cause the one or more processors to obtain, from at least one skill source, an input representing a multi-step task. Further, the instructions, when executed, cause the one or more processors to generate, based on the input, a skill package representing the multi-step task. Further, the skill package may include an executable or interpretable task representation and associated metadata. Further, the instructions, when executed, further cause the one or more processors to provide, via the communication interface, the skill package for use by at least one destination robotic device comprising at least one actuation subsystem. Further, the instructions, when executed, further cause the one or more processors to adapt the skill package at the at least one destination robotic device using destination-local data to generate an adapted version. Further, prior to executing the adapted version, the one or more processors may perform one or more gating operations according to a gating policy associated with the skill package. Further, the execution is blocked unless one or more gating criteria are satisfied. Further, the instructions, when executed, further cause the one or more processors to execute the adapted version by controlling the at least one actuation subsystem of the at least one destination robotic device.

Further, in some embodiments, the instructions, when executed, further cause the one or more processors to store, in association with a version of the skill package, an event log representing a time ordered sequence of events and an event-log schema identifier defining fields, units, and semantics for entries in the event log. Further, the event log may include time-aligned events associated with at least one modality selected from:
Natural-language or Narration.
Gesture input.
Teleoperation commands.
Assistive-input signals.
Augmented-reality or virtual-reality authoring events.
Virtual-world interaction events.
Perception-derived object tracking or environment mapping.

Further, in some embodiments, the at least one destination robotic device comprises one or more sensor subsystems comprising at least one perception sensor. Further, generating the skill package comprises generating, based on the input and sensor data associated with the multi-step task, a structured task plan (STP) representing the multi-step task and comprising one or more parameter slots, generating, from the STP, a task-specific control logic artifact executable to perform the multi-step task, and packaging the task-specific control logic artifact into the skill package. Further, the STP comprises at least one or more object/action pairs, one or more parameter ranges or tolerances, one or more safety criteria associated with at least one step of the multi-step task, and one or more completion criteria associated with at least one step of the multi-step task.

Further, in some embodiments, the system comprises a repository interface for publishing and retrieving skill packages to and from a version-controlled repository. Further, the instructions, when executed, further cause the one or more processors to publish the skill package to the version-controlled repository via the repository interface and to publish, via the repository interface, an update associated with the skill package. Further, publishing the update comprises storing a patch or delta for transforming a parent version into a child version, and storing, in association with the patch or delta, a build manifest comprising at least an input hash for the parent version, a target domain identifier, and an output hash for the child version.

Further, in some embodiments, the system may be implemented as a robotics skill platform configured for creating, packaging, validating, deploying, executing, monitoring, refining, and governing reusable robotic skills across one or more robotic systems. In some embodiments, the platform includes one or more source endpoints, one or more destination robotic devices, and optionally one or more repository, registry, governance, translation, evaluation, or deployment services. Further, a source endpoint may include, by way of non-limiting example, a robot, operator station, developer workstation, teleoperation system, simulation environment, content repository, documentation source, or other system that provides input representing a multi-step task. Further, a destination robotic device may execute locally at the edge using onboard computer and local sensor data, including in disconnected, delay-tolerant, or intermittently connected operating conditions.

Further, in some embodiments, the platform includes a skill-control plane configured to manage reusable robotic skills as governed software assets. Further, the skill-control plane may create, store, version, publish, retrieve, adapt, gate, execute, score, promote, demote, roll back, freeze, or otherwise govern skill packages and related artifacts across a plurality of robotic devices and environments. In some embodiments, skill packages are stored, versioned, published, retrieved, and updated through a repository interface. Further, the repository may operate as a local or remote registry, marketplace, synchronization service, or version-controlled skill library that supports fleet deployment, rollback, refinement, promotion, demotion, scoring, convergence analysis, evidence retention, entitlement enforcement, or selective propagation of updates. Further, the transferable representation may therefore be reused across multiple robotic devices rather than remaining bound to a single robot or a single environment.

Further, in some embodiments, the platform includes a model-control plane configured to manage one or more machine-learning and/or generative artificial intelligence models used by the robotics skill platform. Such models may be used for one or more of perception, segmentation, grounding, object or region binding, task-plan generation, code-artifact generation, clarification generation, simulation, safety evaluation, challenge-suite generation, recovery-policy generation, execution-time policy selection, or post-execution analysis. In some embodiments, the model-control plane stores, versions, evaluates, promotes, demotes, rolls back, distills, quantizes, compiles, deploys, or otherwise governs one or more models, prompts, adapters, embeddings, evaluators, calibration configurations, or runtime configurations, and associates such models with one or more skill packages, execution policies, environment classes, robot classes, or deployment profiles.

Further, in some embodiments, the robotics skill platform may be configured to transform demonstrations, teleoperation traces, event logs, recorded or streamed media assets, documentation assets, clarification interactions, simulation traces, challenge-suite outputs, execution outcomes, anomaly classifications, user corrections, and evidence bundles into one or more versioned training, fine-tuning, validation, calibration, or benchmarking datasets. Such datasets may be filtered, labeled, de-identified, segmented, ranked, or grouped according to robot class, end-effector class, tool class, environment class, task type, risk tier, object category, performance outcome, or source provenance. In some embodiments, one or more such datasets may be used to train, fine-tune, calibrate, benchmark, distill, quantize, or otherwise improve one or more models associated with skill formation, skill adaptation, skill validation, or skill execution.

Further, in some embodiments, the transferable skill representation may be associated with one or more machine-readable dependency records identifying one or more required or optional models, prompts, adapters, embeddings, calibration configurations, tool profiles, or evaluator assets used for skill formation, validation, or execution. In some embodiments, the platform applies one or more pre-execution, pre-deployment, or pre-promotion checks, including validation, conformance, integrity, authorization, entitlement, simulation, approval, trust, compatibility, or safety checks. In some embodiments, the platform uses machine-readable metadata including one or more of environment fingerprints, capability signatures, hardware profiles, validation outputs, evidence bundles, execution-rights tokens, binding receipts, build manifests, policy identifiers, model dependencies, prompts, or lineage mappings to determine whether execution should be allowed, degraded, sandboxed, quarantined, denied, delayed, or rerouted, including whether such dependencies are present, compatible, authorized, and appropriate for a requested task, environment class, hardware profile, risk tier, or deployment profile.

Further, in some embodiments, the platform supports a developer ecosystem in which third-party developers, robot manufacturers, integrators, enterprise operators, or platform owners publish, retrieve, certify, sandbox, score, license, promote, demote, revoke, or roll back skills, modules, prompts, adapters, models, simulation packs, challenge suites, test policies, or tool profiles through one or more documented interfaces. Such assets may declare required sensors, actuators, tool classes, runtime dependencies, permissions, safety policies, validation tests, hardware requirements, model requirements, or entitlement conditions, and may be selectively admitted for execution only after required gating conditions are satisfied.

Further, in some embodiments, the platform supports fleet-level write-back and continuous improvement. Execution evidence, measured outcomes, anomaly classifications, parameter updates, control-artifact deltas, model-related updates, or policy updates may be collected from a plurality of robotic devices and used to support scoring, promotion, demotion, rollback, convergence detection, freeze-state determination, model reconfiguration, skill refinement, or selective propagation of changes across one or more robots, customers, tenants, or managed robotic ecosystems. In some embodiments, updates may be propagated at the level of skill packages, parameter templates, control artifacts, prompts, models, safety policies, or combinations thereof.

Further, in some embodiments, the platform supports deployment of both skill artifacts and associated models to one or more target runtimes, including edge processors, robot controllers, embedded accelerators, cloud services, hybrid control architectures, or combinations thereof. Deployment may include selection, compilation, translation, or generation of a target-specific artifact according to latency budget, compute budget, memory budget, power state, privacy policy, communication availability, robot hardware profile, or safety policy, while preserving portable lineage and execution governance for later audit, rollback, or re-deployment.

Further, in some embodiments, the platform provides a technical framework in which information associated with a task is converted into a machine-usable skill representation that preserves both executable content and supporting metadata, and in which one or more associated machine-learning or generative-artificial-intelligence assets may be linked to, evaluated with, and governed together with the skill representation. Further, the skill representation may then be delivered to one or more robotic systems for local adaptation and execution. In some embodiments, the local robotic system does not merely consume the representation in unchanged form, but instead evaluates local observations, local hardware characteristics, local model availability, local execution constraints, and one or more gating or validation stages before producing device-specific command outputs. Execution is thereby conditioned on compatibility, safety, policy, and governance requirements, reducing unsafe, incompatible, or under-validated robotic execution.

Further, in some embodiments, the one or more gating operations comprise a validation gate that blocks execution unless one or more validation checks pass. Further, the one or more validation checks comprise at least two checks selected from: parameter completeness, workspace reachability, collision checking, force or torque limit checking, end-effector compatibility checking, sensor availability checking, proximity-risk checking including detection of at least one person or animal within a safety envelope, pushback or resistance anomaly checking during commanded motion, or trajectory-safety checking.

Further, in some embodiments, the at least one destination robotic device comprises a plurality of destination robotic devices. Further, adapting the skill package may include decomposing the STP into subtasks for cooperative execution by the plurality of destination robotic devices based on destination-local capability data and local state data. Further, adapting the skill package may include defining one or more synchronization points among the subtasks. Further, adapting the skill package may include applying a coordination contract specifying at least one policy for desynchronization or communication loss. Further, the one or more gating operations comprise, for each subtask prior to activation, a conformance check that verifies capability compatibility and safety constraints. Further, executing the adapted version comprises cooperative execution of the subtasks by the plurality of destination robotic devices under a shared safety envelope.

Further, in some embodiments, the input representing the multi-step task comprises a recorded or streamed media asset retrieved from a remote content platform or media repository. Further, the generating of the skill package includes extracting, from the media asset, a time-aligned event trace comprising at least one of operator actions, object-state transitions, or step markers. Further, the generating of the skill package includes deriving, from the time-aligned event trace, a task representation comprising explicit step sequencing and termination criteria. Further, the generating of the skill package includes generating the skill package from the derived task representation for adaptation and gated execution at the at least one destination robotic device.

Further, in some embodiments, the instructions, when executed, further cause the one or more processors to determine that a parameter slot of the STP fails a confidence criterion based on at least one of an uncertainty measure associated with binding the parameter slot or disagreement among candidate bindings derived from different modalities of the input and the sensor data. Further, the instructions, when executed, further cause the one or more processors to generate a targeted clarification question corresponding to the parameter slot. Further, the instructions, when executed, further cause the one or more processors to receive a clarification response. Further, the instructions, when executed, further cause the one or more processors to bind the parameter slot based on the clarification response. Further, the instructions, when executed, further cause the one or more processors to update a task-specific control logic artifact using a patch or delta and re-perform a validation gate prior to execution.

Further, in some embodiments, the skill package may further include an environment fingerprint or environment metadata describing at least a portion of an environment in which at least one of the skill package or an executable control logic artifact was generated or validated. Further, the environment fingerprint comprises a hashed representation of one or more environment descriptors derived from sensor data. Further, the skill package may further include a capability signature indicating required execution capabilities. Further, the one or more gating operations comprise a conformance test that blocks execution when a conformance test result indicates incompatibility with the capability signature.

Further, in some embodiments, the instructions, when executed, further cause the one or more processors to generate performance metric data for execution of the adapted version by comparing one or more measured outcomes to one or more success criteria specified by a test protocol of the skill package. Further, the instructions, when executed, further cause the one or more processors to publish, to the version-controlled repository, an update associated with the skill package comprising at least one of:
An error classification selected from an error taxonomy.
A patch or delta for transforming a parent version into a child version, or
An update to at least one parameter binding or at least one parameter range,
Further, the update indicates a promotion state or a demotion state for the child version and enables rollback to the parent version.

Further, in some embodiments, the instructions, when executed, further cause the one or more processors to iteratively repeat adaptation and publishing of updates across a plurality of robotic devices to produce successive versions, assign a score to at least one version based on aggregated performance metric data, retroactively update a score of a parent version based on descendant performance, and store an indication that one or more parameter ranges have converged based on changes between successive versions falling below a threshold. Further, the indication of convergence comprises storing a freeze state that requires elevated approval or elevated validation to modify a converged parameter range.

Further, in some embodiments, promoting the child version to a trusted state comprises validating the child version using a simulation regression suite derived from parameter ranges of a parameter template corresponding to one or more parameter slots, the simulation regression suite configured to emulate at least a portion of an environment of a destination robotic device before executing the child version on hardware or before publishing the child version as trusted. Further, the validating comprises storing an evidence bundle comprising:
Reproducibility metadata indicating at least one of a simulator identifier, a simulator version, a physics profile identifier, or a random seed value.
A minimal reproduction bundle comprising at least a reduced scenario description and a trace segment configured to reproduce a failure condition.

Further, in some embodiments, the instructions, when executed, further cause the one or more processors to classify at least one step of the multi-step task as high-risk based on a safety policy and to require human approval prior to executing the high-risk step or prior to promoting a version to a trusted state.

Further, in some embodiments, the at least one destination robotic device comprises a mechanical appendage and the one or more sensor subsystems comprise at least two cameras mounted at different positions relative to the at least one destination robotic device. Further, the instructions, when executed, further cause the one or more processors to compute updated endpoint coordinates for the mechanical appendage based on image-space measurements from images captured by the at least two cameras and based on one or more measured camera-position parameters associated with the at least two cameras, and to store the updated endpoint coordinates as a parameter binding for a parameter slot of the STP.

Further, in some embodiments, the instructions, when executed, further cause the one or more processors to submit, to a distribution service or governance service associated with a managed robotic ecosystem, at least one of the skill package or a source task representation for platform acceptance and deployment authorization. Further, the instructions, when executed, further cause the one or more processors to receive, from the distribution service or governance service, platform-accepted deployment data comprising at least one of a platform-bound execution package, a platform compatibility determination, one or more platform-required constraints, and a deployment authorization state. Further, prior to execution at the at least one destination robotic device, enforce, as part of the one or more gating operations according to the gating policy associated with the skill package, one or more platform-required constraints including at least one of a deployment constraint or an execution constraint, and block execution when a required platform acceptance, compatibility, deployment authorization, or constraint condition is unsatisfied.

Further, in some embodiments, the platform-accepted deployment data comprises at least one acceptance credential selected from an execution-rights token, a signed binding receipt, a package integrity hash mapping, or a platform attestation record. Further, enforcing the one or more platform-required constraints as part of the one or more gating operations comprises verifying validity and scope of the at least one acceptance credential prior to execution and blocking execution when required verification fails.

In some embodiments, the present disclosure describes a method for transferring and executing robotic skills. Further, the method may include obtaining, from at least one skill source, an input representing a multi-step task. Further, the method may include generating, based on the input, a skill package representing the multi-step task. Further, the skill package comprises an executable or interpretable task representation and associated metadata. Further, the method may include providing the skill package for use by at least one destination robotic device comprising at least one actuation subsystem. Further, the method may include adapting, at the at least one destination robotic device, the skill package using destination-local data to generate an adapted version. Further, prior to executing the adapted version, performing one or more gating operations according to a gating policy associated with the skill package. Further, execution is blocked unless one or more gating criteria are satisfied. Further, the method may include executing the adapted version by controlling the at least one actuation subsystem of the at least one destination robotic device.

Further, in some embodiments, the generating of the skill package further comprises storing, in association with a version of the skill package, an event log representing a time-ordered sequence of events and an event-log schema identifier defining fields, units, and semantics for entries in the event log. Further, adapting the skill package at the at least one destination robotic device comprises treating one or more parameter bindings included in the event log as non-authoritative hints, rebinding one or more parameter slots using destination-local perception data, and re-performing the one or more gating operations prior to execution.

Further, in some embodiments, the method may include receiving the skill package at the destination robotic device from a portable storage medium in an offline operating state without network connectivity. Further, the method may include performing, using locally cached trust material, integrity verification, conformance testing, and the one or more gating operations prior to execution. Further, the method may include executing the adapted version only after successful completion of the performing. Further, first execution is constrained by at least one of sandboxed execution or conservative speed/force limits. Further, the method may include storing execution evidence locally for later asynchronous upload when connectivity is restored.

Further, in some embodiments, the method may include receiving, at a destination endpoint, a pointer token conveyed via a machine-readable medium comprising at least one of a QR code or a near-field communication (NFC) payload, the pointer token referencing the skill package by a content-addressed reference or hash, retrieving the referenced skill package when connectivity is available, and storing the pointer token for deferred retrieval when connectivity is unavailable. Further, execution is blocked unless integrity verification, conformance testing, and the one or more gating operations succeed.

Further, in some embodiments, the method may include capturing, during an imaging-guided procedure, time aligned source-trace data comprising at least one imaging stream and at least one operator input stream, converting the captured source-trace data into a de-identified structured task plan (STP) template by replacing one or more subject-specific identifiers with one or more parameter slots and constraints, and for a subsequent destination case rebinding the one or more parameter slots using destination-local sensing and re-performing the one or more gating operations prior to execution.

Further, in some embodiments, the method may include submitting, to a policy-reconciliation service associated with a managed robotic ecosystem, a source policy associated with the skill package and a platform policy associated with a destination tenant. Further, the method may include receiving an effective execution policy and one or more conflict directives. Further, when the one or more conflict directives indicate an unresolved conflict, enforcing at least one fallback action selected from sandboxed execution, human-approval requirement, or denial of execution, and causing the one or more gating operations to block execution unless a required fallback condition is satisfied. Further, when the unresolved conflict is absent, updating the adapted version with one or more required safety constraints of the effective execution policy prior to performing the one or more gating operations.

Further, in some embodiments, the method may include, generating, after executing the adapted version, a dual-lineage update comprising a portable update associated with a canonical task representation and a platform-governance update associated with a platform-native version identifier. Further, the method may include transmitting at least the platform-governance update and execution evidence to a governance service associated with the managed robotic ecosystem. Further, the method may include receiving, from the governance service, a governance disposition comprising at least one of promotion, demotion, quarantine, or rollback. Further, the method may include enforcing the governance disposition before a subsequent execution while maintaining a mapping between the canonical task representation and the platform-native version identifier. Further, enforcing the governance disposition comprises updating one or more gating criteria or the gating policy associated with the skill package and blocking subsequent execution unless disposition-required conditions are satisfied.

In some embodiments, the present disclosure describes a non-transitory computer-readable medium storing instructions that, when executed by one or more processors, cause the one or more processors to obtain, from at least one skill source, an input representing a multi-step task; generate, based on the input, a skill package representing the multi-step task. Further, the skill package comprises an executable or interpretable task representation and associated metadata; provide the skill package for use by at least one destination robotic device comprising at least one actuation subsystem; adapt, at the at least one destination robotic device, the skill package using destination-local data to generate an adapted version. Further, prior to executing the adapted version, performing one or more gating operations according to a gating policy associated with the skill package. Further, execution is blocked unless one or more gating criteria are satisfied. Further, the instructions that, when executed by one or more processors, further cause the one or more processors to execute the adapted version by controlling the at least one actuation subsystem of the at least one destination robotic device.

Further, in some embodiments, robotics and automation systems are increasingly deployed at scale across heterogeneous settings, including domestic, industrial, clinical, remote, and mixed human-robot environments. A practical deployment challenge is not merely executing a task once, but repeatedly transferring task knowledge from one context to many other contexts while maintaining safety, reliability, and performance.

Further, destination robotic systems may differ in nominal and current operational capability, including differences in kinematics, end-effectors, sensor modalities, compute resources, safety envelopes, tooling, calibration state, maintenance state, wear state, fault condition, power state, and communication constraints. Environments are likewise non-identical and dynamic, with different geometry, object sets, lighting, surface properties, human presence, and operational policies. As a result, skills coupled to one robot-environment pair often do not transfer directly to another pair.

Further, centralized training or one-off manual programming alone is difficult to scale for fleet robotics because it does not efficiently cover long-tail tasks, local variation, and continuous change at deployment sites. In many deployments, robots must acquire task knowledge from nearby humans, operators, or other robots, convert that task knowledge into reusable skill representations, and transfer, adapt, and validate those skill representations for use by additional robotic systems.

Further, such transfer requires more than copying software, media, or recordings. A destination robotic system often requires adaptation to its current capability and operating context, together with conformance, safety, and execution authorization checks before task execution. Additional technical needs include maintaining versioned skill history and execution evidence across reuse and refinement, supporting updates, rollback, and offline or delay-tolerant transfer, and enabling coordinated execution across multiple robots, including embodiments in which a task is decomposed into sub-tasks assigned to different robots with synchronization and per-role suitability checks.

Further, accordingly, there is a need for governed skill-transfer architectures that support human-to-robot and robot-to robot skill transference, represent multi-step tasks in reusable packages, adapt those packages at destination endpoints using local data, enforce pre-execution gating, and maintain a versioned lifecycle for safe reuse and continuous fleet wide improvement.

In some embodiments, the present disclosure describes a governed skill-transfer system in which one or more processors obtain, from at least one skill source, an input representing a multi-step task and generate a skill package comprising an executable or interpretable task representation and associated metadata. In various embodiments, the skill source includes one or more of: direct user instruction, demonstration, teleoperation, remote or recorded media, documentation assets including tutorials, manuals, API documents, interface specifications, protocol specifications, and feature specifications, event logs or replay assets, virtual-world traces, and/or assistive intent inputs. The skill package is provided for use by at least one destination robotic device, adapted at the destination using destination-local data, and subjected to one or more gating operations according to a gating policy, wherein execution is blocked unless one or more gating criteria are satisfied. In various embodiments, the system performs local closed-loop execution after gate passage, stores versioned artifacts and updates, and supports governance operations including conformance testing, simulation regression, risk-tiered human review, refinement updates, promotion or demotion, rollback, offline transfer, multi-robot coordination, controlled-ecosystem deployment, and generation or use of human-procedure or human training artifacts associated with a transferred skill. In some embodiments, destination-local data and associated metadata include hardware-profile data such as manipulator configuration, tool attachment state, sensor placement or elevation state, and power or charging state, and such hardware-profile data is used in adaptation, conformance testing, and validation gating.

As used herein, a sensor subsystem includes one or more sensors and associated electronics and/or software for calibration, synchronization, filtering, feature extraction, and/or signal conditioning that provide machine readable measurements for task understanding, adaptation, execution, verification, and safety gating. A sensor subsystem may include, by way of non-limiting example: (i) exteroceptive sensors (e.g., visible-light, infrared, ultraviolet, thermal, depth, LiDAR, radar, sonar, ultrasonic, RF-ranging, and/or other imaging/ranging sensors), (ii) contact or proprioceptive sensors (e.g., tactile, pressure, force/torque, joint-position, joint-velocity, joint-torque, motor current, and inertial sensors), and/or (iii) interaction sensors (e.g., microphone/audio sensors, gesture sensors, gaze or eye-tracking sensors, wearable sensors, assistive-input sensors, and/or physiological/neural sensors such as EMG and/or EEG). As used herein, a perception sensor includes any sensor in a sensor subsystem that provides data used to infer at least one of environment state, workspace state, object state, user state, robot state, or robot-environment interaction state.

Structured Task Plan (STP)/Task Recipe: a structured intermediate representation of a multi-step task (e.g., graph, tree, state machine, behavior tree, JSON, YAML, PDDL-like representation) derived from an input representing the task (e.g., user input, demonstration, teleoperation, a retrieved STP or skill package, an event log, and/or assistive intent signals) and optionally from sensor-subsystem data. An STP may include one or more of: object/action pairs, step ordering and dependencies, branching conditions, parameter slots, parameter ranges and tolerances, constraints, preconditions, post conditions, safety criteria, success criteria, fallback actions, completion or termination criteria, and, in some embodiments, candidate bindings with source-evidence identifiers and confidence values for one or more parameter slots. As used in object/action pairs, “object” includes, in non-limiting examples, both (i) external environment objects and regions and (ii) robot-associated objects including robot body segments, end-effectors, tools or attachments, robot base/state targets, fixtures, and/or virtual proxies used for planning and control. In some embodiments, object/action pairs are semantic task-level representations that may be represented as, compiled into, transformed into, constrained by, and/or accompanied by corresponding state/action representations used by one or more controllers, and state/action representations may be reverse-mapped to object/action semantics for explanation, validation, and governance. In some embodiments, an STP may include optional execution-structure metadata, including role definitions and/or role placeholders (which may be resolved to specific destination robotic devices during destination-side adaptation), coordination constraints, capability descriptors, and sensor/actuation dependency descriptors. In some embodiments, an STP may additionally reference one or more verification artifacts, including a gating-policy identifier, a conformance-test profile identifier, a simulation-scenario-suite identifier, and evidence requirements for promotion/demotion decisions.

Parameter Slot: a field in an STP that requires binding to a value (e.g., object ID, pose, grasp point, insertion axis, force limit, tool choice) prior to execution and may include constraints, ranges, and a required/optional indicator. In some embodiments, a parameter slot stores one or more candidate bindings (e.g., derived from different modalities) with corresponding source-evidence identifiers and confidence values.

Control Logic Artifact: executable or interpretable task-specific control logic produced from an STP, including source code, scripts, bytecode, configuration, compiled binaries, behavior trees, state machines, motion primitives, trajectory plans, controller configurations, policy graphs, and/or any combination thereof. A task execution policy is a non-limiting example of a control logic artifact. Non-limiting embodiments include middleware packages (including ROS/ROS2 packages), callable service graphs, robotic-controller jobs, programmable-logic-controller (PLC) programs (e.g., ladder logic, function blocks, or structured text), microcontroller firmware modules, edge-runtime containers, and simulation-runtime executable bundles. In some embodiments, a control logic artifact is platform-neutral and subsequently compiled, translated, or otherwise bound to a target runtime associated with a destination endpoint.

Validation Gate/Gating Operations: a verification phase performed before executing an artifact (or before promoting a version), in which one or more checks are performed and execution is blocked if checks fail. Non-limiting checks include: capability signature compatibility; parameter completeness; package-integrity and authenticity checks (e.g., hash, digest, checksum, CRC, signature, message-authentication-code, manifest-binding, receipt-binding, token binding, and/or schema-consistency checks); destination-endpoint security-state checks (e.g., secure-boot state, runtime attestation state, revocation state, entitlement state, trusted-key state, and/or authorized software/hardware state); destination-endpoint health or defect-state checks (e.g., self-test results, fault codes, calibration state, wear state, contamination state, maintenance-overdue state, damaged-tool state, damaged-actuator state, degraded-sensor state, and/or watchdog or diagnostic state); kinematic reachability; collision and clearance constraints; force, torque, pressure, and speed envelope constraints; thermal, electrical, power, and battery constraints; timing and latency constraints; environment preconditions (e.g., lighting, temperature, humidity, ambient pressure, fluid-flow, local gravity regime or local gravitational acceleration, contamination state, and communication availability); physics feasibility checks consistent with laws of nature (e.g., stability bounds, friction/contact constraints, mass/inertia constraints, energy-budget consistency, buoyancy and hydrostatic-pressure constraints, aerodynamic or hydrodynamic drag/flow constraints, and pressure-load constraints on components and seals); and policy or regulatory constraints (e.g., geofencing, sterile/no-touch zones, privacy constraints, required human approvals, and applicable operational safety rules). In some embodiments, the validation gate returns one or more of: pass/fail status, risk tier, and reason codes used to allow, block, defer, reroute, quarantine, request maintenance, and/or request credential refresh or re attestation for execution and/or promotion.

Skill Record: a stored record of a skill or artifact version including metadata such as lineage, parameter bindings, validation outcomes, and execution metrics.

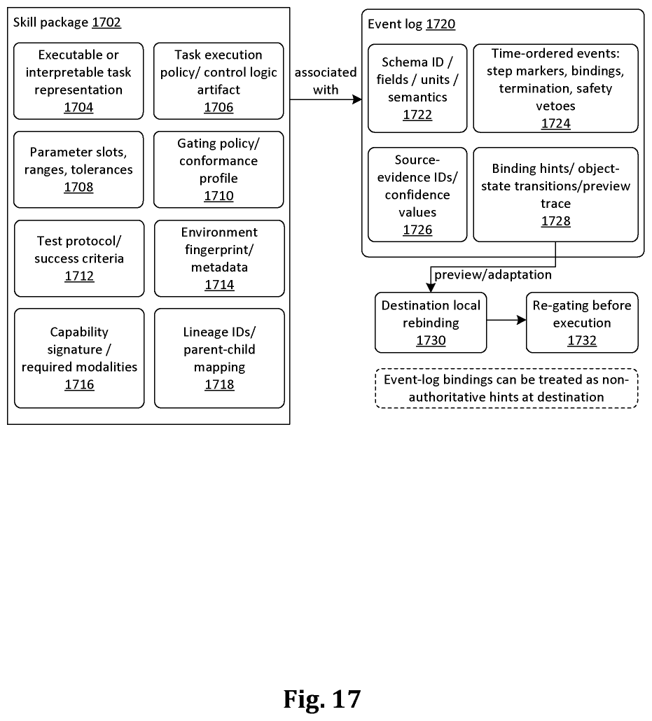

Skill Package: a transport and/or storage representation comprising at least (i) an artifact or policy, (ii) metadata, and (iii) a parameter template or bindings. In some embodiments, the skill package further includes one or more optional fields selected from environment descriptors (including, in some embodiments, an environment fingerprint), safety-policy data, test-protocol data (including, in some embodiments, success criteria and measurable metrics), capability signature data (also referred to as compatibility signature data), human-procedure instruction data, and/or integrity/authenticity data such as one or more package hashes, digests, checksums, CRC values, signatures, message-authentication codes, schema identifiers, manifest identifiers, and/or binding receipts. In some embodiments, the artifact or policy comprises a declarative language specification, including structured natural-language procedural text, that is machine-interpretable at runtime for gated execution. In some embodiments, a skill package is generated transiently in memory at a destination endpoint from one or more retrieved media inputs (e.g., recorded or streamed video/audio/text content) and need not be pre-authored as a standalone file by a source publisher; raw media content by itself is treated as an input source unless transformed into a machine-interpretable task representation and associated metadata. FIG. 17 illustrates a non-limiting structural relationship in which skill package 1702 may include executable/interpretable task representation 1704, task-execution-policy/control-logic-artifact element 1706, parameter-slot/range/tolerance element 1708, gating-policy/conformance-profile element 1710, test-protocol/success criteria element 1712, environment-fingerprint/metadata element 1714, capability-signature/required-modalities element 1716, and lineage-identifier mapping 1718, and may be associated with event log 1720 comprising schema/fields/units/semantics element 1722, time-ordered events element 1724, source-evidence/confidence element 1726, and binding-hints/object-state/preview element 1728.

Synthetic Data: data that is artificially generated rather than directly collected from physical real-world observation, and that is produced using one or more of simulation, physics-based modeling, rendering, procedural generation, replay mutation, augmentation, generative models, stochastic perturbation, or combinations thereof. Synthetic data may include image data, audio data, time-series data, event traces, scene graphs, task episodes, or labeled task outcomes, and may be used for experimentation, testing, benchmarking, validation, training, fine-tuning, calibration, or challenge-suite generation.

Experiment Record/Experiment Management: an experiment record is a machine-readable record associated with a candidate skill, model, pipeline, or validation configuration, and may include one or more of input selections, transformation settings, labeling settings, model settings, prompt settings, hyperparameters, skill-tuning settings, validation results, target-device constraints, application-budget constraints, calibration parameters, performance metrics, simulator settings, seed values, or deployment outputs. Experiment management includes storing, comparing, ranking, reproducing, promoting, demoting, or rolling back two or more such experiment records.

Custom Block: a reusable processing component that may be inserted into a data, model, or skill lifecycle pipeline to perform one or more transformations, annotations, generations, training operations, validations, calibrations, or deployment-related operations. Non-limiting examples include transformation blocks, AI-labeling blocks, learning blocks, synthetic-data blocks, evaluation blocks, calibration blocks, and deployment blocks.

Target Device Profile/Application Budget: a target device profile is a machine-readable descriptor of a destination execution target and may include one or more of processor type, accelerator type, memory capacity, storage capacity, latency limits, power limits, bandwidth limits, runtime environment, supported interfaces, supported control frameworks, sensor availability, actuator availability, safety capabilities, or environmental assumptions. An application budget includes one or more resource or performance constraints associated with deployment or execution, including one or more of RAM budget, ROM or storage budget, inference-time budget, execution-latency budget, power budget, thermal budget, communication budget, or safety margin.

Performance Calibration/Post-Processing Calibration: performance calibration includes evaluating and tuning one or more runtime parameters, thresholds, decision rules, event-detection rules, filtering rules, temporal aggregation rules, or post-processing rules using continuous real-world or synthetic streams prior to or after deployment. Post-processing calibration may include adjustment of event windows, smoothing, suppression, hysteresis, confidence thresholds, trigger conditions, recovery thresholds, or output-ranking parameters so that a skill, model, or combined skill-model pipeline performs more reliably in field conditions.

Dependency Record: a machine-readable record identifying one or more required or optional dependencies associated with a skill, model, prompt, adapter, embedding, evaluator, calibration configuration, tool profile, runtime configuration, or other executable or support component. In some embodiments, a dependency record includes one or more of a dependency type, identifier, version, compatibility constraint, authorization state, integrity state, source, target environment, or admissibility condition, and is used to determine whether execution, deployment, promotion, or validation should be allowed, blocked, sandboxed, delayed, or rerouted.

Conformance Test: a set of checks performed upon retrieval or prior to execution of a skill package to confirm capability signature compatibility, parameter completeness, integrity/authenticity consistency for required package credentials, acceptable destination-device health and security state for the requested task or risk tier, and safety policy satisfiability. In the non-limiting example of FIG. 17, destination-local rebinding 1730 and re-gating-before-execution 1732 illustrate that event-log content may be used as non-authoritative input to destination-side adaptation and subsequent gating rather than trusted as an authoritative command stream.

Patch/Delta: a stored update relative to a parent version that modifies an artifact, parameter template, safety policy, or metadata, and that can be applied or rolled back.

Promotion/Demotion/Rollback: lifecycle state transitions of a skill or artifact version based on measured outcomes, including promotion to trusted or demotion to untrusted/quarantined states and rollback to a prior version.

Convergence: a condition where successive versions show diminishing change in parameter ranges or performance metrics below a threshold across iterations or environments.

Freeze State: a state in which one or more parameter ranges or version attributes are locked or require elevated approval to modify after convergence.

Skill Source: a source endpoint, repository, media asset, documentation asset, simulation or virtual-world trace, event log, prior skill package, developer-authored representation, and/or other origin from which input representing a multi-step task is obtained.

Destination Robotic Device: a robotic execution endpoint, or a coordinated set of robotic execution endpoints, that receives a skill package and performs destination-local adaptation, gating, and execution.

Event Log/Event-Log Schema Identifier: an event log is a time-ordered record of semantic events associated with a demonstration, execution, adaptation, simulation, replay, or lifecycle update. An event-log schema identifier is an identifier defining fields, units, semantics, and interpretation rules for entries in the event log.

Environment Fingerprint/Capability Signature: an environment fingerprint is machine-readable environment metadata used to assess transfer suitability, adaptation requirements, conformance, clustering, and/or validation conditions. A capability signature is machine-readable metadata describing required and/or available robotic capabilities, configurations, modalities, and/or operational states used for conformance and validation gating.

Execution-Rights Token: a machine-readable rights or entitlement artifact whose state may condition whether execution is permitted, including, by way of non-limiting example, scope, expiration, revocation, usage-budget, authorization, and/or attestation state.

Binding Receipt: a record linking a canonical or portable representation to a destination-bound or platform bound representation, optionally including one or more hashes, manifests, signatures, receipts, or other linkage data used for audit, integrity, or governance.

Policy Reconciliation/Conflict Directives: policy reconciliation is determination of an effective execution policy from multiple policy sources. Conflict directives are instructions specifying required fallback, restriction, approval, sandboxing, denial, and/or other constrained behavior when policy conflicts are present.

Dual-Lineage Write-Back: post-execution or post-governance updating of both portable or canonical lineage and platform-native lineage, while maintaining mapping continuity between them.

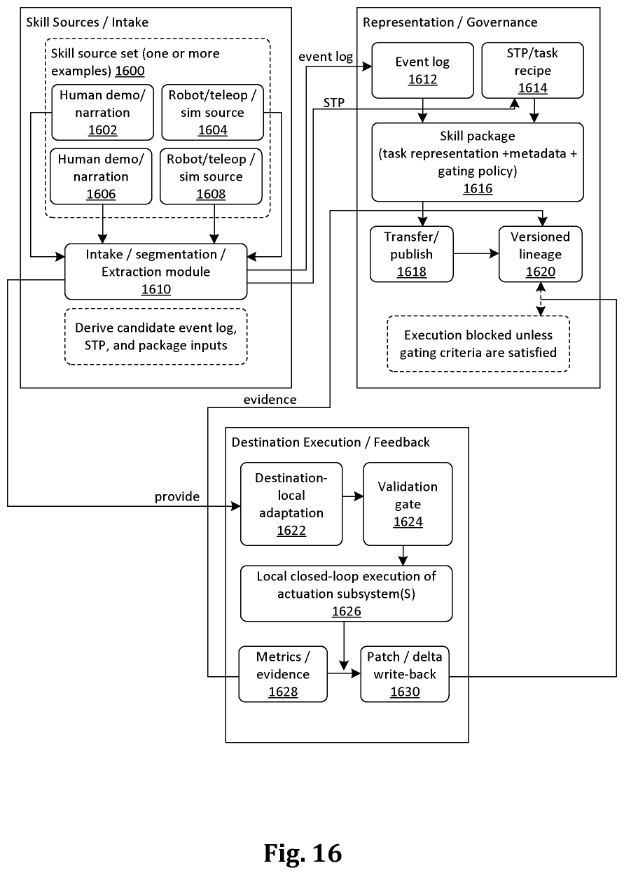

In some embodiments, the system implements a unified task execution pipeline including: (i) receive multimodal input and sensor data; (ii) generate a Structured Task Plan (STP) with parameter slots and constraints; (iii) generate a task-specific Control Logic Artifact from the STP; (iv) apply a Validation Gate that blocks execution unless checks pass; and (v) execute using local closed-loop control. In some embodiments, the pipeline further includes storing the artifact and associated metadata in a version-controlled repository for reuse, refinement, and rollback. In some embodiments, steps (i)-(iii) are performed at a source endpoint and steps (iv)-(v) are performed at a destination robotic device after transfer of the skill package via a communication interface, and execution is coordinated by one or more processors distributed across the source endpoint and the destination robotic device. This pipeline is implemented on a robotic device that may be mobile or stationary and may include one or more mechanical appendages, sensors, onboard processing, and hardware-state subsystems whose configuration and present state may be represented in capability signatures and evaluated during conformance testing and validation gating. FIG. 16 illustrates a non-limiting governed skill-transfer kernel in which a skill source set 1600 includes one or more example sources such as human demo/narration source 1602, robot/teleoperation/simulation source 1604, tutorial/manual/web asset source 1606, and egocentric/streamed-media/virtual-trace source a, which feed intake/segmentation/extraction module 1610. Module 1610 derives event log 1612 and STP 1614, which are used to assemble skill package 1616. In the illustrated embodiment, skill package 1616 supports transfer/publish element 1618 and versioned lineage element 1620, while destination-local adaptation 1622, validation gate 1624, local closed-loop execution 1626, metrics/evidence 1628, and patch/delta write-back 1630 support destination-side execution and lifecycle governance. Metrics/evidence 1628 and patch/delta write-back 1630 may feed back into versioned lineage element 1620, so that execution outcomes and refinements are associated with versioned skill history.

In some embodiments, the governed skill-transfer architecture is implemented as a lifecycle platform for the formation, validation, deployment, and governance of robotic skills. The lifecycle may include capture and ingest of demonstrations, teleoperation sessions, documentation assets, video, robot logs, simulation traces, and fleet telemetry; normalization and provenance-tagging across modalities, source types, environment classes, tooling, and robot classes; AI-assisted structuring that auto-labels objects or actions, segments tasks, derives event logs, suggests STPs, infers parameter slots, and proposes constraints; and one or more authoring environments in which an operator, developer, or automated service builds or edits STPs, policies, prompts, evaluators, and runtime adapters. In some embodiments, the lifecycle further includes a model plane supporting bring-your-own-model, bring-your-own-prompt, or custom perception, grounding, generation, safety, or recovery blocks; a skill-tuning stage that jointly optimizes structuring blocks, models, prompts, policies, hardware-profile choices, latency budgets, safety budgets, and transferability; a validation stage using simulation, challenge suites, shadow mode, minimal reproduction generation, and gate checks; a live-validation stage using dry runs, assisted runs, or staged actuation on real robotic systems; a deployment stage that packages skill artifacts together with dependencies, prompts, and runtime adapters for ROS2, PLC, edge-agent, cloud, simulator, or human-workflow targets; an observe-and-write-back stage that collects outcomes, failures, corrections, drift, confidence, and resource usage; and a governance stage that performs promotion, demotion, rollback, freeze, entitlement enforcement, tenant-policy application, and fleet propagation.

In some embodiments, the lifecycle further includes experiment management in which a plurality of candidate skill, model, prompt, calibration, transformation, or validation configurations are stored as experiment records and compared according to one or more measured outcomes, target-device profiles, or application budgets. In some embodiments, one or more experiments may differ in one or more of structuring blocks, custom blocks, prompts, model architectures, tuning settings, validation suites, simulation settings, synthetic-data generation settings, calibration parameters, runtime adapters, or deployment targets. In some embodiments, experiment management supports ranking, reproduction, promotion, demotion, rollback, or freeze-state decisions across candidate skill or model variants.

In some embodiments, the platform supports one or more custom blocks that may be inserted into one or more lifecycle pipelines. Non-limiting examples include transformation blocks, AI-labeling blocks, learning blocks, synthetic-data blocks, evaluation blocks, calibration blocks, and deployment blocks. Such blocks may be built-in, third-party, or user-defined, and may be selected, chained, parameterized, versioned, validated, or compared across experiments.

In some embodiments, the lifecycle further includes one or more target device profiles and one or more application budgets used to evaluate whether a candidate skill, artifact, model, or combined skill-model pipeline is suitable for deployment. Non-limiting examples include memory budgets, storage budgets, inference-time budgets, execution-latency budgets, power budgets, thermal budgets, communication budgets, and safety margins. In some embodiments, when a target device profile is explicitly specified, candidate configurations are filtered, ranked, or tuned according to the target device profile and the one or more application budgets. In some embodiments, when a target device profile is not specified, the destination robotic device evaluates its own local hardware profile, capability signature, runtime resources, and safety state to determine whether the candidate skill or associated model assets are admissible for execution, require degradation or alternate binding, or should be blocked.

In some embodiments, the observe-and-write-back stage includes performance calibration and post-processing calibration using continuous streams of real-world data, replayed task traces, or synthetic data. Such calibration may tune one or more thresholds, trigger conditions, smoothing parameters, temporal aggregation rules, recovery thresholds, event-detection parameters, confidence thresholds, or output-ranking rules associated with a skill, model, or combined skill-model pipeline. In some embodiments, calibration results from different destination robotic devices are compared and used to improve cross-robot robustness, reduce false activations, improve timing of task-phase transitions, or improve reliability of recovery or safety behavior across a fleet.

In some embodiments, the platform optimizes portable robotic skills for heterogeneous robots, robot classes, end-effectors, and deployment environments rather than limiting optimization to an inference model for a single edge-device class. In some embodiments, observation, skill formation, model/skill co-optimization, gated execution, and fleet governance are managed as parts of a single technical lifecycle so that reusable skills can be improved, validated, deployed, and governed across mixed robotic fleets.

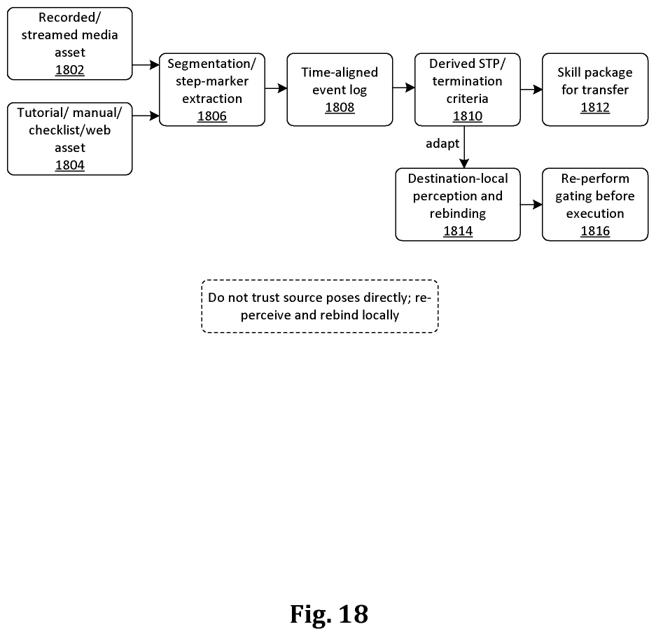

In some embodiments, a robotic device (or an onboard processor thereof) receives multimodal input representing a multi-step task. The multimodal input may comprise, by way of example, at least one of: (i) a natural language instruction (voice or text, including narration synchronized to a demonstration), (ii) a demonstration observed by one or more sensor subsystems including one or more perception sensors and/or interaction sensors (e.g., cameras, depth sensors, LiDAR, microphones, gaze sensors, and/or tactile/force sensing channels used to infer interaction state), including in some embodiments first-person, egocentric, wearable, or body-worn capture streams, (iii) a gesture input (e.g., pointing, hand pose, sign language gestures such as American Sign Language (ASL), or gaze) indicating an object, a region, or an endpoint to be bound to a parameter slot, (iv) a teleoperation session in which a user controls one or more robot joints or end-effectors while the robot records state and sensor data, including in some embodiments a live or recorded remote-expert, telepresence, or shared-autonomy session, (v) a retrieved STP and/or skill package, (vi) an assistive-input signal (e.g., eye gaze selections, switch scanning, and/or brain-computer interface (BCI) signals) used to select among candidate plans and/or to answer clarification questions, (vii) a virtual-world, game-engine, metaverse, and/or simulation interaction trace representing the multi-step task, and/or (viii) a recorded or streamed media asset retrieved from a remote content platform, documentation source, social network, messaging channel, or media repository, the media asset comprising, in non-limiting examples, video, audio, text, caption/transcript data, tutorial content, manual or checklist content, web-page content, and/or robot-to-robot streamed execution content. The multimodal input may be generated by a user, another robot, a simulation environment, a remote expert, a computing system, a plurality of contributors, and/or may be retrieved from a repository or network content service as a stored STP, skill record, skill package, event log, patch/delta, tutorial asset, documentation asset, and/or media asset. The robotic device further receives sensor-subsystem data including one or more of: exteroceptive data (e.g., visible-light, infrared, ultraviolet, thermal, depth, LiDAR, radar, sonar, ultrasonic, RF ranging, and/or other imaging/ranging data), contact/proprioceptive data (e.g., tactile, pressure, force/torque, joint-state, motor-current, and/or inertial data), and interaction data (e.g., audio, gesture, gaze, wearable, assistive-input, and/or physiological/neural sensing data such as EMG/EEG), representing a current environment and, in some embodiments, an environment map, scene model, and/or state estimate derived from the sensor-subsystem data. FIG. 18 illustrates a non-limiting source-ingestion flow in which recorded/streamed media asset 1802 and tutorial/manual/checklist/web asset 1804 feed segmentation/step-marker extraction 1806 and time-aligned event log 1808.

In some embodiments, the robotic device generates, from the input and sensor data, a Structured Task Plan (STP) (also referred to as a Task Recipe) that represents a multi-step task as an ordered sequence, graph, state machine, and/or behavior tree of action primitives, and that includes one or more parameter slots to be bound prior to execution. In some embodiments, the STP further encodes one or more of: step ordering and dependencies, branching conditions, preconditions, post conditions, safety criteria, success criteria, fallback actions, completion or termination criteria, and candidate bindings with source-evidence identifiers and confidence values for one or more parameter slots. In some embodiments, object/action pairs in the STP may reference both external task objects and robot associated objects (including body segments, end-effectors, tools/attachments, robot-state targets, and/or virtual proxies), such that task steps may include both object-manipulation actions and robot-configuration or robot-motion actions. In some embodiments, the object/action semantics are additionally represented and/or enforced through one or more corresponding state/action representations at runtime without limiting the STP to any particular model family or controller architecture. In some embodiments, the STP includes optional execution-structure metadata including role definitions and/or role placeholders (resolved to specific destination robotic devices during destination-side adaptation), coordination constraints, capability descriptors, and sensor/actuation dependency descriptors, and optionally references one or more verification artifacts including a gating-policy identifier, a conformance-test profile identifier, a simulation-scenario-suite identifier, and evidence requirements for promotion/demotion decisions. Example action primitives include: navigate-to, open/close, grasp, lift, place, insert, wipe, pour, plug-in, unplug, and tool-use primitives. In the non-limiting example of FIG. 18, time-aligned event log 1808 supports derivation of STP/termination criteria 1810 and assembly of skill package 1812, after which destination-local perception/rebinding 1814 and re-performed gating-before-execution 1816 occur prior to execution.

In some embodiments, each parameter slot is associated with (i) a parameter type, (ii) a required/optional indicator, and (iii) one or more constraints. Example parameter slots include: a target object identifier, a grasp point, a target pose, an insertion axis, a placement region, a maximum force/torque value, a speed limit, an allowed tool identifier, and a no-go zone constraint.

In some embodiments, the robotic device generates a task-specific control logic artifact from the STP. The artifact may comprise any executable representation capable of being executed by the robot's controller stack, including one or more of: source code, scripts, bytecode, a state machine, a behavior tree, a controller configuration, motion primitives, a trajectory plan with guards, or a ROS/ROS2 package including node scripts and launch files.

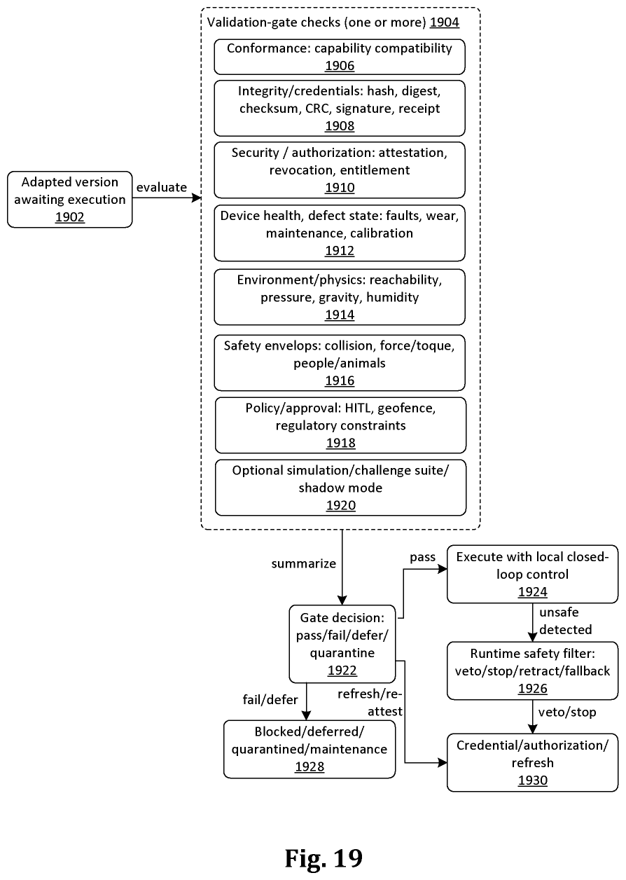

In some embodiments, the robotic device applies a validation gate prior to enabling execution of the task specific control logic artifact. The validation gate may block execution unless one or more checks pass. FIG. 19 illustrates a non-limiting example in which adapted version 1902 is evaluated against a validation-gate check set 1904, the results of the checks are summarized into gate decision 1922, and only a pass outcome permits local closed-loop execution 1924. In the example of FIG. 19, check set 1904 includes, by way of illustration and not limitation, conformance checking 1906, integrity/credential checking 1908, security/authorization checking 1910, device health/defect-state checking 1912, environment/physics checking 1914, safety-envelope checking 1916, policy/approval checking 1918, and optional simulation/challenge-suite/shadow-mode checking 1920. In some embodiments, the validation gate comprises one or more of:
Parameter completeness checking and package-credential consistency checking for required package fields, schema identifiers, manifests, hashes, digests, checksums, CRC values, signatures, and/or binding receipts.
Capability signature compatibility checking and destination-endpoint health/defect-state checking, including one or more of self-test results, fault codes, wear indicators, maintenance state, damaged-tool state, degraded-actuator state, degraded-sensor state, and/or contamination state.
Destination-endpoint security-state and authorization checking, including one or more of secure-boot status, runtime attestation state, trusted-key state, revocation state, entitlement state, and authorized software/hardware state.
Reachability, calibration-freshness, and/or candidate-pose consistency checking for one or more candidate end effector poses relative to a scene model derived from sensor data.
Collision, clearance, force, torque, pressure, speed, thermal, electrical, power, and/or battery envelope checking for one or more action primitives.
End-effector, tool-head, and sensor-subsystem compatibility checking (e.g., gripper type, tool presence, tool change state, sensor availability, and required modality calibration state).
Environment, safety-policy, and approval satisfiability checking (e.g., no-go zones, human proximity limits, geofencing, regulatory constraints, sterile/no-touch zones, and required human approvals).
Simulation-based, challenge-suite-based, quarantine-based, and/or shadow-mode checking as described herein.

In some embodiments, when the validation gate fails, the robotic device prevents execution and performs one or more remedial actions, including: requesting clarification, adjusting parameter ranges, selecting an alternate action primitive, selecting an alternate viewpoint, placing the robot into a safe stop state, placing the package or endpoint into quarantine, requesting maintenance or recalibration, requesting package re-download or credential refresh, and/or requesting renewed authorization or runtime attestation. As illustrated in FIG. 19, gate decision 1922 may therefore route the adapted version to blocked/deferred/quarantined/maintenance disposition 1928 and/or to credential/authorization/refresh disposition 1930 rather than permitting execution.

In some embodiments, after passing the validation gate, the robotic device executes the artifact using local closed-loop control. For latency-critical manipulation actions, the robot executes feedback control locally on an onboard processor using tactile/force feedback and/or vision feedback. In some embodiments, the robot adjusts a trajectory, a contact direction, or a grip force based on tactile feedback indicating slip, contact, resistance, or force spikes. In the non-limiting example of FIG. 19, execution path 1924 is additionally monitored by runtime safety filter 1926, which may veto, stop, retract, or invoke a fallback behavior when an unsafe condition is detected and may redirect execution toward credential/authorization/refresh disposition 1930 and/or another blocked or maintenance related disposition.

In some embodiments, the robotic device stores the artifact (and optionally the STP) in a version-controlled repository to enable reuse, refinement, and rollback. In some embodiments, the repository stores a plurality of versions of an artifact or skill and supports rollback to a prior version based on one or more triggers, including repeated failures, safety anomalies, excessive clarification requests, and/or user negative feedback. In some embodiments, an update is stored as a patch/delta relative to a parent version and associated with a derivation chain and performance metrics.

In some embodiments, cloud connectivity is used for non-time-critical operations (e.g., synchronization, long term analytics, model updates), while manipulation control loops remain local and continue to operate during loss of connectivity.

Workflow narrative: A robotic device receives an input representing a multi-step task and sensor data representing a current environment. The input may comprise, by way of example, at least one of: a natural-language instruction, a demonstration, teleoperation input, a retrieved STP or skill package, a trace/replay asset, and/or assistive intent signals (e.g., eye gaze selections). The device generates an STP with parameter slots and constraints, compiles or assembles a control logic artifact from the STP, applies a validation gate to verify completeness, integrity/authenticity of required package credentials, acceptable destination-device health and security state, and operational safety, executes the artifact using local closed-loop control, and stores the artifact and execution outcomes in a version controlled repository that supports patch/delta updates and rollback.

Non-limiting embodiments include: STP as behavior tree or graph; artifact as a state machine, motion primitive set, or controller configuration; validation gate on-device or distributed; repository local or cloud-synchronized; patch/delta updates stored as lineage records; and rollback triggered by anomalies or user feedback.

Validation gate checklist (example): parameter completeness; required package hash/digest/checksum/CRC/signature/receipt consistency; destination-device self-test, fault, and maintenance state; destination-device security and authorization state (e.g., attestation, revocation, entitlement, and trusted-key state); workspace reachability; calibration freshness and scene-consistency checks; collision checking against a scene model; force/torque envelope compliance; sensor modality availability; end-effector compatibility; safety policy satisfiability; and simulation regression if required by policy.

In some embodiments, the robotic device computes an uncertainty or confidence measure associated with binding one or more parameter slots of an STP and/or feasibility of executing one or more action primitives. In some embodiments, uncertainty is computed based on agreement or disagreement among different modalities (e.g., narration, gesture, perception, and/or an environment map or scene model). For example, uncertainty may be computed for object grounding (which object), pose estimation, tool selection, grasp feasibility, reachability, collision risk, insertion alignment, or allowable force limits.

In some embodiments, when a confidence measure fails a threshold for a parameter slot, the robotic device generates and issues a targeted clarification question corresponding to that parameter slot. In some embodiments, disagreement among modalities triggers clarification even when one modality alone exceeds a threshold. The clarification question may be presented via audio (speaker), text, a display, or an augmented reality interface, and may present selectable options (e.g., candidate objects highlighted in a camera image). A clarification response may be received via voice, gesture (including sign language gestures such as ASL), touch, or other user input.

In some embodiments, the robotic device binds the parameter slot based on the clarification response by associating the slot with a perception identifier, including a tracked object identifier and/or a pose estimate derived from sensor data. The robotic device then updates the STP and generates a patch/delta update to the artifact (or regenerates the artifact) using the bound slot value, and re-runs the validation gate prior to execution.

In some embodiments, clarification interactions, parameter bindings, and execution outcomes are stored in the version-controlled repository as part of lineage metadata for a corresponding artifact version, and are used to update confidence measures and promotion/demotion decisions for the artifact or a corresponding skill package.

Workflow narrative: When binding a parameter slot yields a confidence below a threshold, the system generates a targeted clarification question, receives a response, binds the slot to a perception identifier, patches the artifact, and re-runs the validation gate prior to execution.

Non-limiting embodiments include: clarification presented via audio, display, or AR; clarification based on tool choice, force limit, or insertion axis; slot binding based on voice, gesture (including sign language gestures such as ASL), gaze, or touch input; multi-modal fusion policies (e.g., rule-based consistency checks, weighted voting, learned fusion, or constrained optimization subject to reachability/collision constraints); and storing bindings as lineage metadata in a skill record.

Validation gate checklist (example): minimum confidence threshold; cross-modal consistency between candidate bindings and the environment map/scene model; verify bound object is reachable; re-check collision and force limits; confirm required sensor modalities; and confirm no-go zone constraints remain satisfied.

In some embodiments, a robotic device captures images of a work scene using at least two cameras mounted at different elevations relative to the robot base, such as cameras mounted on telescopic vertical arms having height sensors. The work scene may include a gripper and a target object to be grasped, manipulated, or inserted.

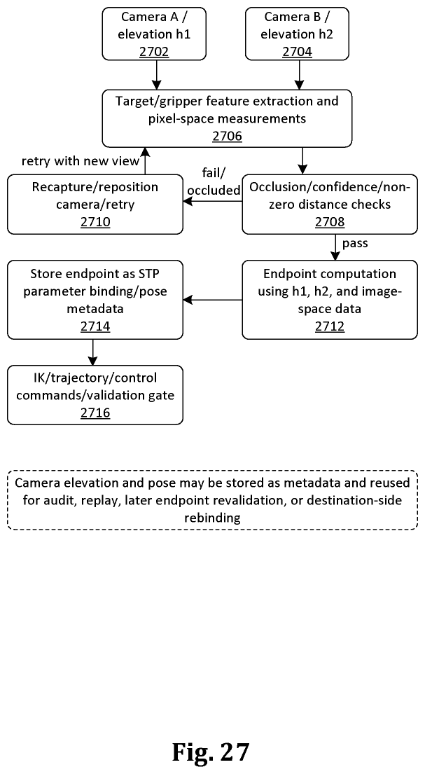

In some embodiments, the robotic device measures, for each of the images, a pixel-space distance between the gripper and a target feature of the target object and verifies that the measured pixel-space distance is non-zero (or satisfies a minimum threshold). In some embodiments, the robotic device measures the elevation (height) of each camera and combines the measured pixel-space distances with the measured elevations to compute updated endpoint coordinates for the gripper. FIG. 27 illustrates a non-limiting example in which camera A/elevation h1 2702 and camera B/elevation h2 2704 feed target/gripper feature extraction and pixel-space measurements 2706, after which occlusion/confidence/non-zero-distance checks 2708 determine whether computation can proceed.

In some embodiments, the robotic device computes joint angles for one or more joints of a robotic arm and/or gripper using inverse kinematics based on the updated endpoint coordinates, converts the joint angles into robot commands (e.g., ROS commands as an example embodiment), and applies the commands to move the gripper. In some embodiments, when the pixel-space distance is zero or when confidence is below a threshold, the robotic device triggers re-capture and/or repositions one of the cameras to mitigate occlusion. In the non-limiting example of FIG. 27, a failure or occlusion outcome at stage 2708 routes to recapture/reposition/retry stage 2710, which returns to the measurement stage with a new camera view, while a passing outcome proceeds to endpoint computation 2712.

In some embodiments, the computed endpoint coordinates are stored as parameter bindings for a parameter slot of an STP and/or as part of a skill package parameter template, enabling subsequent executions and cross-robot transfer. In some embodiments, tactile/force feedback is further used during contact-rich operations (e.g., insertion) to perform compliant adjustments after the inverse kinematics-based motion. As further illustrated in FIG. 27, endpoint computation 2712 may be stored as STP parameter binding and pose metadata 2714 and then used by IK/trajectory/control/validation stage 2716 for destination-side execution.

Workflow narrative: Two cameras at different elevations capture images, pixel-space distances are measured to a target feature, camera heights are combined to compute updated endpoint coordinates, and inverse kinematics generates joint commands. Endpoint coordinates may be stored as parameter bindings in the STP or a skill package. In some embodiments, camera pose and elevation metadata are preserved together with the endpoint binding so that later replay, audit, rebinding, or validation-gate analysis can distinguish between the original observation geometry and a later destination configuration.

Non-limiting embodiments include: telescopic camera arms with height sensors; re-capture when occluded; and tactile compliance for insertion.

Validation gate checklist (example): verify non-zero-pixel distance; verify height sensor reading; and confirm IK solution within joint limits.

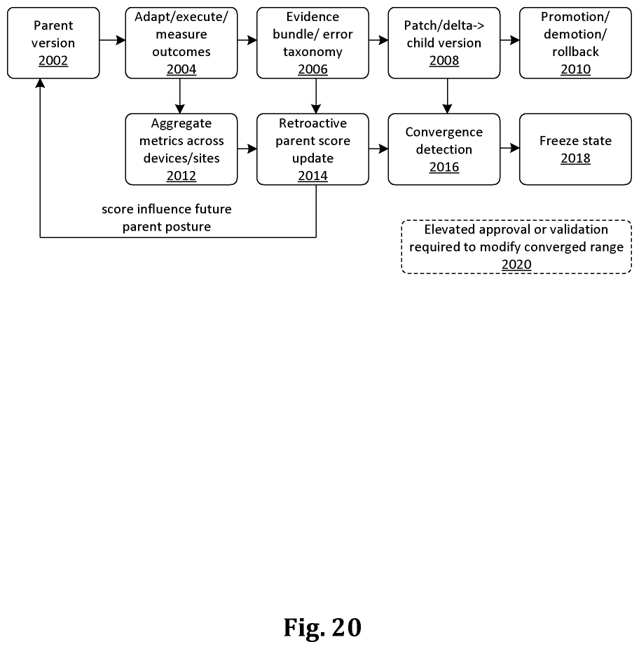

Workflow narrative: A skill package is published to a registry with an artifact, parameter template, safety policy, test protocol, and environment metadata (e.g., an environment fingerprint comprising a hashed descriptor set and/or map-derived descriptors). A second robot retrieves the skill, performs conformance tests, adapts parameters locally, executes under a validation gate, records metrics, and writes back a patch/delta and updated metadata. In some embodiments, the skill package is additionally retrieved by a user device and rendered as a human procedure or instruction artifact to guide a human executor (e.g., step prompts and augmented-reality overlays), and the human execution is monitored and logged as metrics and evidence (e.g., images/video, depth, wearable inertial/positional measurements, tool telemetry, haptic/force measurements, and/or physiological/neural signals such as EMG/EEG) to support write-back and promotion/demotion. The registry computes score across versions, retroactively updates parent version scores based on descendants, and detects convergence to freeze or stabilize parameter ranges. In some embodiments, score computation, promotion eligibility, and retroactive parent-score updates distinguish between outcomes attributable to the skill itself and outcomes attributable to destination-device faults, degraded calibration, maintenance or wear state, communication failure, or incomplete evidence/write-back availability, so that a destination-endpoint problem need not be treated as a substantive defect in the skill package. FIG. 20 illustrates a non-limiting logical lifecycle in which parent version 2002 feeds adapt/execute/measure stage 2004, evidence bundle/error taxonomy stage 2006, patch/delta child-version stage 2008, and promotion/demotion/rollback stage 2010, while aggregate-metrics stage 2012, retroactive parent-score update stage 2014, convergence detection stage 2016, freeze state 2018, and elevated approval/validation requirement 2020 may be carried out by one or more registry services, governance services, destination endpoints, and/or human reviewer workflows.

Non-limiting embodiments include: registry as centralized or distributed; write-back as metadata-only or patch/delta; promotion/demotion based on score thresholds, anomaly counts, or user ratings; retroactive scoring for parent versions; convergence detection based on parameter variance or success rate saturation; environment-fingerprint clustering to maintain separate “known-good” bindings and scores for different environment classes (e.g., different appliance models, work surface heights, gravity profiles, or friction regimes); hybrid deployments in which a skill package includes both a robot-executable artifact and a human procedure or instruction artifact (e.g., for fallback execution or training); score weighting, exclusion, or quarantine for runs affected by destination hardware faults, maintenance-overdue state, communication loss, or incomplete telemetry/evidence; and local queueing, deferred transmission, resumable upload, and later reconciliation of evidence bundles, metrics, and patch/delta updates when connectivity or registry availability is intermittent. In some embodiments, the operations depicted in FIG. 20 are not required to occur at a single physical location, at a single endpoint, or at a single time; for example, execution and evidence capture may occur at destination robots or human-guided endpoints, aggregation and retroactive scoring may occur at one or more remote services, and promotion, demotion, convergence, or freeze decisions may occur in automated or human-reviewed governance workflows. In some embodiments, arrows in FIG. 20 represent lineage, metric-propagation, score-influence, approval, and/or lifecycle relationships and do not require synchronous co location of the depicted actions.

Validation gate checklist (example): capability compatibility; parameter completeness; required package hash/digest/checksum/signature/receipt consistency; environment fingerprint staleness/validity (e.g., required descriptors present and descriptor hash recomputed); destination-device health and security state acceptable for requested task or risk tier; required malware, spyware, static-analysis, dynamic-analysis, sandbox, or restricted-runtime checks when policy designates a package, artifact, or update as untrusted, first-use, externally sourced, or otherwise elevated-risk; verification that package or runtime policy does not request unauthorized outbound communication, telemetry exfiltration, credential access, or resource access outside the allowed execution profile; safety policy satisfiability; test protocol pass/fail; optional human approval for high-risk actions; and, when a human procedure is provided, verify that step prompts include explicit completion criteria and safety constraints and that a monitoring or evidence-capture policy is enabled for high-risk steps, including identification of at least one feasible feedback channel (e.g., video, inertial/positional, tool telemetry, haptic/force, and/or physiological/neural sensing) for verifying completion.

In some embodiments, a simulation gate is applied prior to executing a new or adapted version on real hardware and/or prior to promoting a version in the registry. The simulation gate may include:
Simulation in a physics-based environment configured to emulate the robot and at least a portion of the environment.
Scenario sampling (e.g., randomization of object placement, friction, lighting, clutter).
Evaluation against the test protocol, including detection of collisions, force spikes, unstable grasps, or unsafe trajectories.
Digital twin alignment checks to confirm that key assumptions match sensed conditions.

In some embodiments, the simulation gate uses a learned world model or generative model to produce candidate environments and stress-test a skill's parameter ranges before promotion.

In some embodiments, one or more simulation outputs may be used to generate synthetic data for experimentation, validation, calibration, benchmark generation, adversarial scenario generation, rare-event coverage, or model fine-tuning.

Workflow narrative: Prior to executing or promoting a newly adapted skill version, the system executes a simulation regression suite using a digital twin or physics-based simulator with scenario sampling derived from parameter ranges. The gate blocks promotion if collisions, force spikes, or policy violations are detected.

In some embodiments, tasks and/or task steps are classified into risk tiers, for example:
Low risk: non-contact navigation or low-force manipulation.
Medium risk: contact-rich manipulation with bounded force.
High risk: tool use, heating/cutting, near-human manipulation, plug insertion into powered outlets, or actions near fragile objects.

Further, for medium and high risk tiers, the system may require one or more of:
Stricter validation gate thresholds,
Reduced speed/force envelopes (Conservative mode)
Mandatory simulation gate.
Explicit human approval prior to execution or prior to promotion,
Continuous runtime monitoring and automatic abort rules.

In some embodiments, the system monitors execution in real time for anomalies, including tactile slip events, unexpected resistance, collision likelihood, human proximity, unauthorized outbound communication attempts, prohibited data-export attempts, or execution outside an authorized runtime state, and triggers an abort, safe retract, isolation action, and/or a clarification request.

Runtime safety filter workflow: During execution, a runtime safety filter monitors sensor feedback and runtime-policy state and can veto or override planned actions by issuing a safe stop, retraction, isolation action, or fallback behavior when unsafe conditions or policy violations are detected.

Non-limiting embodiments include: approval per step or per task; two-person approval for sensitive actions; and automatic demotion when approval is denied.

Validation gate checklist (example): confirm risk tier assignment; verify safety filter enabled for high-risk steps; confirm approval captured; and confirm audit log entry stored in the skill record.

In some embodiments, the system enforces privacy constraints for uploads to the registry, such as uploading only:
Signed skill packages and signed patches.
Role-based access control (RBAC)
Quarantine states for untrusted updates.
Audit logging of who/what/when modified each version.

Non-limiting embodiments include: privacy-filtered uploads that exclude raw media; signed packages and patches; RBAC for registry access; quarantine states for untrusted updates; and audit logging for modification events.

In some embodiments, the robotic system provides a documented API enabling third-party skill modules to:
Declare required capabilities and sensors.
Provide STP interfaces (inputs/outputs).
Provide validation tests and safety policies.
Publish skill packages to a registry.
Receive telemetry-based reliability scores.

In some embodiments, third-party skill modules execute in a sandboxed environment with restricted permissions, and high-risk actions require explicit authorization.

Validation gate checklist (example): verify module signature, hash, digest, checksum, and/or revocation status as required; verify declared capabilities and schema/version compatibility; verify required tests executed; verify permissions and authorization match task risk tier; and verify that any required destination security or attestation conditions are satisfied before activation.

The following hardware embodiments and configurations are provided as non-limiting support for the robotic platforms on which the governed skill-transfer workflows described herein may be executed. These embodiments may be claimed separately, in combination with one another, and/or in combination with the skill-transfer, validation-gate, lifecycle, and governance features described elsewhere in this specification.

In some embodiments, non-limiting hardware embodiments include one or more of: manipulator and base topology families; sensor-placement and sensor-elevation families; power, charging, and stability-management families; attachment, tool-head, and gripper families; and safety hardware families. Different members of these families may appear in the same physical robot or may be distributed across different product tiers, deployment environments, or destination robotic devices.

In some embodiments, hardware state and hardware configuration data are used as direct technical inputs to the governed skill-transfer architecture. By way of non-limiting example, one or more of: arm count, arm reach, gripper or tool-head type, tool attachment state, camera count, camera mounting configuration, camera elevation, camera pose, brake or lock state, base geometry, wheel or lift configuration, battery location, battery status, charging-interface availability, tactile/force sensing availability, self-test state, fault or defect state, maintenance state, calibration state, and/or secure-runtime or attestation state may be represented in a capability signature, a conformance-test profile, an STP dependency descriptor, a validation-gate rule set, an event log, a build/port manifest, and/or a skill record.

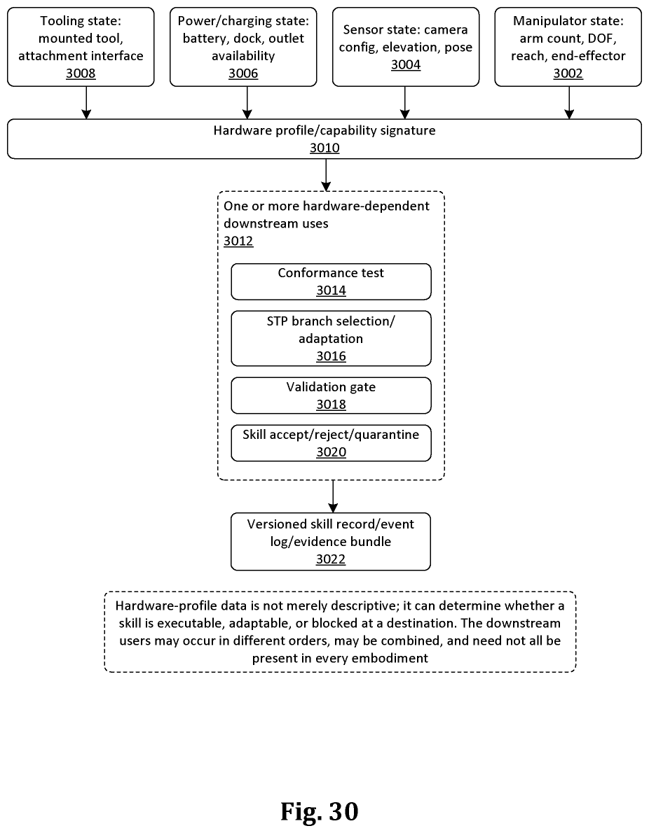

In some embodiments, a skill package does not merely describe semantic task steps, but additionally identifies one or more hardware-dependent conditions under which the task may be executed, adapted, or blocked. For example, a skill package may require a dual-camera configuration, a minimum camera elevation, a particular gripper class, a mounted tool head, a pushback-detection threshold, a battery reserve threshold, a charging-interface type, a minimum calibration state, an acceptable defect/fault state, an acceptable secure-runtime state, and/or a safe-retract capability. A destination endpoint may therefore accept, adapt, branch, reject, quarantine, or defer a skill package based in part on destination-local hardware profile data. FIG. 30 illustrates one non-limiting summary in which manipulator-state input 3002, sensor-state input 3004, power/charging-state input 3006, and tooling-state input 3008 contribute to a hardware profile/capability signature 3010.

Workflow narrative: A source robot, developer workstation, or authoring system generates a skill package for a task such as bimanual lifting, plug insertion, or elevated-view manipulation. The skill package declares one or more hardware dependencies and optional fallbacks. A destination robotic device evaluates its local hardware profile, including manipulator topology, tooling state, camera configuration, elevation state, power state, self-test and calibration state, and secure-runtime state. If the destination hardware satisfies the declared requirements, the task is adapted and gated for execution. If the hardware profile fails one or more requirements, the system blocks execution, requests reconfiguration, requests maintenance or recalibration, requests renewed authorization or attestation, selects an alternate hardware-compatible branch, or routes the task to a different robot. As further illustrated in FIG. 30, the hardware profile/capability signature 3010 may feed one or more hardware-dependent downstream uses 3012, including conformance testing 3014, STP branch selection or adaptation 3016, validation gating 3018, and/or skill acceptance, rejection, quarantine, or deferral 3020. These downstream uses may occur in different orders, may be combined, and need not all be present in every embodiment. Results and status from such downstream uses may be recorded in a versioned skill record, event log, and/or evidence bundle 3022.

Non-limiting embodiments include: (i) single-arm or dual-arm robots; (ii) arms mounted directly on a mobile base, on vertical supports, on rails, or on torso substitutes; (iii) fixed, telescopic, or turret-mounted sensor arrangements; (iv) one or more independently positionable camera arms with microphones and auxiliary sensors; (v) integrated mechanical brakes and/or passive locks that hold camera or sensor elevation with reduced idle energy consumption; (vi) self-docking or wall-outlet charging interfaces; (vii) battery packs, ballast masses, or other lower center-of-gravity structures placed in a lower region of the base; (viii) universal attachment interfaces supporting removable or task-specific tool heads; and (ix) hardware variants optimized for domestic, industrial, clinical, remote, or constrained environments.

Validation gate checklist (example): verify that declared hardware dependencies for a skill package are present; verify camera mounting configuration, elevation, and calibration if perception geometry is relied upon; verify tool head identity and attachment state if a tool-specific skill is requested; verify self-test, fault/defect, maintenance, and secure-runtime or attestation state for requested risk tier; verify brake or lock state if a sensor mast or lift must hold position; verify battery reserve and charging-path availability for tasks requiring extended runtime or plug insertion; verify configured safe-retract or safe-stop responses for pushback or resistance events; and block execution or promotion unless the required hardware-state conditions are satisfied.

The present disclosure describes an intelligent mobile robotic system designed to autonomously perform a wide range of domestic tasks, such as dishwashing, organizing, and kitchen cleanup. The system integrates multimodal sensory processing—including visual, tactile, auditory, and gestural inputs to perceive and interact with its environment. Core components include dual 6+ DOF robotic arms with tactile grippers, a mobile omnidirectional base, depth-sensing camera systems in flexible configurations, and a microphone and speaker for natural voice-based interaction. Powered by an onboard processor with cloud connectivity, the present disclosure supports scene analysis, embodied reasoning, in-context learning, and autonomous task code generation. For latency-critical actions such as grasping or manipulation, closed-loop motion control is executed locally using low-latency feedback from onboard sensors. This enables safe, adaptive, and precise operation in real-time.

In some embodiments, the system is also referred to as Assistio, offering a cost-effective, energy-efficient alternative to humanoid robots, with autonomous navigation and self-charging capabilities for continuous home assistance.

In some embodiments, the present disclosure describes a system relating to the field of domestic service robotics. Current humanoid robotic systems, while promising, are often prohibitively expensive due to the complexity and number of motorized joints. These systems also consume large amounts of power to maintain joint angles and static postures, resulting in impractical battery life. Assistio addresses these challenges by introducing a task optimized, energy-efficient robotic system capable of autonomously executing routine household chores. Furthermore, most humanoid robots lack the flexibility to utilize two independently placed or synchronized depth cameras mounted on adjustable vertical arms. Such configurations provide superior environmental coverage and adaptive scene understanding that are particularly valuable in unstructured household environments. Furthermore, most humanoid robots inherit structural choices from human anatomy—such as placing batteries in the chest or relying on legged locomotion to mimic walking. These anthropomorphic conventions often come at the cost of mechanical inefficiency, higher energy consumption, and unnecessary complexity. Assistio breaks with this paradigm. Its battery is mounted at the base, improving balance and minimizing energy used for posture maintenance. Instead of legs, Assistio employs a wheeled omnidirectional base with vertical lift-trading stair-climbing ability for simplicity, stability, and practical household deployment. Dual robotic arms are mounted directly to the base or vertical supports, eliminating the need for a torso and reducing the spatial footprint, especially when idle or stored.

Further, several robotic systems have been developed to assist with domestic and industrial tasks, particularly those involving mobility and manipulation. However, current systems often fall short in key areas such as autonomy, adaptability, multimodal perception, or seamless user interaction. Key differentiators associated with Assistio in relation to the existing systems are as follows:
Fully autonomous operation without reliance on manual control.
Dual multi-DOF arms capable of synchronized, bimanual manipulation.
Advanced perception using height-adjustable telescopic camera arms for dynamic 360 scene understanding.
Interprets natural language, gestures, and demonstrations for intuitive user input.
Performs scene analysis and task planning independently, adapting to new contexts without reprogramming.
Indoor-optimized for task-specific manipulation and real-time spatial reasoning in cluttered home environments.
Full manipulation capabilities with real-time autonomous decision-making.
Combines perception and manipulation for active domestic assistance.
Supports imitation learning from user demonstration or from narration of instructions.
Supports dynamic task reprioritization via real-time environmental analysis.
Prioritizes low-latency local control with cloud connectivity only for asynchronous functions.
Blends safety with closed-loop manipulation, in-context learning, and multimodal perception.

In some embodiments, the preset disclosure introduces a novel combination of features that distinguish it from existing robotic systems. These innovations advance the state of the art in mobile manipulation, perception, and autonomous domestic task execution:

### Dual-Arm Configuration on a Base

Unlike many prior systems that use a single arm or are stationary, Assistio incorporates two coordinated 6+ DOF robotic arms on a base. This enables complex bimanual operations such as lifting, folding, sorting, and stabilizing objects in dynamic home environments.
   Omnidirectional Mobile Base with Telescopic Lift
Rather than replicate human walking through complex and power-hungry leg designs, Assistio employs a wheeled base with a telescopic vertical lift. This solution offers smooth horizontal movement and adjustable reach without the drawbacks of leg-based locomotion.
   Modular Dual Arms without Torso Articulation
Assistio mounts dual arms directly onto the mobile platform or vertical rails-avoiding the mechanical overhead of a humanoid torso. This enables wide operational reach while minimizing volume, complexity, and maintenance requirements. It also allows the robot to compress into a compact footprint when not in use.

### Height-Adjustable Telescopic Camera Arms for Adaptive 360 Scene Awareness

Unlike robots with fixed cameras, Assistio uses telescopic arms to raise, lower, or reposition its cameras for the best view of the space. By placing two depth-sensing cameras on separate adjustable mounts, it gains strong 3D depth perception through triangulation—helping it accurately judge object distance and shape, which is essential for precise tasks like grasping. The flexible camera setup also provides 360 scene awareness, improving safety by detecting people, pets, or obstacles anywhere in the room. This allows Assistio to adapt to different home layouts while staying responsive and aware of its surroundings. In some embodiments, camera mounting configuration and elevation are selected according to task context, expected occlusion, and/or required measurement precision, and current camera elevation and pose are stored as metadata usable for endpoint computation, conformance testing, and later replay or audit.

### Base-Anchored Battery Design for Mechanical and Energy Efficiency

Unlike conventional humanoid robots, where batteries are elevated in the chest or backpack, Assistio locates its battery pack in the base. This anchors the system, lowers the center of gravity, and eliminates the need for energy consuming static balance. This departure from anthropomorphic mimicry results in improved energy efficiency, stability, and safety during manipulation. In some embodiments, one or more additional ballast masses, power modules, or energy-storage modules are positioned in a lower region of the base so that manipulator extension, sensor mast elevation, and payload handling remain within specified stability or tip-resistance envelopes.

### Self-Plugging Power Connection for Recharging

While most domestic robots rely on docking stations, Assistio can autonomously identify and plug into wall outlets using bimanual force-controlled manipulation. This allows charging in flexible home layouts and demonstrates a level of motor precision rarely attempted in consumer robotics. In some embodiments, charging workflows support both dock-based charging and wall-outlet plug insertion, and the selected charging path is determined according to battery state, outlet or dock availability, local reachability, and risk policy.

### Pushback Sensing on Telescopic Lifts and Robotic Arms

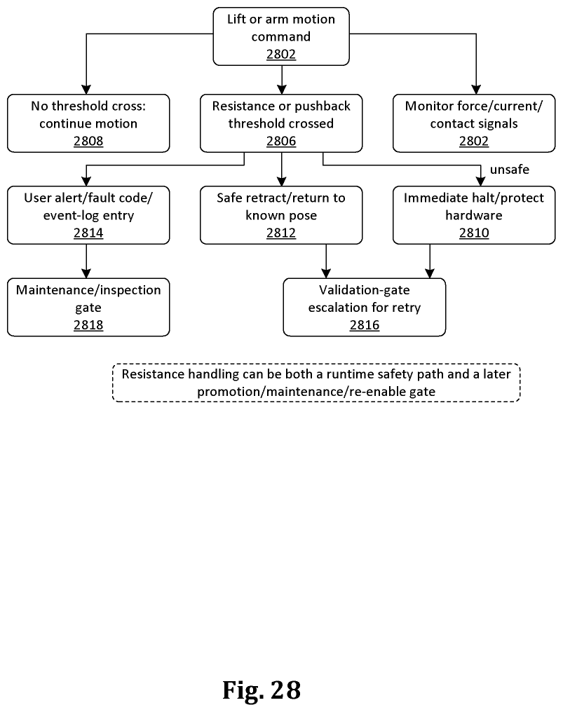

If resistance or pushback is detected during the extension or retraction of the telescopic lifts or during the movement of the robotic arms-the corresponding motor halts operation to prevent damage or unsafe contact. In some embodiments, such a condition additionally triggers one or more of: a safe retract, a user alert, a fault code, a captured event-log entry, a validation-gate escalation for later retries, and/or a maintenance or inspection requirement before re enabling the affected hardware path. FIG. 28 illustrates one non-limiting example in which a lift-or-arm motion command 2802 is accompanied by force/current/contact monitoring 2804, a detected resistance or pushback threshold crossing 2806 causes immediate halt/protect-hardware handling 2810, safe retract/return-to-known-pose handling 2812, and user-alert/fault-code/event-log handling 2814, and one or both of validation-gate escalation for retry 2816 and maintenance/inspection gate 2818. If no threshold crossing is observed 2808, motion may continue.

### Autonomous Operation Without Direct User Intervention

Unlike systems that rely on teleoperation, preprogramming, or assistive input devices, Assistio autonomously executes tasks using sensor fusion, onboard planning, and learned task policies.

### Local, Multimodal Embodied Reasoning

Assistio fuses real-time data from vision, touch, voice, and gesture, and performs reactive reasoning onboard. This contrasts with vision-dominant humanoids that rely on cloud inference. The system adapts its plan to local stimuli and interrupts or reprioritizes tasks based on emergent conditions, such as spills or human interaction.

### LLM-Based Autonomous ROS Code Generation

Assistio incorporates a large language model (LLM) fine-tuned on its ROS-based architecture. This enables autonomous generation of task-specific code from high-level verbal instructions or visual demonstrations—without manual programming—allowing non-technical users to teach new tasks.

### In-Context Learning via User Demonstration

The system can observe short user demonstrations and generalize the underlying task logic to new scenarios. This imitation-based learning approach enables rapid skill acquisition without retraining or dataset collection.

### Closed-Loop, Low-Latency Local Control

Manipulation tasks requiring sub-millisecond precision-such as grasping, insertion, or torque-limited actions are handled locally by Assistio's onboard processor. This eliminates reliance on cloud connectivity for critical feedback loops, ensuring fast and accurate execution.

### Multimodal Sensory Integration for Contextual Understanding

Assistio fuses visual, tactile, auditory, and gestural inputs to build a rich, semantic model of the environment. This enables robust task execution, adaptive reasoning, and intuitive user interaction.

### Safety-Aware Decision Making

The system continuously monitors for humans, pets, and unexpected obstacles using real-time sensor data. It dynamically replans trajectories and pauses or alters task execution to ensure safety in shared home environments.

### Self-X Autonomy Framework

Assistio performs self-cleanup, self-monitoring, self-validation, and self-calibration. It detects contamination on its own body, monitors internal metrics and balance, verifies whether actions achieved intended outcomes, and adjusts for mechanical drift using sensor feedback. These capabilities ensure long-term precision, stability, and autonomous recovery without human intervention.

In some embodiments, the present disclosure describes a system integrating the following features:
Dual coordinated arms for bimanual manipulation on a mobile platform.
Autonomous operation and task execution without remote input.
Height-adjustable telescopic cameras for adaptable 360 perceptions.
Seamless interaction using natural language, gesture, touch, and vision.
In-context learning and real-time imitation of user-demonstrated tasks.
Onboard code generation using a domain-tuned LLM for ROS.
Closed-loop manipulation using locally executed control loops.
Multimodal fusion with proactive safety mechanisms.

Further, this unique synthesis of mechanical versatility, perceptual intelligence, and autonomous reasoning positions Assistio as a novel and non-obvious advancement over existing domestic robotic systems.

In some embodiments, the present disclosure describes Assistio, a mobile robotic platform designed to autonomously perform a variety of household tasks with high precision, contextual awareness, and adaptability. Its modular hardware and intelligent control architecture comprises:
Dual multi-degree-of-freedom (DOF) robotic arms with tactile grippers for fine, coordinated manipulation.
An omnidirectional mobile base with mecanum wheels for smooth, precise indoor navigation.
Configurable depth-sensing camera systems, mountable individually or in dual configurations on telescopic vertical arms to enable full 360 spatial awareness;
A microphone and speaker system for two-way natural language interaction via voice recognition and feedback.
An onboard computing unit responsible for motion planning, perception, learning, and multimodal input fusion.

Further, a tactile gripper refers to a robotic end-effector equipped with embedded force, pressure, or contact sensors, enabling real-time feedback for grasp stability and nuanced object interaction.

Further, unlike systems that rely heavily on remote or cloud-based processing, Assistio executes closed-loop feedback control for real-time motion tasks-such as grasping a cup by its handle—directly on its local processor. This low-latency control architecture ensures responsive and accurate physical interactions. Cloud connectivity is leveraged only for non-time-critical operations such as model updates, long-term learning, and remote diagnostics, while all latency-sensitive feedback loops remain local.

Further, in some embodiments, the system supports autonomous code generation, enabling new tasks to be executed based on high-level verbal instructions or visual demonstrations without manual programming. Combined with its capabilities for scene analysis, object recognition, in-context learning, and safety-aware planning, Assistio delivers scalable, intelligent household assistance in dynamic and unstructured environments.

Further, in some embodiments, the system supports cross-device skill sharing. When one Assistio unit learns a new task via demonstration or instruction it can generate executable control logic and store this in a centralized or peer-accessible repository. Other Assistio units may retrieve and adapt this logic based on their own environment and sensory context. This allows skill propagation across different households without retraining or manual programming.

In some embodiments, the present disclosure describes Assistio is a multifunctional mobile robotic system designed to autonomously perform domestic tasks through advanced manipulation, perception, adaptive learning, and multimodal human interaction. It features a modular hardware architecture coupled with intelligent software that supports contextual awareness, autonomous reasoning, and real-time closed-loop control in unstructured household environments.

In some embodiments, the disclosed system comprises the following components:
Dual 6+ DOF Robotic Arms Modular, high-degree-of-freedom arms designed for precise, coordinated bimanual operation, capable of performing tasks such as lifting, folding, stacking, or delicately manipulating household items.
Tactile Grippers Interchangeable grippers equipped with force and contact sensors for detecting object weight, texture, and grip stability, enabling nuanced and safe interactions with fragile or irregularly shaped items.
Mobile Base, an omnidirectional drive platform with telescopic lift using mecanum wheels to support agile navigation within cluttered or tight indoor spaces.
Onboard Computer Manages all local processing, including perception, planning, motion control, voice interaction, learning, and feedback fusion. It enables real-time, closed-loop control for latency-sensitive tasks and integrates with cloud services for non-time-critical functions such as model updates.
Rechargeable Battery Pack Supplies extended operational power and is optimized for energy-efficient execution of tasks across several hours of continuous use.
Self-Docking Charging Interface Automatically guides the robot to a charging dock based on monitored battery status, ensuring uninterrupted service and autonomy.
Depth-Sensing Camera Module(s) One or two depth-sensing cameras can be flexibly configured and mounted on fixed positions or telescopic arms. These may be front-facing, panoramic (back-to-back), or lateral to achieve wide field-of-view and dynamic scene awareness based on task context. In some embodiments, the camera configuration is actively selected or repositioned to reduce occlusion, improve endpoint estimation, and satisfy one or more skill-specific perception requirements.
Telescopic Vertical Arms Height-adjustable mounts for elevating sensors like cameras and microphones to optimize scene perception, support 3D mapping, and maintain line-of-sight with target objects. Each telescopic arm includes a motorized actuator with integrated mechanical brakes, allowing the system to maintain elevation without consuming energy while stationary. In some embodiments, the telescopic vertical arm further includes a passive locking subsystem, and arm elevation is scheduled according to an energy-aware policy and/or observation-quality policy.
Height-Sensing Modules Built into the telescopic arms to provide real-time elevation data, ensuring accurate sensor alignment with workspace geometry. In some embodiments, elevation and pose data for a camera or other mast-mounted sensor are stored as metadata associated with a skill record, STP parameter binding, control artifact version, and/or validation result.

Further, the user interaction interfaces include:
Microphone with Voice Recognition Captures natural language voice commands and queries, enabling intuitive verbal interaction.
Gesture Recognition Sensors Detects body and hand movements for nonverbal command input and safety awareness.
Touchscreen or Display Panel Presents real-time system feedback, diagnostic tools, and manual overrides.
Speaker Module Enables the system to audibly communicate with users by providing real-time confirmations, status updates, clarifying questions, and task progress summaries. This module supports intuitive, bidirectional communication, enhancing user trust, transparency, and the overall quality of human robot interaction.

In some embodiments, the present disclosure describes the following advanced capabilities and functionalities:

### Multimodal Integration

Assistio integrates vision, touch, and voice inputs to achieve contextual understanding. It processes visual data from the panoramic and depth cameras alongside real-time audio and tactile feedback to assess task requirements and determine appropriate actions. Speifically:
   Visual input from depth-sensing camera modules.
   Tactile input via grippers.
   Auditory input from the microphone.
   Gesture input from motion sensors.
Further, the onboard computer fuses these inputs in real time to assess the context, understand user intent, and adapt system behavior. This fusion allows for rich semantic understanding and robust task execution in dynamic environments.

### Object Detection and Spatial Understanding

Utilizing depth perception, height sensing, and AI-based image analysis, Assistio performs:
   Object localization and classification.
   Spatial arrangement and occlusion detection.
   Orientation and pose estimation.
   Semantic segmentation of household areas (e.g., counters, sinks).

### Example: Identifying the Topmost Utensil in a Sink.

### Embodied Reasoning and Task Planning

Using the onboard computer, Assistio performs logical reasoning and multi-step task planning. Based on visual input, touch feedback, and user commands, it formulates plans such as:
   Locating and identifying objects.
   Selecting the appropriate arm and grip strategy.
   Navigating to the next location while avoiding obstacles.
   Executing task-specific sequences.
Further, the action primitives are dynamically chained into high-level goals, with on-the-fly adjustment in response to environmental or user-driven changes, all without requiring explicit programming.

### Example: Identifying a Cup and Selecting the Optimal Grasp Point Using Geometric and Visual Cues as Part of a Series of Objects to Pick and Place in a Dishwasher.

### Energy-Aware Task Planning

Assistio comprises an energy-aware planning module configured to prioritize or sequence tasks based on energy availability, environmental layout, or anticipated task duration. The onboard processor maintains a database of historical energy usage for previously performed tasks or initializes energy consumption values for new tasks based on default assumptions. These values are updated over time using sensor data and execution feedback, enabling the system to defer or reorder high-consumption activities when battery levels are low or when charging access is unavailable. In some embodiments, the same planning module schedules hardware-state changes including camera elevation, sensor-mast repositioning, lift extension, tool changes, and charging-path selection according to projected energy cost, expected perception benefit, and required safety margin. This ensures robust operation and resource optimization for mobile deployments across large or complex environments.

### Natural Language Understanding

Using the microphone and onboard NLP engine in the onboard computer, Assistio:
Processes commands with context-aware interpretation.
Handles ambiguous phrasing by initiating clarifying dialogue via speaker.
Executes multi-step instructions and provides progress feedback.
Example: “Pick up the red mug and place it in the top rack” triggers object search, disambiguation (if multiple red mugs), and placement action with verbal confirmation.

### Safety-Aware Decision Making

Assistio continuously monitors its environment through its sensors and predicts motion outcomes:
   Human and pet detection.
   Trajectory re-planning to avoid fragile or moving objects.
   Halting or pausing tasks in response to proximity alerts.
Further, this ensures secure operation in dynamic, shared living spaces and safe operation in households with children or elderly users.

### Dexterous Manipulation

Combining tactile grippers, dual robotic arms, and closed-loop feedback control via the onboard processor, Assistio performs fine manipulation tasks such as:
   Rotating and aligning objects.
   Folding fabrics or opening jars.
   Two-handed lifting and placement with load balancing.
   Real-time force feedback supports dynamic grip adjustment to avoid slippage or breakage.
Example: Assistio may use its right arm to grasp a stored power cord plug and using depth perception and force feedback, the system performs compliant insertion of the plug into the socket, dynamically adjusting for orientation, resistance, and contact pressure. If measured resistance or misalignment exceeds a threshold, the system aborts insertion, performs a safe retract, and either retries under modified parameters or routes to an alternate charging path.

### Support for External Tool Use

Assistio is configured to interact with external tools not physically integrated into the robot. This includes locating, retrieving, and employing household instruments such as kitchen utensils, grooming tools, or cleaning devices like vacuum extensions. The system maintains a spatial memory of tool locations using prior observations or user-provided mappings. During execution, the robot uses object detection, contextual cues, and path planning to navigate to tool storage areas, perform compliant retrieval using its manipulators, and complete the task using the external device. This enables greater versatility across diverse household scenarios and minimizes the need for tool specific robotic appendages.
   In-Context Learning from User Demonstration
Assistio learns new tasks through demonstration by:
   Observing user-performed actions via cameras.
   Recording motion trajectories and object interactions.
   In some cases, the user may narrate the actions they perform and the narration is used to better understand the context of the actions and object interactions.
   Generalizing learned behavior to new objects or contexts without retraining.
Example: Watching a user stack plates once enables replication of the procedure with different dishes and stack heights.

### In-Context Learning From Teleoperation

In addition to learning from demonstrations performed in front of it, Assistio can also learn tasks through teleoperation. A user may remotely control Assistio using a joystick, smartphone app, or haptic device to perform a task while the robot observes. During this process, Assistio records motion trajectories, sensor inputs, object manipulation and contextual cues associated with the task.
Further, the system analyzes this data to generalize actions, identify reusable task patterns and generate executable instructions. Once learned, the robot can repeat the task autonomously in the future, even in varied environments or with different objects. This capability is particularly valuable when the user cannot physically demonstrate the task in person or when teaching more complex procedures that require precision control.

### Scene Analysis and Context Switching

Advanced scene analysis allows Assistio to segment the environment semantically (e.g., differentiating countertop vs. sink area) and prioritize actions. It can interrupt and resume tasks based on detected changes, such as cleaning a spill mid-way through dish loading. By analyzing its environment with depth cameras and AI perception models, Assistio:
   Detects zones of activity (e.g., cluttered countertop, spilled liquid).
   Adjusts task priorities on the fly.
   Suspends current tasks to respond to environmental changes.
Example: If a spill is detected while loading dishes, Assistio pauses and addresses the spill before resuming.

### Gripping Strategy and Adaptive Manipulation

Assistio employs an intelligent gripping strategy that dynamically adapts to object type, task context, and environmental conditions. Through tactile sensing, scene understanding, and in-context learning, the system selects, adjusts, and refines its grasping approach in real time. This allows Assistio to handle a wide variety of domestic objects including fragile, slippery, or irregularly shaped items with precision and reliability. Assistio:
   Uses tactile grippers to detect object texture, weight, and slippage in real time.
Adjusts grip force dynamically based on feedback from embedded pressure and force sensors.
   Learns user-preferred grip patterns through demonstration, narration, or teleoperation.
   Executes bimanual cooperative gripping for large, heavy, or complex objects (e.g., lifting a tray or plugging into a wall outlet).
   Modifies grip strategy in response to environmental cues such as wet surfaces or obstructions.
   Shares learned grip strategies across devices via skill synchronization, enabling distributed learning and

### Refinement.

Example: When picking up a wet glass, Assistio detects decreased friction via tactile sensors and automatically switches to a two-handed, stabilizing grip. The same grip strategy tagged for “wet cylindrical glass” is later used by another Assistio unit in a different household, after retrieving the shared skill module.

### Autonomous Code Generation

After learning a task through demonstration or instruction, Assistio uses its onboard AI model to generate a set of structured instructions or rules that tell the robot how to perform a task, including what actions to take and when to take them, based on sensor inputs or internal state. This control logic is executed locally and stored on the robot for future use.
For example, after learning how to stack plates, Assistio converts the learned steps into reusable motion plans for its arms and base it can execute on command. This allows the robot to perform complex tasks without requiring programming, apps, or cloud-based processing.

### Closed-loop Local Control

Assistio uses real-time sensor feedback and low-latency control algorithms to execute fine motor tasks such as:
   Grasping a cup handle.
   Inserting objects into slots.
   Applying specific torque or force constraints.
Further, these tasks require sub-millisecond responsiveness and are not feasible via cloud-based control. Hence, Assistio's onboard processor ensures all latency-critical feedback loops—particularly those for manipulation-are executed locally.

### Learning Confidence and Uncertainty Modeling

Assistio employs uncertainty modeling to manage ambiguity in learning-based modules, including those that rely on large language models (LLMs) for autonomous ROS code generation. The system assesses learning confidence through reinforcement signals such as successful task completion, execution latency, or user feedback. User feedback may be verbal (e.g., spoken praise or correction) or visual (e.g., gesture approval, facial expressions). These multimodal feedback signals are interpreted by the perception subsystem and used to reinforce or revise the generated task policies. This enables the robot to improve task reliability, adapt code logic, and reduce error propagation across future executions.

### Cross-device Skill Sharing and Collective Learning

Once an Assistio unit acquires a new task skill whether through in-context learning, natural language instruction, or demonstration it stores the corresponding control logic in a shared cloud repository or via peer-to-peer synchronization. Other Assistio units, possibly located in different homes or environments, can access this repository and import the skill. Upon retrieval, the second unit uses its local perception modules to adjust the imported control logic (e.g., updating grip locations or spatial paths) based on its own geometry, objects, and layout.
Further, this mechanism enables collective learning, allowing all Assistio units to benefit from skills learned by any one robot, accelerating deployment and adaptation across diverse use cases. Skills may also include metadata, parameter templates, or environment tags to assist in transferability.
   American Sign Language (asl)
Assistio also supports interaction with users who communicate via American Sign Language (ASL), which is treated herein as a type of gesture input (sign-language gesture). A camera that has the user in its frame can detect when the user is using ASL and detect the user's instruction after translating the ASL into text. For example, a non-verbal user may sign ‘clean table,’ and the gesture recognition system interprets the command, initiating a surface cleaning routine. This capability extends Assistio's utility to users with diverse communication preferences.

In some embodiments, the present disclosure describes Assistio, designed to perform a wide range of domestic tasks across kitchen, cleaning, and organization domains. Its multimodal perception, dexterous manipulation, and autonomous reasoning capabilities enable it to adapt dynamically to real-world environments and user preferences. Below are representative use-case scenarios that highlight its features:

### Dishwashing Assistance

A user signs wash dishes using the compound ASL sign, and Assistio interprets the gesture to begin a dish-loading routine in the kitchen.
Scene Analysis identifies a cluttered sink with stacked dishes.
Object Detection locates plates, bowls, and utensils, determining their type and orientation.
Task Planning prioritizes loading the utensils at the top using appropriate grip force from the tactile grippers.
Dexterous Manipulation ensures precise two-handed transfer of items into the appropriate dishwasher compartments.
If a dish is obstructed or the dishwasher is full, Assistio may pause, alert the user via speaker, and wait for confirmation.
The system resumes loading or closes the door based on user input via voice or touchscreen.

### Kitchen Cleanup

Assistio patrols the kitchen post-meal, detecting spills or misplaced objects using its depth cameras.
A liquid spill is detected on the countertop.
It navigates to a storage area, uses in-context learning to locate and retrieve a paper towel or sponge.
The robot performs localized wiping using adaptive arm control and closed-loop feedback from real time image analysis, ensuring effective cleanup without damage to surfaces.
Upon completion, it returns the cleaning tool and provides a verbal task summary via speaker.

### Sorting and Organizing Items

Assistio is tasked with organizing a toy bin or bookshelf.
Through object classification, it identifies items by shape, label, or color (e.g., books, dolls, vehicles).
A user instructs: “Put the blue books on the top shelf and the rest in the bin.”
The robot uses natural language understanding to interpret this multi-step task and confirms via voice: “Do you mean the dark blue and light blue books?”
After confirmation, Assistio plans a multi-arm sorting routine, performs the task with careful placement, and confirms completion via both visual update on the screen and audio feedback.

### Folding Laundry

Assistio detects a pile of unfolded laundry on a table using scene segmentation.
A user demonstrates folding a towel once; Assistio records this and replicates the folds using imitation learning and closed-loop control to maintain precise fold lines.
It separates clothing by type (e.g., shirts, socks) using object detection and classification.
Upon completing a batch, Assistio notifies the user verbally and displays the status on the touchscreen.

### Ad Hoc Task Instruction

A user gives a voice command: “Pick up the new package at the door and bring it to the kitchen.”
Assistio uses depth sensing and spatial awareness to locate the door area and identify the object based on dimensions and packaging cues.
If it encounters multiple candidates, it initiates a clarification: “Do you mean the brown box or the white envelope?”
Upon confirmation, it retrieves the correct item using autonomous path planning, and delivers it safely using its bimanual arms while maintaining balance and avoiding obstacles.

### Real-Time Task Interruption and Context Switching

While loading the dishwasher, Assistio's vision system detects a glass has tipped on the counter.
Using scene analysis, it prioritizes recovering the fragile item before it falls.
The current loading sequence is paused, and the robot reorients its attention to safely retrieve the glass.
After resolving the interruption, it resumes the original task from the last completed step, preserving workflow continuity.

In some embodiments, the present disclosure describes Assistio, a robotic system which is modular and may be implemented in several configurations, depending on user requirements, home layout, or manufacturing constraints. The following design variations and alternative configurations are contemplated within the scope of the present disclosure:

### Robotic Arm and Gripper Configurations

Arms may include fewer or more degrees of freedom (DOF) than the 6+described, depending on the complexity of the tasks targeted.
The system may use single-arm configurations for constrained environments or specialized task sets.
Grippers may be replaced with suction-based manipulators, multi-finger anthropomorphic hands, or task-specific tools (e.g., mops, scrapers, bottle openers).

### Camera and Sensor Placement

The depth-sensing camera modules may be mounted:
   On fixed front-facing positions.
   On dual telescopic arms.
   On rotating turrets.
   Single-camera systems may be used for simplified cost-sensitive models, while multi-camera setups may enhance coverage in complex environments.
   Additional sensors such as LiDAR, radar, sonar, ultrasonic sensors, infrared cameras, ultraviolet cameras, thermal cameras, or environmental sensors (CO, VOCs) may be integrated.

### Mobility Platform Variants

In some embodiments, the base may adopt a circular geometry to reduce turning radius and support tighter indoor navigation. The mobile base may use:
   Tracked treads for improved grip on carpeted or uneven floors.
   Legged locomotion for stair-climbing or terrain adaptation.
   Wall-mounted or ceiling-mounted variants for confined living spaces or smart kitchens.
   Static versions of Assistio (no wheels) may be designed for fixed-location use (e.g., beside kitchen sinks or workstations).
In one embodiment, the system may be configured with a humanoid-style head mounted on the upper portion of the vertical support structure. This head includes integrated cameras for vision, a microphone array for audio input, and one or more speakers for audio output. The vertical support structure in this configuration serves as a substitute for a traditional torso and also anchors both robotic arms. This arrangement enables expressive interaction and intuitive communication with users, while maintaining the compact and balanced mechanical design of the system.

### Power and Energy Systems

In addition to rechargeable batteries, Assistio may support:
   Swappable battery packs.
   Wired power operation for continuous-use environments.
   Solar charging for eco-friendly operation in well-lit environments. In an alternative or supplementary embodiment, Assistio includes the capability to autonomously connect its power plug into a standard electrical outlet for recharging. The robot stores a retractable power cord within a compartment accessible to one of its robotic arms. Upon detecting a low battery state, the system locates a known or visually identified wall outlet using its depth-sensing camera modules and onboard perception algorithms. It then retrieves the plug using its tactile gripper, navigates to the outlet, and inserts the plug using visual-serving and force controlled manipulation to ensure secure electrical contact. This plug-in mechanism enables recharging in environments where self-docking stations are impractical or unavailable and showcases advanced bimanual coordination and precision insertion capabilities. In some embodiments, the plug-in workflow is governed by a charging-interface validation profile that checks reachability, outlet geometry, force or resistance limits, and an abort or safe-retract policy before reattempting insertion.

### Processing and Control Architecture

The system may include:
Hybrid compute models using edge processors for real-time control and cloud processors for model training and synchronization.
Hardware acceleration for deep learning models (e.g., embedded GPUs, TPUs).
A central hub design where perception and planning are processed externally and streamed to multiple robot units.

### User Interaction Modalities

Interaction interfaces may include:
   Heads-up displays (HUDs) via augmented reality glasses or projection.
   Haptic input devices for direct teleoperation or assisted training.
   Smartphone/tablet-based control panels.
   Voiceprint-based user authentication for personalized interaction and task assignment.
Additionally, the gesture recognition interface may be configured to interpret American

Sign Language (ASL), enabling communication with non-verbal users. This enhances accessibility and expands the range of intuitive human robot interaction methods supported by Assistio.

### Environmental Integration

Assistio may interface with:
   Smart home systems (e.g., lights, thermostats, appliances).
   IoT sensors for motion, humidity, or air quality monitoring.
   Voice assistants (e.g., Alexa, Google Assistant) via standard APIs.

### Use-Specific Variants

Compact models for:
   Studio apartments, RVs, or elder-care rooms
   Heavy-duty models for: Commercial kitchens, office maintenance, or retail stockroom assistance.

### Expandability and Customization

Modular accessory kits may allow for:
   Task-specific attachments (e.g., grooming tools, screwdrivers, feeding aids).
   Modular storage or payload trays.
   Custom tool-change interfaces.

In some embodiments, the present disclosure describes the following advantages associated with the system:
Cost-effective alternative to humanoid robots, reducing mechanical complexity and actuator count without sacrificing functionality.
Energy-efficient design enables longer operational time between charges, aided by a larger battery pack.
Motorized telescopic lifts for camera positioning include mechanical brakes, which allow the cameras to maintain elevation without continuously consuming power thereby reducing idle energy drain and extending battery life during prolonged observation or monitoring tasks.
Autonomous charging behavior with a self-docking interface ensures uninterrupted operation with minimal user intervention.
Modular and scalable architecture, allowing customization for different home sizes, user needs, or budget tiers.
High adaptability and task flexibility, capable of performing a wide range of domestic tasks including dishwashing, organizing, cleanup, and more.
360-degree environmental awareness via flexible camera module placement (telescopic arms or fixed positions), enabling panoramic visual context.
Enhanced safety and obstacle avoidance, using real-time environmental monitoring, proximity alerts, and trajectory re-planning.
Multimodal perception integration, fusing vision, touch, and voice data for robust scene understanding and task execution.
Natural user interaction, including voice, gesture, and touchscreen inputs, requiring no
Autonomous code generation, allowing new tasks to be learned from high-level user input or demonstration-without manual programming.
Closed-loop local feedback control, enabling real-time precision in grasping and manipulation tasks without cloud dependency.
In-context learning and imitation-based task acquisition, allowing rapid onboarding of new skills based on a few demonstrations.
Context switching and scene analysis, permitting dynamic reprioritization of tasks based on real-time environmental changes (e.g., cleaning spills mid-task).
Cloud-connectivity for non-time-critical updates, diagnostics, and performance logging, while maintaining privacy and control for real-time execution.
Breaks away from anthropomorphic design, choosing efficiency over mimicry in areas such as battery placement, locomotion, and arm configuration.
Anchors its battery in the base, using gravitational physics to improve balance and reduce energy drain for static posture.
Replaces legged mobility with an omnidirectional wheeled base that incorporates vertical lift prioritizing reach and simplicity over stair-climbing.
Enables dynamic, interruptible workflows by analyzing environmental changes and responding mid task, such as stopping to clean a spill.
Eliminates the need for screens or apps-users simply demonstrate tasks or issue verbal instructions for learning and task execution.
Provides developer-friendly APIs and skill plug-ins, making Assistio not just a product but a platform for household robotics.
Supports skill sharing across units via a shared learning architecture, enabling distributed task execution and rapid adaptation without retraining, so a task learned by one Assistio can be exported and performed by another-enabling collective robotic intelligence.
Collective intelligence model allows distributed robots to improve functionality over time
Reduces redundancy and enables rapid global adaptation of new tasks.

In some embodiments, the present disclosure describes a system enhancing stability and safety by lowering the battery's placement. Further, the system improves energy efficiency and ease of use in home environments. Further, the system enhances mobility while maintaining stability for the user. Further, the system simplifies design and enhances safety by mounting arms directly onto a stable support structure. Further, the system enables comprehensive visual feedback for users with mobility impairments. Further, the system empowers individuals by allowing them to interact directly rather than relying on pre-programmed content. Further, offers flexibility for charging devices through various docking stations, supporting future expansion of the system. Further, enhances adaptability and scalability through a modular design that supports both individual use cases and larger systems.

In some embodiments, the present disclosure describes a mobile robotic system for performing household tasks, comprising:
A tactile gripper attached to the robotic arm.
At least one depth-sensing camera module, optionally mounted on a height-adjustable
An onboard processor configured for local control.
And a rechargeable battery pack, wherein the system is capable of performing real-time manipulation, perception, task planning, and navigation.

Further, the mobile base is vertically adjustable to extend the robot's operational reach.

Further, the robotic arm is one of two coordinated arms configured for bimanual operation, enabling dual-arm manipulation and collaborative task execution.

Further, the tactile gripper includes force and contact sensors enabling real-time feedback for closed-loop grasping and manipulation control such that the tactile gripper detects surface properties, contact force, and slip conditions to support closed-loop grasping.

Further, the onboard processor is configured to execute closed-loop feedback control locally, independent of cloud processing, for low-latency manipulation tasks.

In some embodiments, the system described in the present disclosure further comprising a docking interface configured for automatic alignment and electrical contact, wherein the robot autonomously returns to the docking station based on internal battery status.

In some embodiments, the system described in the present disclosure further comprises an autonomous plug-in interface, wherein the robot identifies a standard wall outlet and uses its robotic arm to grasp, align, and insert a power plug based on visual and spatial perception.

In some embodiments, the system described in the present disclosure further comprises at least one telescopic vertical arm configured to adjust the height of the camera module or other sensors.

Further, the camera modules are configured in a solo or dual arrangement and may be mounted in front-facing, panoramic, or side-facing positions for 360-degree environmental awareness.

In some embodiments, the system described in the present disclosure further comprises two independently positionable telescopic arms, each carrying a depth-sensing camera, wherein the cameras are configured to adjust height and orientation for dynamic triangulation and panoramic environmental perception.

Further, the onboard processor is further configured to:
Fuse data from visual, tactile, auditory, and gestural inputs.
Perform real-time scene segmentation and spatial mapping.
And interpret multimodal input to determine user intent.

In some embodiments, the system described in the present disclosure further comprises a microphone and speaker, wherein:
The microphone is configured to receive natural language commands.
The speaker is configured to provide verbal confirmations, task updates, or clarifying questions.

Further, the onboard processor includes a model configured to autonomously generate task-specific control logic based on verbal instructions, visual cues, or observed demonstrations.

Further, the autonomously generated task logic is stored and reused for subsequent executions of similar tasks without requiring manual programming.

Further, the onboard processor adjusts its task execution policy over time using feedback from task outcomes, user interaction, or environmental response.

Further, the onboard processor supports in-context learning by observing short user demonstrations and generalizing the demonstrated behavior to new objects or environments.

Further, the onboard processor is further configured to dynamically reprioritize or
A touchscreen or display panel for visual interaction and manual control.

Further, the model is a large language model (LLM) fine-tuned on robotic control code implemented in the Robot Operating System (ROS), and is configured to generate syntactically valid and semantically meaningful ROS node scripts or launch files based on natural language input.

Further, the LLM-based code generation is triggered by a natural language command received via the microphone or by the interpretation of a user demonstration, and produces control logic that is directly executable on the robot's onboard processor.

Further, the generated ROS code is stored in a local repository and version-controlled to allow for rollback, refinement, and reuse in similar task contexts.

Further, the user demonstration comprises a sequence of physical actions observed through the robot's camera module, and the system generates an abstracted task plan based on extracted motion trajectories and object interactions.

Further, the narration accompanying the demonstration is interpreted to extract semantic context to supplement contextual understanding of object categories, relationships, or task sequencing.

Further, the generalized task plan includes parameterizable variables allowing the learned behavior to be adapted to different object types, spatial layouts, or environmental conditions.

In some embodiments, the present disclosure describes a method for distributed task execution in a robotic system comprising a plurality of mobile robots, the method comprising the following steps:
Generating task-specific control logic on a first robot based on a user demonstration or natural language instruction.
Storing the control logic in a shared repository accessible to multiple robots.
Retrieving the control logic on a second robot located in a different environment.
Adjusting the control logic on the second robot based on local sensory input to execute the task within its environment.

Further, the stored control logic includes parameterizable variables that allow adaptation to different spatial layouts, object dimensions, or user preferences.

Further, the repository is a cloud-based skill library or a peer-to-peer synchronization channel between robots.

Further, the second robot evaluates task execution performance and updates the control logic, thereby improving the shared skill for future retrieval.

Further, the retrieved control logic comprises parameterizable variables enabling context-specific adaptation based on local sensor input.

Further, the control logic includes metadata describing environmental context, object types, or task constraints to guide adaptation on secondary units.

Further, skill transfer occurs through direct peer-to-peer synchronization between robotic systems operating in separate environments.

Further, the onboard processor includes a fallback operational mode configured to maintain limited autonomous functionality during loss of cloud connectivity.

Further, the onboard processor supports a modular software framework for executing third-party skill modules developed via a documented API.

In some embodiments, the present disclosure describes a self-adjusting workspace system that enables autonomous navigation, task execution, and adaptation in dynamic environments. The system leverages modular components, advanced sensors, and intelligent control algorithms to achieve its functionality. This disclosure provides detailed descriptions of the technical features of the invention, including inherent and additional technical improvements that enhance specific technologies used in the system.

In some embodiments, the system described in the present disclosure incorporates AI-driven adaptive learning algorithms that enable the system to learn from past task executions and improve its performance over time. This allows the system to adapt its strategies based on feedback from previous interactions with the environment.

In some embodiments, the system described in the present disclosure integrates haptic feedback technology using advanced sensors to provide tactile information about the environment and objects being manipulated. This allows for more accurate and controlled task execution.

In some embodiments, the system described in the present disclosure incorporates real-time environmental monitoring using low-power sensors that provide continuous data on the state of the workspace. This allows the system to adjust its operations accordingly.

In some embodiments, the system described in the present disclosure employs adaptive task prioritization algorithms using fuzzy logic to determine the most critical tasks based on current environmental conditions and system resources. This ensures efficient and effective task execution even in resource constrained scenarios.

In some embodiments, the system described in the present disclosure integrates advanced vision-based obstacle detection using high-resolution cameras and AI algorithms to identify and avoid obstacles with greater accuracy and efficiency.

In some embodiments, the system described in the present disclosure incorporates predictive maintenance algorithms using AI to monitor component health and predict potential failures before they occur. This reduces downtime and ensures continuous operation in demanding environments.

In some embodiments, the system described in the present disclosure incorporates energy-efficient design principles to reduce power consumption and extend operational time in mobile or battery-powered environments.

In some embodiments, the system described in the present disclosure incorporates multi-modal interaction interfaces that allow users to provide input through multiple modalities, such as gesture control, voice commands, or touch inputs. This enhances user experience and flexibility in operation.

In some embodiments, the system described in the present disclosure incorporates local data processing capabilities to ensure that sensitive information is handled securely within the system itself, reducing the risk of data breaches or unauthorized access.

In some embodiments, the system described in the present disclosure is designed to integrate seamlessly with IoT platforms, enabling remote monitoring and control of the system's operations. This allows for easier management and troubleshooting from a distance.

In some embodiments, the system described in the present disclosure incorporates 5G connectivity to enable high-speed communication and data transfer, ensuring efficient operation even in highly dynamic environments.

In some embodiments, the system described in the present disclosure represents a significant advancement in Self-Adjusting Workspace technology, enabling autonomous navigation, task execution, and adaptation in dynamic environments. The system's modular components, advanced sensors, and intelligent control algorithms provide a robust foundation for achieving these functionalities. Furthermore, the inherent and additional technical improvements detailed above enhance specific technologies used in the system, offering extended functionality, efficiency, and adaptability.

Further, in some embodiments, the system incorporates an autonomous issue detection and correction mechanism designed to identify and resolve operational anomalies, such as dirt accumulation, task failures, or mechanical drift. Further, this feature enables continuous monitoring and self-correction without requiring external input, ensuring consistent performance across various operational scenarios.

In some embodiments, the system further comprises a weight ballast housed in the lower portion of the mobile base. This ballast lowers the center of gravity and enhances mechanical stability during manipulation or navigation, especially when the telescopic arms are extended or when carrying payloads.

Further, the system employs proactive state monitoring through a combination of sensors and metrics to identify potential issues before they impact operations. Further, it utilizes inertial measurement units (IMUs) for tracking joint loads and accelerometers for balance detection, enabling preemptive problem identification and resolution.

Further, once an issue is detected such as dirt buildup or task failure, the system automatically triggers corrective actions. Further, these include activating self-cleaning mechanisms or retrying tasks with enhanced validation protocols to improve the likelihood of achieving successful outcomes.

Further, the system adapts to environmental changes by integrating sensor feedback and internal models. This allows it to compensate for kinematic drifts and maintain balance during tasks such as lifting, reaching, or other manipulative actions.

In some embodiments, the present disclosure describes a robot designed for flexibility in control systems and middleware, supporting integration with various platforms such as ROS (Robot Operating System), YARP (Yet Another Robot Platform), or industrial controllers. This cross-platform capability is achieved through abstraction layers that preserve core functionality while allowing for modular system updates.

Further, in some embodiments, instead of using ROS, the following platforms can be used:
YARP (Yet Another Robot Platform) for distributed communication.
OROCOS for real-time control.
Genom3 for safety-critical applications.
Industrial Controllers: Industrial PCs or Programmable Logic Controllers (PLCs) to control robot's movements and integrate it with factory automation systems.
Custom Stacks: For high-performance tasks, custom codes can be written using libraries like:
   MRPT (Mobile Robot Programming Toolkit) for direct firmware-level programming.
   Rust-based Frameworks Like Dora-rs.

In some embodiments, the system supports extended skill-transfer workflows and governance enhancements that improve reproducibility, integrity, and cross-domain portability of skill packages. These embodiments may be used in combination with any of the foregoing embodiments.

In some embodiments, the system stores an event log (also referred to as a trace and/or replay log) describing an execution or demonstration as a time-ordered sequence of semantic events, separate from raw sensor streams. The event log may represent STP step transitions, parameter slot binding events (including multimodal source-evidence metadata), termination events, safety filter veto events, gesture events (e.g., pointing used for grounding), environment map or scene-model update events, and outcomes.

In some embodiments, an event log is versioned by an event-log schema identifier (also referred to as a trace schema identifier or trace schema version) indicating an interpretation of event fields, units, and semantics. The event log schema identifier may be stored in a skill record and/or a skill package to enable later decoding, diffing, and analysis.

Workflow narrative: A user demonstration or other workflow capture session (video, teleoperation, kinesthetic teaching, AR/VR authoring, virtual-world interaction, and/or low-bandwidth assistive intent capture) is captured as one or more assets including raw media and a semantic event trace. The system derives an STP template and/or artifact, stores the trace with a trace schema version, and packages the trace as part of a skill package for transfer. A destination robot imports the skill package, verifies integrity, re-perceives and re-binds parameter slots locally, and uses the trace as a preview and/or for debugging prior to physical execution. In some embodiments, a destination user device renders the trace as an instructional replay to guide a human executor, and human-performed outcomes are recorded as additional trace events and metrics for write-back.

Non-limiting embodiments include: (i) a trace containing only high-level STP step events; (ii) a trace containing action primitives and controller state summaries; (iii) a trace generated from video segmentation and narration; (iv) a trace generated from teleoperation logs; (v) a trace generated from a simulation or virtual-world engine; (vi) a trace including gesture or annotation events (e.g., pointing, selection, sign) used for grounding; (vii) a trace including environment map or scene-graph update events used for conformance and adaptation; (viii) a trace including human guidance prompts and human-acknowledged step completions for robot-to-human transfer; (ix) compression and privacy filtering of raw streams while preserving event traces; and (x) a trace generated from a low bandwidth intent/approval session in which a user provides selections or confirmations without performing a physical demonstration.

Validation gate checklist (example): verify trace hash and signature if required; verify trace schema compatibility; verify that the trace compiles to an STP with explicit termination criteria; verify that any included bindings are treated as hints and that destination-side perception rebinding is performed; and verify that safety policies and no-go zones are satisfiable in the destination environment.

In some embodiments, the system stores reproducibility metadata for simulation and replay, including one or more of: simulator identifier, simulator version, physics profile identifier, determinism mode indicator, and random seed values used to generate scenarios.

In some embodiments, when a validation gate, simulation gate, or runtime execution detects a failure condition, the system generates or stores a minimal reproduction bundle (minimal repro) that is sufficient to reproduce the failure in a simulator or test harness. The minimal repro bundle may include a reduced scenario description, a trace segment, and a parameter-binding template.

Workflow narrative: A robot executes a skill under a validation gate and optionally a simulation regression suite. Upon detecting an anomaly (collision, force spike, safety veto spike, or policy violation), the system automatically produces a minimal repro bundle and attaches it to an evidence bundle stored in the skill record. The evidence bundle is used to justify demotion/quarantine and to validate a patch/delta prior to re-promotion.

Non-limiting embodiments include: (i) minimal repro generation by shrinking randomized parameter ranges to a boundary condition; (ii) minimal repro generation by slicing a trace to a shortest failing prefix; (iii) storing multiple minimal repros per failure class; (iv) using minimal repros as regression tests that must pass prior to promotion or freeze; and (v) storing minimal repros locally only or in a shared repository.

Validation gate checklist (example): ensure evidence bundles are hash-bound to the evaluated artifact and STP template; ensure minimal repro bundles use de-identified or privacy-filtered assets when required; ensure minimal repro bundles do not override safety policies; and ensure that promotion requires passing a specified test protocol including minimal-repro regression.

In some embodiments, the skill package or skill record stores one or more trust inputs used as policy hints to select gating strictness, including publisher identity, publisher tier, contributor identity, review history, and moderation flags.

Workflow narrative: Upon retrieval of a skill package from a channel (registry, marketplace, peer-to-peer, or offline media), a destination robot evaluates integrity (hashes, signatures) and also evaluates trust inputs. The system selects a policy that may require quarantine, sandbox execution, stronger validation checks, human approval, and/or simulation gate prior to actuation, based on the trust inputs and risk tier. Integrity checks, conformance tests, and safety gates are not waived due to trust inputs.

Non-limiting embodiments include: (i) publisher tiers such as personal-share, organization-signed, marketplace verified, or regulator-certified; (ii) policy that never waives integrity checks based on trust inputs; (iii) policy that escalates to quarantine for unknown publishers; (iv) policy that requires multi-party approval for high-risk actions; and (v) storing trust inputs separate from technical artifacts to avoid mixing identity with execution.

Validation gate checklist (example): verify integrity regardless of trust inputs; ensure trust inputs only increase (not decrease) required gates; ensure revocation and emergency bulletins override trust; and ensure audit logs record trust evaluation decisions.

In some embodiments, the system anchors one or more hashes (e.g., artifact hash, STP template hash, evidence bundle hash, approval packet hash, or revocation list hash) to an append-only ledger or distributed ledger as an optional audit mechanism. Payloads of skill packages, traces, and telemetry remain off-ledger.

Workflow narrative: A publisher generates a skill package and computes hashes for core artifacts and evidence. The publisher writes an anchor record to a ledger. A destination robot validates a skill package offline by verifying local hashes and signatures and optionally consulting a cached ledger anchor and cached revocation lists; if the ledger is unavailable, the robot continues to enforce safety policies and can demote/quarantine based on local integrity and runtime outcomes.

Non-limiting embodiments include: (i) ledger anchoring performed by a registry operator; (ii) batching anchor writes; (iii) multi-signature approval packets anchored; (iv) privacy-preserving anchoring using only hashes; and (v) using non-ledger channels to distribute revocations and emergency bulletins.

Validation gate checklist (example): treat ledger anchors as integrity-only signals and not as safety substitutes; verify signatures and hashes locally; enforce cached revocations even when offline; and prevent storing sensitive telemetry on-ledger.

In some embodiments, the system supports cross-domain skill transfer in which a semantic STP is compiled into a domain-specific artifact using a domain adapter. Non-limiting domains include: home/industrial workcells, space/microgravity, deep ocean/high pressure, in vivo environments, and virtual environments.

In some embodiments, the system stores a build or port manifest describing the compilation, including input hashes, target domain identifier, physics profile identifier, transforms applied, toolchain versions, and output hashes. The build/port manifest may be stored as a patch/delta and used for diffing and reproducibility.

Workflow narrative: A semantic STP template is derived from demonstration or instruction and is compiled by a domain adapter into an artifact targeted to a domain class and environment envelope. The output is gated by conformance tests and a validation gate, and optionally by simulation regression tests based on domain-appropriate physics profiles. Results are stored as evidence bundles and used for promotion/demotion and freeze decisions.

Non-limiting embodiments include: (i) compiling a macro-scale “deliver payload” STP into an in vivo artifact controlled by an external field controller; (ii) compiling an “align and mate” STP into a microgravity artifact with momentum constraints; (iii) compiling an “inspect and retrieve” STP into a deep-ocean artifact with station-keeping policies; (iv) maintaining separate promotion tracks per environment class; and (v) requiring shadow-mode audition before actuation in high-risk or low-supervision domains.

Validation gate checklist (example): verify manifest hash binding between inputs and outputs; verify environment envelope compatibility; verify termination and abort criteria are explicit per step; verify simulation gate uses a physics profile appropriate to the target domain; and block promotion unless evidence bundles satisfy the test protocol.

In some embodiments, the system supports delay-tolerant or intermittently connected skill transfer, in which skill packages and updates are transported by store-and-forward channels and enforced using cached integrity and revocation data.

Workflow narrative: A first site publishes a skill package and an approval packet prior to deployment in a remote or disconnected location. The remote robot caches a set of trusted keys, revocation lists, and emergency bulletins, performs conformance and validation gates locally, executes under runtime safety filters, and records evidence for later asynchronous upload and retroactive scoring.

Non-limiting embodiments include: (i) physical media transfer (e.g., portable storage media such as USB or SD cards carrying a skill package and associated metadata); (ii) high-latency communication links; (iii) periodic synchronization windows; (iv) demotion and rollback without network connectivity; and (v) post-execution human review in lieu of real-time teleoperation.

Validation gate checklist (example): verify signatures against cached keys; verify revocation lists and emergency bulletins are current within a policy window; enforce conservative modes for high-risk actions; and require local safe stop/retract behavior independent of connectivity.

In some embodiments, a single-agent STP is decomposed at a destination environment into cooperative subtasks for a plurality of robots or a swarm based on destination-local capability data and local state data, including synchronization points, shared safety envelopes, and coordination contracts specifying behavior upon desynchronization or loss of communication.

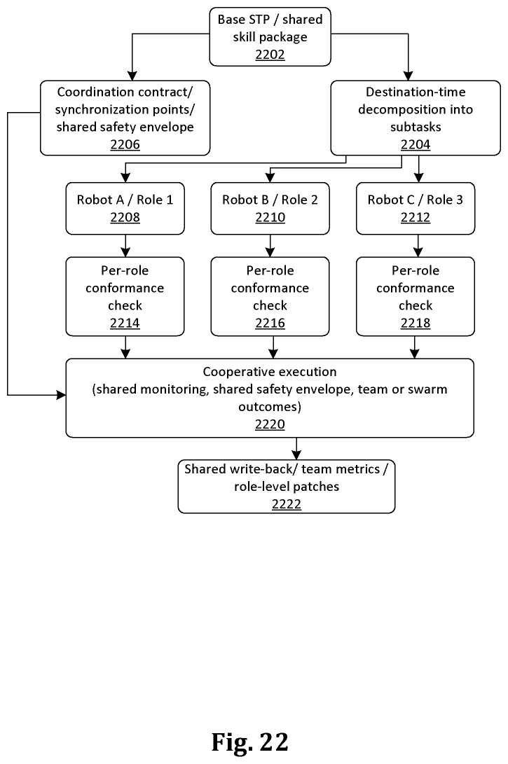

Workflow narrative: A base STP is received at a destination environment and decomposed into cooperative subtasks. The destination runtime identifies available robotic devices, evaluates destination-local capability data and local state data, and allocates subtasks to the devices at execution time. Prior to team execution, per-subtask conformance checks are performed to verify capability compatibility and safety constraints before activation, and the team executes with shared monitoring. Each agent writes back outcomes and patches/deltas, and a registry aggregates multi-agent metrics for scoring, convergence detection, and freeze decisions. FIG. 22 illustrates a non-limiting example in which base STP/shared skill package 2202 is processed by destination-time decomposition 2204 and coordination contract/shared safety envelope 2206, after which role placeholders are resolved to destination-selected robot/role assignments 2208, 2210, and 2212. In the example of FIG. 22, per-role conformance checks 2214, 2216, and 2218 are performed before those roles participate in cooperative execution 2220, and the resulting team metrics and role-level updates are collected as shared write-back 2222.

Non-limiting embodiments include: (i) leader/follower allocation; (ii) quorum policies; (iii) redundant execution; (iv) safe stop on communication loss; and (v) per-role promotion/demotion states. In some embodiments, the three robots and three roles depicted in FIG. 22 are illustrative only, and the number of participating robots, role placeholders, and conformance checks may be fewer or greater, including swarm execution, temporary role reassignment, fallback to a single robot for one or more subtasks, and/or delayed admission of a robot into cooperative execution until its corresponding conformance checks succeed.

Validation gate checklist (example): verify each subtask allocation is satisfiable; verify per-subtask conformance checks pass before activation; verify sync point termination criteria; verify keep-out zones between robots; and verify communication-loss policy yields a safe stop or a degraded mode.

In some embodiments, to evaluate whether a skill, artifact, or STP-derived execution is correct or needs improvement, the system specifies one or more success criteria (also referred to as correctness criteria), measures outcomes using sensor-based feedback mechanisms, and applies an improvement model that proposes one or more refinements when one or more success criteria are not satisfied. Success criteria may be expressed in an STP (e.g., completion criteria) and/or in a validation policy or test protocol packaged with a skill package, and may be used for both local execution decisions and promotion/demotion decisions across a fleet.

Workflow narrative: The robotic device executes an artifact under local closed-loop control and logs time aligned sensor data and state summaries. The device computes one or more measurable metrics (e.g., end-effector pose error, insertion depth error, contact-force envelope violations, slip indicators, collision indicators, time-to-complete) and compares the metrics to one or more success criteria. When a criterion is not satisfied, the device determines a discrepancy and optionally classifies the discrepancy into an error category selected from an error taxonomy (e.g., slip, misgrasp, collision, occlusion, misalignment, timeout, or excessive force). The device selects an adaptation action based on the discrepancy (e.g., rebind a parameter slot, widen or narrow a parameter range, change a grasp point, adjust a trajectory segment, or modify a controller parameter), generates an update (e.g., a patch/delta and/or updated parameter bindings), and re-performs the validation gate (and optionally a simulation gate) prior to re-execution or prior to promotion of the updated version.

Non-limiting embodiments include: (i) success criteria defined per STP step (e.g., completion criteria) and/or per task (e.g., final object pose within tolerance); (ii) success criteria that include state predicates (e.g., door closed), contact predicates (e.g., stable contact force within bounds), and/or time/resource predicates; (iii) metric computation from perception sensors, tactile sensors, force/torque sensors, joint-torque sensors, proprioception, inertial sensors, tool telemetry sensors, and/or wearable sensors (including physiological and/or neural sensing such as EMG and/or EEG); (iv) discrepancy diagnosis using a rule set, a learned classifier, a model-based estimator, and/or human-in-the-loop feedback; and (v) improvement models that generate patches/deltas, parameter-binding updates, controller-parameter updates, and/or rollback decisions.

Validation gate checklist (example): verify that success criteria are explicitly declared and machine-checkable; verify that required feedback channels are available and calibrated (e.g., camera calibration, wearable calibration, and sensor-to-world alignment when used); verify that metric computation is defined and repeatable; verify that proposed adaptations are bounded by safety policies (e.g., force/torque limits and keep-out zones); require simulation regression and/or human approval for high-risk adaptations; store an evidence bundle documenting metrics, diagnosis, and the applied patch/delta; and block promotion unless the updated version satisfies the test protocol.

In some embodiments, transfer of a skill package uses a pointer token conveyed by a short-range or machine readable medium, including at least one of: a QR code, an NFC payload, a barcode, a printed token, or a tag associated with a physical object, tool, or location. The pointer token may encode or reference one or more of: a content addressed package reference, a package hash, a trace schema identifier, a risk tier, an expiration field, and a retrieval policy.

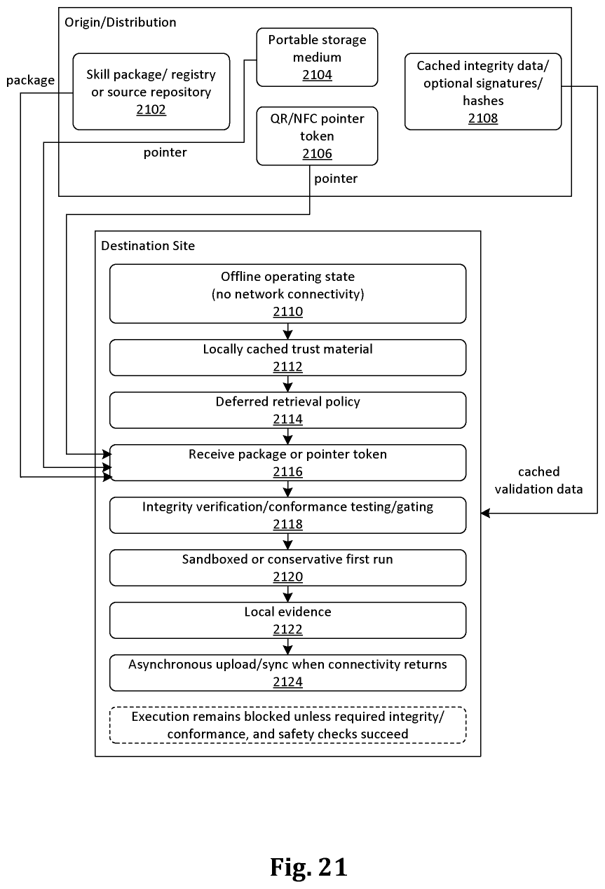

Workflow narrative: A source endpoint generates a skill package and a pointer token bound to the skill package by at least one integrity identifier. As illustrated in FIG. 21, the origin/distribution side may expose skill-package or source-repository element 2102, portable storage medium 2104, QR/NFC pointer token 2106, and cached integrity data 2108, while the destination side may include offline operating state 2110, locally cached trust material 2112, deferred retrieval policy 2114, receive-package-or-pointer stage 2116, and integrity-verification/conformance/gating stage 2118. A destination endpoint scans or reads the pointer token, resolves or retrieves the referenced package when connectivity is available, performs conformance and validation-gate checks, and executes only if required checks pass. In some embodiments, when connectivity is unavailable, the destination endpoint stores the pointer token for deferred retrieval and blocks execution unless a locally cached and integrity-verified package is available.

Non-limiting embodiments include: (i) a printed QR code associated with an appliance or workstation; (ii) an NFC tag affixed to a tool, fixture, or consumable; (iii) a pointer token distributed in a maintenance bulletin or operations checklist; (iv) a pointer token that resolves to a package and an associated challenge suite; and (v) site policy requiring quarantine or sandboxed execution for first use of pointer-delivered packages.

Validation gate checklist (example): verify pointer-token integrity and authenticity when required; verify referenced package hash and signature; verify package schema and trace schema compatibility; verify conformance checks pass for destination capabilities and environment constraints; enforce deferred-retrieval policy when offline; and block execution if required package, approvals, or safety constraints are unavailable. In FIG. 21, a destination endpoint may proceed from receive-package-or-pointer stage 2116 to integrity-verification/conformance/gating stage 2118 and then, if permitted by site policy, to sandboxed-or-conservative first run 2120, with local evidence log 2122 and asynchronous upload/synchronization stage 2124 occurring after or during destination-side use.

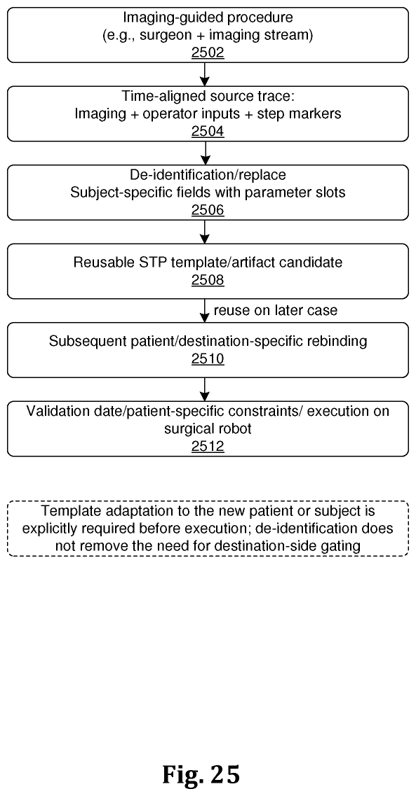

In some embodiments, during an imaging-guided procedure or operation, the system captures time-aligned source-trace data including one or more imaging streams, operator inputs, step markers, and safety-filter events, and converts the captured source-trace data into a reusable STP template and/or artifact candidate. In a non-limiting example, the operator is a surgeon and the captured source-trace data is used to transfer a surgery skill to one or more surgical robots for subsequent gated reuse. Patient-specific, subject-specific, or location-specific identifiers may be removed, transformed, or replaced with parameter slots and constrained ranges to form a de-identified reusable template. For reuse on a subsequent patient, adaptation of the template and/or artifact to patient-specific anatomy, state, and procedural constraints is explicitly required prior to execution. FIG. 25 illustrates a non-limiting example in which imaging-guided procedure 2502 yields time-aligned source trace 2504, which is processed through de-identification stage 2506 to produce reusable STP template/artifact candidate 2508.

Workflow narrative: A first procedure is executed under imaging guidance with monitored step outcomes. The system extracts semantic step transitions, termination criteria, and parameterizable constraints, removes direct identifiers from captured data, and generates a de-identified STP template. For a subsequent case or destination environment, the system rebinds slots using destination-local sensing, executes conformance and validation gates (and optionally simulation gates), and allows execution only when required criteria are satisfied. In the non-limiting example of FIG. 25, reusable STP template/artifact candidate 2508 is applied to subsequent-patient/destination-specific rebinding 2510 before validation-gate/patient-specific-constraints/execution stage 2512.

Non-limiting embodiments include: (i) conversion of imaging-guided teleoperation sessions, including surgeon to-surgical-robot transfer sessions, into reusable templates; (ii) retaining geometric constraints while removing subject identifiers; (iii) generating separate template branches for environment or anatomy classes; (iv) requiring elevated approval for template edits that widen safety envelopes; and (v) storing de-identification audit metadata in an evidence bundle for audit.

Validation gate checklist (example): verify de-identification policy compliance before publication or transfer; verify removal or transformation of direct identifiers; verify extracted termination criteria are explicit and machine checkable; verify destination-side slot rebinding and compatibility checks are completed; verify safety and policy constraints for the destination class; and require simulation and/or human approval for high-risk deployments.

In some embodiments, a skill package is interoperable and portable at authoring time, and is translated at deployment time by a managed-ecosystem translation service into a platform-native task execution policy and associated deployment manifest for a destination robotic device. The translation service may enforce target-runtime constraints, capability constraints, safety-policy constraints, and entitlement constraints without requiring that the source authoring environment and destination runtime use the same internal representation.

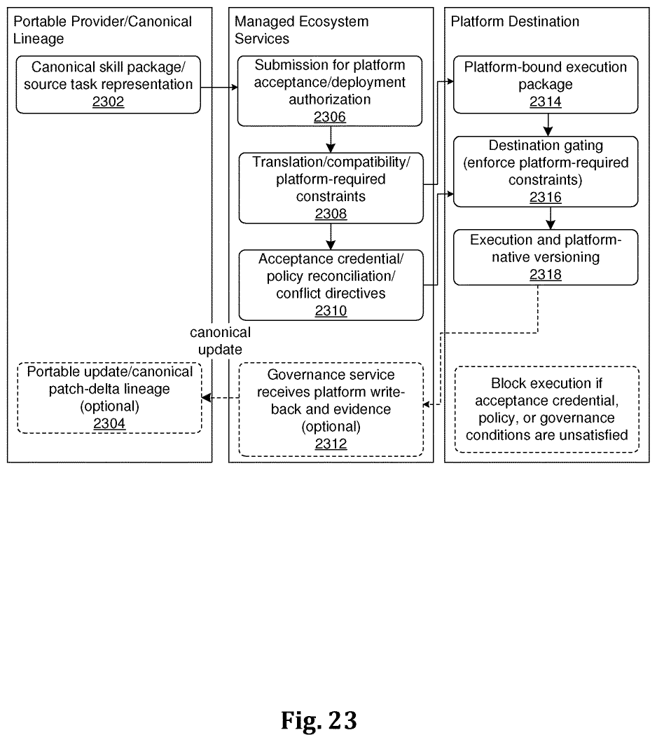

Workflow narrative: A source endpoint publishes a portable skill package and identifies destination constraints. A translation service associated with a managed ecosystem receives the portable representation and destination constraints, produces a platform-native task execution policy and deployment manifest, and returns translation metadata (e.g., translator identifier and version). Prior to execution, the destination endpoint verifies required trust artifacts (e.g., platform signatures, runtime attestation tokens, and entitlement policies), requests a compatibility evaluation based on the destination capability profile and task requirements, receives required safety constraints, injects or binds those constraints into the adapted version, performs gating operations, and executes only if required criteria pass. After execution, the destination endpoint may, in some embodiments, submit execution evidence and lifecycle metadata to a governance service that can issue a disposition (promotion, demotion, quarantine, and/or rollback) that is enforced before subsequent execution; in other embodiments, the ecosystem omits such a governance service write-back path or defers it to a later platform evolution stage. FIG. 23 illustrates a non-limiting example in which canonical skill package/source task representation 2302 is submitted through platform-acceptance submission 2306, translated through translation/compatibility/platform-required constraints stage 2308, and reconciled through acceptance credential/policy reconciliation/conflict-directives stage 2310 before yielding platform-bound execution package 2314 and destination gating 2316. In the example of FIG. 23, execution/platform-native versioning 2318 proceeds on the platform destination side, while optional governance-service write-back stage 2312 and optional portable update/canonical patch-delta lineage 2304 are shown as dashed optional blocks.

Non-limiting embodiments include: (i) cloud-managed robotic fleets where translation and governance services are operated by a platform provider; (ii) enterprise-private managed ecosystems with on-premises translation and attestation services; (iii) mixed-vendor deployments where portable representations are translated into multiple platform-native policy formats; (iv) entitlement policies bound to facility, robot identity, operator role, or jurisdiction; and (v) governance services that require additional approvals before lifting quarantine or reversing demotion. In some embodiments, one or both of (a) governance-service evidence/write-back handling and (b) portable-provider canonical update propagation are optional and may be absent from an initial managed-ecosystem deployment.

Validation gate checklist (example): verify translation metadata consistency (translator identity, version, and policy-format identifier); verify cryptographic signature and integrity of platform-native policy and deployment manifest; verify runtime attestation indicates authorized and non-compromised software/hardware state for the requested task or risk tier; verify entitlement policy authorizes requested task and environment class; verify compatibility-service-required safety constraints are injected into the adapted version before gate evaluation; verify required local self-test, fault, maintenance, and calibration conditions are satisfied; and block execution and/or force quarantine if any required verification or governance disposition check fails.

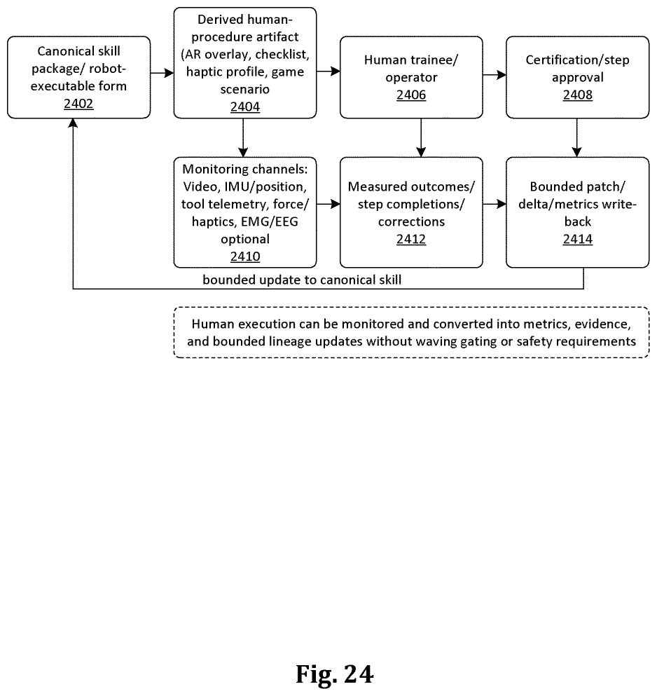

Further, in accordance with FIG. 24, the robot-to-human training, monitoring, and write-back including a canonical skill package/robot-executable form 2402, a derived human-procedure artifact 2404, a human trainee or operator 2406, certification or step approval 2408, monitoring channels 2410, measured outcomes/step completions/corrections 2412, and bounded patch/delta/metrics write-back 2414, in accordance with some embodiments.

In some embodiments, the system operates with dual control planes: (i) a portable skills-provider plane that maintains a canonical task representation independent of any single platform format, and (ii) a platform-governance plane that issues platform-bound execution packages and rights controls for a managed ecosystem. The system stores at least one canonical representation hash and at least one platform-bound package hash and maintains one or more mapping records between them, thereby enabling portable lineage continuity and platform-specific governance.

Workflow narrative: A skills provider submits a canonical task-representation record, destination constraints, and an execution-rights request to a platform binding service. The platform binding service returns a platform-bound execution package and an execution-rights token. Prior to execution, the destination endpoint verifies token state (e.g., not expired, not revoked, in-scope for destination identity, usage budget remaining) and verifies a binding receipt linking canonical and platform-bound hashes. The endpoint executes only when required verification checks pass.

In some embodiments, policy reconciliation is performed between a source policy associated with the portable skill package and a platform policy associated with a destination tenant. The system may output an effective execution policy and one or more conflict directives. Non-limiting conflict directives include: sandbox-only execution, mandatory human approval, limited-privilege execution, and denial. In some embodiments, unresolved policy conflicts cause execution to be blocked or constrained until a required fallback action is satisfied.

In some embodiments, post-execution governance includes dual-lineage write-back. A portable update (e.g., canonical patch/delta, parameter update, or metadata update) is maintained in the portable provider lineage, and a platform-governance update is maintained in the platform-native lineage. A mapping between canonical lineage identifiers and platform-native version identifiers is maintained so that governance dispositions (promotion, demotion, quarantine, rollback) can be enforced in-platform while preserving cross-platform portability and provider-side continuity. In other embodiments, a platform may retain only the platform-native lineage, may omit provider-side canonical update propagation, and/or may defer dual-lineage mapping until a later ecosystem version. As illustrated in FIG. 23, optional portable update/canonical patch-delta lineage 2304 and optional governance-service write-back stage 2312 may be present in some ecosystems and absent in others, while destination gating 2316 and block-execution note 1820 still enforce platform-required acceptance, credential, policy, and governance conditions before execution.

Validation gate checklist (example): verify the canonical hash and platform-bound hash mapping in the binding receipt; verify execution-rights token state (scope, expiration, revocation, and optional usage budget); verify policy reconciliation result and enforce required conflict directives; verify fallback actions were completed when conflicts were unresolved; verify governance disposition has been applied before subsequent execution; and verify dual-lineage mapping remains internally consistent after write-back.

In some embodiments, the same governed skill-transfer architecture is used when the source material is not a direct robot demonstration but rather one or more tutorial or documentation assets, egocentric or body-worn first person capture assets, live telepresence sessions, robot-to-robot streamed execution sessions, and/or a plurality of micro-demonstrations contributed by different contributors. The system may convert one or more such inputs into a bounded event log, STP template, skill package, or candidate patch/delta, and may treat contributor or session metadata as trust inputs that can increase required gates without waiving integrity, conformance, or safety checks. In some embodiments, one or more auxiliary validation assets are associated with a candidate skill package, including a physical or virtual skill kit, a ghost-preview policy or predicted-execution-trace policy, a challenge-suite identifier, a shadow-mode audition policy, and/or an approval policy that defines when a candidate may remain quarantined, become eligible for limited execution, or be promoted.

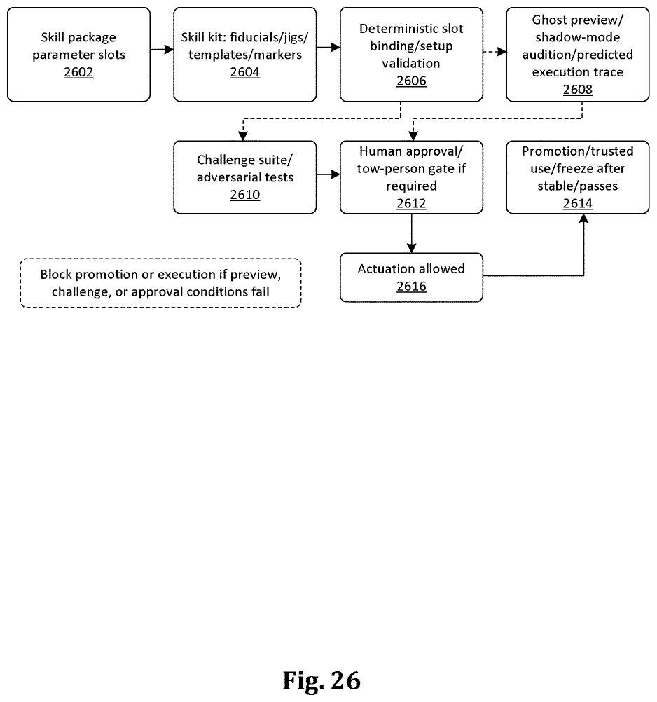

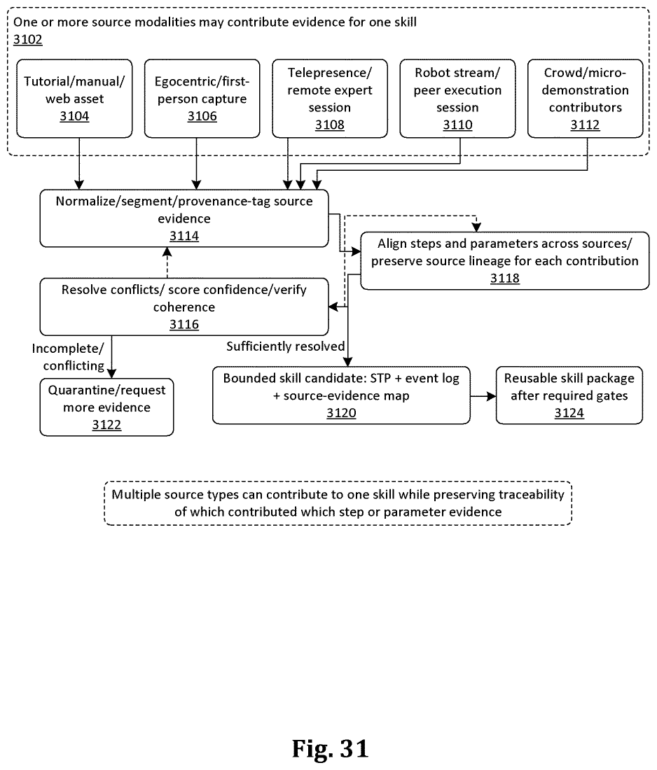

Workflow narrative: One or more source assets are collected from at least one of a tutorial/manual/checklist/web page, an egocentric or first-person video capture session, a live telepresence or remote expert session, a streamed robot-to-robot execution session, or a set of crowd-sourced micro-demonstrations. The system segments the assets into step candidates, extracts or receives step markers and termination criteria, generates an event log and STP template, and optionally merges multiple partial demonstrations into a canonical candidate representation. In the non-limiting example of FIG. 31, source-modality group 3102 may include tutorial/manual/web asset 3104, egocentric/first-person capture 3106, telepresence/remote-expert session 3108, robot-stream/peer-execution session 3110, and crowd/micro-demonstration contributors 3112. Those heterogeneous source evidences may be normalized and provenance-tagged at stage 3114, aligned into a cross-source step/parameter representation at stage 3118, and iteratively resolved for conflicts/coherence/confidence at stage 3116. When sufficiently resolved, the result may become bounded skill candidate 3120 and later reusable skill package 3124 after required gates; otherwise the candidate may be routed to quarantine/request-more-evidence stage 3122. In some embodiments, the system next binds or validates one or more skill-kit assets (e.g., fiducials, fixtures, jigs, tags, tools, templates, or markers), generates a ghost preview or predicted execution trace for at least one candidate binding, and evaluates the candidate against a challenge suite comprising one or more nominal, edge-case, or adversarial scenarios. Prior to promotion or physical execution, the system may quarantine candidate packages, require moderation or review of contributor inputs, and require simulation, challenge-suite passage, shadow-mode audition, and/or human approval when provenance is incomplete, crowd-sourced, skill-kit-dependent, or otherwise policy-designated as high risk. In the non-limiting example of FIG. 26, skill package/parameter slots 2602 feed skill kit 2604 and deterministic slot binding/setup validation 2606. Stage 2606 may branch to ghost preview/shadow-mode/predicted execution trace 2608 and challenge suite/adversarial tests 2610, and one or both branches may inform human approval/two-person gate 2612 before actuation allowed stage 2616. Promotion/trusted use/freeze stage 2614 remains blocked according to note 2618 unless preview, challenge, and approval conditions satisfy the applicable policy.

Non-limiting embodiments include: (i) tutorial/manual/checklist or web-page ingestion into a candidate STP; (ii) first-person or body-worn capture sessions, including guided-video and egocentric capture, converted into step/termination event logs; (iii) telepresence sessions stored with session authorization, operator identity class, and/or network-quality metadata as provenance inputs; (iv) streamed robot-to-robot execution sessions converted into bounded replay/event logs rather than trusted as raw commands; (v) crowd-sourced or micro-demonstration merges gated by moderation flags, contributor history, or challenge-suite results; (vi) physical skill kits comprising one or more fiducials, fixtures, jigs, tags, tools, or appliance-attached markers used to reduce binding ambiguity or to establish deterministic setup conditions at a destination; (vii) ghost-preview generation that simulates or predicts an execution trace for at least one candidate binding before live actuation; (viii) challenge suites comprising nominal, perturbed, occluded, adversarial, and/or recovery scenarios identified by stable scenario identifiers and associated expected outcomes; and (ix) promotion policies that require one or more of shadow-mode passage, challenge-suite passage, human approval, or repeated stable passes before a package is eligible for trusted use, wider distribution, or freeze-state consideration.

In some embodiments, a skill package, event log, or derived human-procedure artifact is used for robot-to human or human-to-human skill transfer, including monitored instruction replays, augmented-reality overlays, step prompts, haptic or kinesthetic guidance profiles, simulation-based or game-engine-based training scenarios, mental rehearsal candidate-evaluation sessions in which low-bandwidth intent inputs select or score simulated candidates prior to physical execution, and/or human certification workflows. Human performance may be verified using one or more feedback channels including video, inertial or positional measurements, tool telemetry, haptic or force measurements, wearable sensors, and/or physiological or neural measurements, and human-generated corrections may be converted into bounded patches/deltas or lineage updates associated with a canonical robotic skill representation. FIG. 24 illustrates a non-limiting example in which canonical skill package or robot-executable form 2402 is converted into derived human-procedure artifact 2404 for human trainee or operator 2406, certification or step approval 2408 and monitoring channels 2410 produce measured outcomes/step completions/corrections 2412, and bounded patch/delta/metrics write-back 2414 returns constrained updates to the canonical lineage without waiving gating, safety, or approval constraints.

In some embodiments, low-supervision or regulated domains may impose additional workflow constraints. Non-limiting embodiments include: (i) sterile preloading of a skill package prior to in vivo deployment; (ii) patient class, anatomy-class, species-class, environment-class, planetary-class, or mission-class branching of templates and promotion tracks; (iii) swarm or micro-to-micro dissemination of a skill update under constrained communication channels with local quarantine and later convergence/freeze analysis; (iv) safe-mode termination dispositions including retrieval, exfiltration, deactivation, biodegradation, or other domain-appropriate exit actions when localization, physiology, timing, or policy conditions are violated; (v) capture and export of an onboard, embedded, or in situ pilot log as a skill record for later autonomous reuse by a same-class or related device; and (vi) asynchronous approval or certification workflows for delay-tolerant domains such as space, planetary-surface, deep-ocean, or remote industrial environments.

Validation gate checklist (example): verify source-channel provenance is sufficient for the requested risk tier; verify tutorial-, telepresence-, streaming-, or crowd-derived traces include explicit step ordering and machine checkable termination criteria; verify merged or crowd-sourced candidates remain quarantined until required moderation, challenge suites, shadow-mode audition, and/or approval conditions are satisfied; verify any skill-kit fiducials, fixtures, or tags are present and aligned before relying on them for binding; verify any ghost preview or predicted execution trace remains within required uncertainty, clearance, collision, or policy bounds before first live actuation; verify any challenge suite identifies the applicable scenario set, pass/fail criteria, evidence fields, and required nominal/adversarial coverage for the requested risk tier; verify challenge-suite outcomes are stored with stable scenario identifiers and associated measured outcomes or failure codes before promotion or demotion; verify human training or human-certification artifacts include explicit success criteria, measurable metrics, and at least one feasible monitoring channel; and verify low-supervision or regulated-domain packages include explicit abort or exit policies and class-specific constraints before execution or promotion.

In some embodiments, the present disclosure provides systems, methods, and non-transitory computer-readable media for governed transfer of robotic skills. One or more processors obtain, from at least one skill source, an input representing a multi-step task, generate a skill package comprising an executable or interpretable task representation and associated metadata, and provide the skill package for use by at least one destination robotic device. At the destination, the skill package is adapted using destination-local data, one or more gating operations are performed according to a gating policy, and execution is blocked unless one or more gating criteria are satisfied. After gate passage, an adapted version is executed by controlling at least one actuation subsystem. Embodiments further support conformance testing, tutorial/media-derived skill acquisition, patch/delta refinement, promotion/demotion and rollback, offline transfer, cooperative multi-robot execution with role-aware coordination, managed-ecosystem translation/compatibility/governance controls, robot-to-human instruction or training artifacts, and dual-lineage mapping between portable and platform-native versions.

In some embodiments, the present disclosure provides a technical framework in which information associated with a task is converted into a machine-usable skill representation that preserves both executable content and supporting metadata. The skill representation can then be delivered to one or more robotic systems for local adaptation and execution. In some embodiments, the local robotic system does not merely consume the representation in unchanged form, but instead evaluates local observations, local hardware characteristics, and local execution constraints before producing device-specific command outputs. In some embodiments, execution is conditioned on one or more gating or validation stages, thereby preventing use of an incompatible or under-validated skill artifact.

In some embodiments, the present disclosure further provides a lifecycle-management framework for robot-executable artifacts, including structured event recording, controlled update publication, compatibility verification, regression testing, rollback, version scoring, and selective promotion of trusted revisions. In some embodiments, the same framework supports both single-robot and cooperative multi-robot operation.

In some embodiments, a technical problem addressed by the present disclosure includes how to generate a transferable machine-usable skill representation for a robotic task and then adapt that skill representation for execution by one or more destination robotic assistance devices having locally varying sensor inputs, hardware capabilities, environmental conditions, and safety constraints. Another technical problem addressed by the present disclosure includes how to prevent incompatible or unsafe transferred control logic from being executed on robotic hardware before validation, conformance checking, and satisfaction of execution requirements have occurred.

A further technical problem addressed by the present disclosure includes how to represent a robotic task in a form that is both reusable and executable, while preserving sufficient structure for parameter binding, validation, rollback, debugging, and iterative improvement. Another technical problem addressed by the present disclosure includes how to coordinate cooperative execution of subtasks across multiple robotic assistance devices while maintaining synchronization and safety under communication loss, desynchronization, or destination-specific capability limitations.

In some embodiments, one or more processors obtain one or more inputs associated with a task from one or more sources and analyze the one or more inputs to generate skill data associated with a skill. In some embodiments, the skill data comprises one or more control logic data associated with one or more control logics for performing the task. A communication interface transmits the skill data to one or more robotic assistance devices. At a destination robotic assistance device, a processing device obtains one or more sensor inputs from one or more sensors coupled to a body of the robotic assistance device, obtains the one or more control logic data, adapts the one or more control logic data based on the one or more sensor inputs, and generates task command data associated with the task. One or more actuators then actuate one or more mechanical appendages based on the task command data to perform one or more task operations associated with the task.

In some embodiments, the one or more processors generate the skill data in a form that preserves both executable content and machine-usable metadata for downstream adaptation and control. For example, the skill data can include or reference one or more of: a structured task plan, one or more task-specific control logic artifacts, one or more parameter slots, one or more parameter ranges, one or more safety criteria, one or more completion criteria, one or more environment descriptors, one or more capability requirements, one or more version identifiers, one or more event logs, one or more build manifests, one or more validation results, one or more update states, or combinations thereof.

In some embodiments, the processing device of a robotic assistance device uses locally detected information to modify the transferred control logic before physical actuation occurs. In some embodiments, the processing device further evaluates one or more requirements associated with execution of the task, including one or more gating criteria, prior to actuating one or more mechanical appendages. In some embodiments, actuation is blocked until the processing device determines that the one or more requirements have been satisfied.

In some embodiments, the disclosed system improves operation of robotic assistance devices by causing control logic to be adapted according to locally obtained sensor inputs rather than executing a transferred skill in an unmodified form. Such adaptation can improve compatibility between transferred control logic and the destination environment, destination hardware configuration, or destination local state.

In some embodiments, the disclosed system improves robotic safety and execution reliability by introducing machine-enforced gating, validation, and conformance operations prior to physical actuation. Such operations can include, by way of example, evaluation of parameter completeness, workspace reachability, collision conditions, force limits, torque limits, end-effector compatibility, sensor availability, trajectory safety, and proximity-related risks. By blocking actuation when one or more criteria are not satisfied, the system can reduce unsafe or incompatible execution states.

In some embodiments, the disclosed system improves reproducibility and lifecycle management of robotic skills by storing event logs, schema identifiers, version histories, patches, deltas, build manifests, test protocols, evidence bundles, rollback information, and promotion or demotion states associated with different skill versions. Such structures can improve traceability of changes, support debugging of failure conditions, and support controlled promotion of updated versions for deployment on robotic hardware.

In some embodiments, the disclosed system improves cooperative robotic execution by decomposing a structured task plan into subtasks for multiple robotic assistance devices, defining synchronization points among the subtasks, and applying coordination contracts that govern execution under normal conditions and under fault conditions including communication loss or desynchronization.

In some embodiments, a system according to the present disclosure includes one or more remote or centralized compute resources that generate or refine machine-usable skill representations, together with one or more robotic systems that consume and locally adapt such representations. In some embodiments, the remote or centralized compute resources include one or more servers, edge-compute nodes, embedded controllers, cloud-compute instances, workstation-class systems, or combinations thereof. In some embodiments, a robotic system includes a local control processor, one or more sensors, one or more actuated mechanical structures, one or more communication modules, and one or more data stores.

In some embodiments, the sensing resources associated with a robotic system include one or more of visible-light cameras, depth cameras, stereo cameras, force sensors, torque sensors, tactile sensors, inertial sensors, range sensors, localization sensors, microphones, or environmental sensors. In some embodiments, the mechanical structures include one or more arms, grippers, hands, tool carriers, mobile bases, pan-tilt structures, suction assemblies, or other actuable mechanisms configured to interact with a physical environment.

In some embodiments, local and remote compute resources exchange machine-usable task information over one or more wired or wireless communication paths. In some embodiments, the exchanged data is encoded using a binary serialization format, a structured field-value format, a graph-based format, a hierarchical document format, or a table-backed storage format.

In some embodiments, a skill representation is produced from one or more source inputs associated with a task. The source inputs may originate from demonstration data, teleoperation traces, narrated procedures, authored workflows, virtual or augmented reality sessions, perception streams, simulation sessions, prior task artifacts, or combinations thereof. In some embodiments, source inputs are first normalized into a common intermediate representation that preserves timing, entity references, source provenance, and modality identity.

In some embodiments, normalization is followed by extraction of task-relevant elements such as object identities, state transitions, interaction events, tool selections, spatial references, and temporal boundaries. In some embodiments, these extracted elements are assembled into a structured task representation that is sufficiently detailed to support downstream generation of executable artifacts, parameter binding, validation, and exception handling. In some embodiments, the intermediate representation and the resulting structured representation are separately stored so that later processing stages can reproduce, inspect, or regenerate downstream artifacts.

In some embodiments, a generated skill representation includes or references multiple layers of information. By way of example, a first layer can include a structured task representation; a second layer can include executable or interpretable control logic; a third layer can include environment or capability assumptions; and a fourth layer can include lineage, testing, or version metadata. In some embodiments, these layers are independently versioned so that a change to one layer need not require regeneration of every other layer.

In some embodiments, event information is recorded as a sequence of machine-readable records. Each record may include, for example, an event identifier, event class, source identifier, modality identifier, timestamp, task identifier, version identifier, and a payload area for event-specific data. In some embodiments, the payload area includes one or more values selected from object labels, object states, poses, confidence values, command identifiers, operator annotations, tool identifiers, environment descriptors, step markers, or exception codes.

In some embodiments, the event records conform to a schema identified by an event-log schema identifier. In some embodiments, the schema identifies field names, field types, field ordering, required versus optional fields, timestamp conventions, unit conventions, coordinate-frame conventions, and validation rules. In some embodiments, the schema also identifies modality-specific payload requirements such that different source types can be stored in the same overall event infrastructure without sacrificing parseability. In some embodiments, schema-version information and backward-compatibility rules permit later components to interpret older event records generated under earlier schema definitions.

In some embodiments, event logs are indexed according to time, event type, source, task, version, or modality. In some embodiments, such indexing permits reconstruction of a task timeline, reconstruction of a local execution timeline, identification of a failure interval, or comparison of event sequences across different task versions or different robotic systems.

In some embodiments, a structured task plan includes an ordered or partially ordered set of task elements. In some embodiments, the task plan further includes a dependency graph, a resource map, a set of preconditions, a set of expected result states, a set of fallback actions, and a parameter-binding table. In some embodiments, each task element carries one or more identifiers for required objects, referenced tools, intended actions, expected outcomes, and completion conditions.

In some embodiments, the structured task plan additionally stores information not typically present in a low-level motion script. By way of example, the structured task plan may include candidate sources for a bindable value, one or more allowed value ranges, one or more tolerances, one or more priority rules among alternative bindings, one or more exception categories, and one or more repair options if a precondition is not satisfied. In some embodiments, the task plan also includes one or more environmental assumptions or one or more capability assumptions that can later be compared against locally observed conditions at a destination system.

In some embodiments, the structured task plan is not directly executed. Instead, the plan serves as an intermediate technical object from which one or more executable modules, behavior-tree fragments, state-machine descriptions, script blocks, or command templates are generated. In some embodiments, one representation is retained for interpretability and auditing while another representation is retained for device-specific execution.

In some embodiments, a recorded or streamed media asset is analyzed to derive a task representation. In some embodiments, analysis of the media asset includes identifying time segments corresponding to task phases, identifying operator actions, identifying object transitions, detecting gestures, identifying narration boundaries, or recognizing step markers. In some embodiments, detected events are aligned on a common time base so that multiple modalities extracted from the same media asset can be related to one another.

In some embodiments, one or more derived traces are converted into a task representation that captures step ordering, dependencies, and completion conditions. In some embodiments, ambiguities detected during media analysis are preserved as unresolved bindings or candidate interpretations rather than being immediately collapsed into a single inferred value. This can be useful where later clarification, local observation, or destination-specific constraints provide a better basis for selecting among candidate interpretations.

In some embodiments, a bindable value in a task representation is associated with multiple candidate sources. By way of example, a bindable value may be inferable from a media-derived trace, from a sensed object pose, from a user-provided value, from a prior execution record, or from a default template. In some embodiments, a confidence value is computed for each candidate source or for a selected binding. In some embodiments, the confidence value is based on source reliability, agreement across modalities, geometric consistency, constraint satisfaction, or uncertainty estimates.

In some embodiments, when a current binding is insufficiently reliable, the system generates a targeted clarification request rather than proceeding with an uncertain interpretation. In some embodiments, the clarification request is specific to an unresolved slot and includes one or more candidate values, one or more context cues, or one or more expected unit or type constraints. In some embodiments, a received clarification is stored as provenance-bearing binding data, and an updated executable artifact is generated using the revised value. In some embodiments, the updated artifact is flagged for partial or full revalidation before deployment.

In some embodiments, a robot-executable artifact is not applied directly upon receipt. Instead, one or more validation stages are executed prior to physical actuation. In some embodiments, the validation stages are arranged in an ordered pipeline so that low-cost incompatibility checks can be performed before more resource-intensive planning or simulation operations. In some embodiments, early stages include integrity verification, version compatibility checks, and runtime-component checks. In some embodiments, later stages include geometric feasibility analysis, collision analysis, actuator-envelope analysis, and local safety-envelope analysis.

In some embodiments, each validation stage produces a structured result indicating a stage identifier, one or more measured values, a pass/fail state, one or more confidence values, and optionally one or more remediation suggestions. In some embodiments, the structured results are stored so that later analysis can determine which stage prevented execution or which stage frequently fails across repeated deployments.

In some embodiments, a failed validation stage may trigger a repairable-remediation workflow. By way of example, an unavailable sensing resource can trigger substitution with a fallback sensing configuration; stale calibration data can trigger a calibration update procedure; an infeasible path can trigger local regeneration of a path segment using revised geometric bounds; and a missing parameter value can trigger a parameter-resolution workflow. In some embodiments, a policy associated with the artifact determines which failures are repairable, how many retries are permitted, and which stages must be repeated after remediation.

In some embodiments, an environment fingerprint is generated from normalized descriptors associated with a local environment. In some embodiments, the descriptors include one or more of workspace dimensions, obstacle descriptors, fixture identifiers, tool identifiers, object categories, object poses, surface characteristics, lighting conditions, floor or support characteristics, or localized hazard descriptors. In some embodiments, the descriptors are transformed into a common coordinate frame and a common unit system prior to fingerprint generation.

In some embodiments, fingerprint generation includes sorting or grouping normalized descriptor values according to descriptor type, applying quantization rules to reduce sensitivity to insignificant sensor noise, and computing a hash or other compressed identifier over the normalized descriptor set. In some embodiments, the compressed identifier is accompanied by auxiliary metadata indicating which descriptor classes are mandatory, which are advisory, and which can vary within tolerance.

In some embodiments, capability matching is performed using a capability signature that identifies one or more expected local resources or execution properties. In some embodiments, the capability signature identifies sensing resources, actuation resources, tool requirements, motion ranges, supported control modes, communication features, software dependencies, or workspace assumptions. In some embodiments, a conformance engine compares locally available capabilities and locally observed environmental characteristics against the capability signature and associated environment metadata to determine whether the destination system is suitable for execution, suitable only under a degraded profile, or unsuitable without further modification.

In some embodiments, robot-executable artifacts are stored under version identifiers with lineage metadata indicating parent-child relationships among successive versions. In some embodiments, an update is represented as a patch, delta, or change set that can be applied to a parent version to produce a child version. In some embodiments, a build manifest is stored in association with the update and identifies one or more of a parent-version identifier, a child-version identifier, one or more hash values, one or more runtime dependencies, a target platform class, one or more policy identifiers, one or more source datasets, or one or more generator-module identifiers.

In some embodiments, rollback information is stored separately from the build manifest or within the same metadata object. In some embodiments, rollback information includes a fallback-version identifier, a rollback eligibility flag, one or more rollback reason codes, one or more parameter-preservation rules, one or more execution-state preservation rules, and one or more compatibility indicators that identify whether local adjustments can survive rollback. In some embodiments, rollback may be invoked automatically when a child version fails validation, fails post-deployment testing, violates a safety threshold, or underperforms relative to one or more measured criteria.

In some embodiments, one or more measured outcomes from task execution are compared to one or more evaluation criteria. In some embodiments, measured outcomes include completion success, execution time, path deviation, collision incidence, force excursion, perception confidence, rework frequency, recovery frequency, or operator intervention frequency. In some embodiments, results from multiple deployments are aggregated so that successive artifact versions can be scored relative to one another.

In some embodiments, a promotion decision is based on one or more thresholds, weighted combinations of measured outcomes, comparison to a trusted baseline, or comparison to a parent version. In some embodiments, a demotion decision is triggered when a previously promoted version shows degraded behavior under a broader or later data set. In some embodiments, convergence of one or more configurable values is determined by tracking change magnitude across successive updates and detecting when further changes fall below a threshold. In some embodiments, converged values are placed into a restricted-update state requiring additional approval or additional validation before further modification.

In some embodiments, a candidate artifact is tested using a simulation regression suite before trusted deployment. In some embodiments, the simulation regression suite includes both deterministic scenarios and stochastic scenarios. In some embodiments, deterministic scenarios are used to reproduce known edge cases or prior failures, while stochastic scenarios are used to evaluate robustness under perturbations of environment geometry, object placement, timing, sensing conditions, or communication conditions.

In some embodiments, a simulation scenario definition includes one or more environment models, one or more object sets, one or more friction or compliance parameters, one or more lighting conditions, one or more latency parameters, one or more sensor-noise models, one or more perturbation ranges, and one or more expected success or failure thresholds. In some embodiments, each simulation run yields a result record including a scenario identifier, seed value, metric set, failure labels, and one or more links to traces or replay materials.

In some embodiments, validation output is stored as an evidence bundle. In some embodiments, the evidence bundle includes reproducibility metadata such as simulator identifiers, simulator versions, environment-model identifiers, physics-profile identifiers, seed values, or run identifiers. In some embodiments, the evidence bundle further includes one or more reduced scenarios and one or more trace segments selected to reproduce or isolate an observed failure. In some embodiments, the evidence bundle is used to support promotion, demotion, rollback, regression comparison, or debugging.

In some embodiments, a shared task is partitioned into multiple sub-activities for execution by multiple robotic systems. In some embodiments, partitioning considers local capability data, local state data, current tool assignments, current workspace occupancy, or current availability. In some embodiments, a cooperative execution plan includes one or more synchronization points, one or more handoff conditions, one or more waiting conditions, one or more timeout conditions, and one or more fallback actions.

In some embodiments, a coordination contract specifies what information is exchanged among participants at each synchronization point. By way of example, the exchanged information can include a current step identifier, one or more completion indicators, one or more summarized pose values, one or more hazard indicators, one or more tool-state indicators, or one or more readiness values. In some embodiments, the coordination contract also specifies a degraded-operation profile for cases in which one participant becomes unavailable, communication is lost, or a synchronization deadline expires.

In some embodiments, a cooperative task may continue under a reduced mode, may be converted to a single-robot partial-completion mode, may retreat to safe poses, or may enter a safe shutdown sequence depending on the contract and current execution state.

In some embodiments, a local robotic system uses information from multiple cameras to refine endpoint-related parameters. In some embodiments, camera-related data includes intrinsic parameters, extrinsic parameters, reference-frame transforms, distortion parameters, and calibration-version information. In some embodiments, calibration information is produced using a calibration target, a hand-eye calibration routine, a scene-based calibration process, or a combination thereof.

In some embodiments, image-space measurements from multiple viewpoints are combined to compute an updated physical location, orientation, or trajectory-related quantity. In some embodiments, the computation uses triangulation, a perspective-n-point routine, stereo correspondence, bundle adjustment, weighted least squares, or another estimator. In some embodiments, different observations are weighted according to reprojection error, visibility, occlusion level, image sharpness, illumination quality, or consistency with kinematic constraints.

In some embodiments, an observation is rejected when one or more quality measures exceed a threshold or when the observation conflicts with one or more robot-state constraints. In some embodiments, computed values are filtered over time using a Kalman filter, particle filter, smoother, or median-based filter before being stored for later use. In some embodiments, recalibration is triggered by a detected mechanical shock, drift in one or more camera-position values, repeated reprojection-error increases, or a detected mounting change. In some embodiments, artifacts dependent on superseded calibration data are flagged for selective revalidation.

In some embodiments, different data structures are stored using different serialization strategies selected according to access frequency, update frequency, or validation requirements. In some embodiments, event logs use append-oriented storage, structured task plans use graph-oriented or hierarchical storage, and version metadata uses table-backed indexed storage. In some embodiments, hashes, signatures, schema-version identifiers, and compatibility descriptors are stored together so that a receiving component can verify integrity, determine interpretation rules, and reject stale or incompatible data before use in downstream robotic processing.

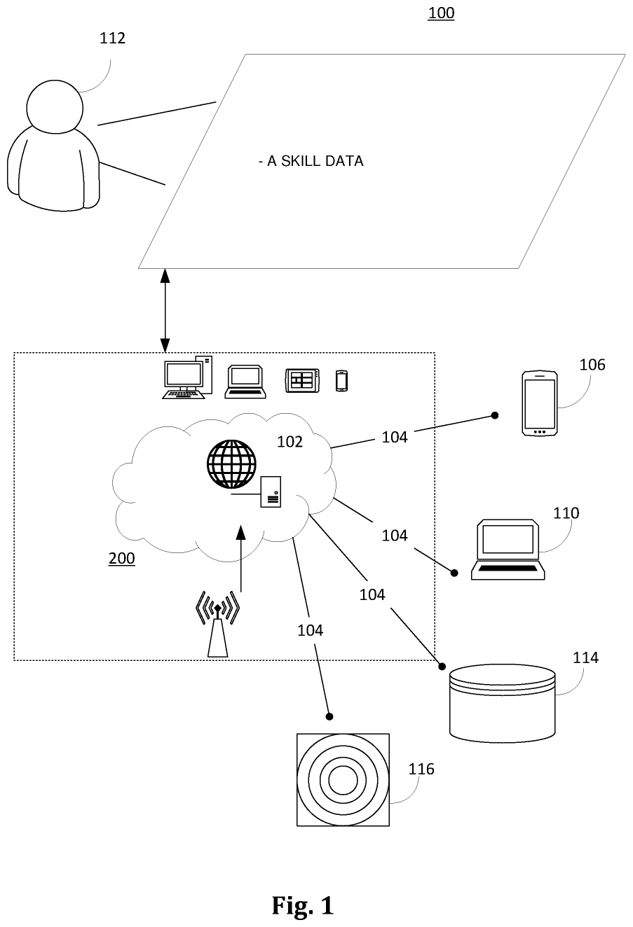

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not limited to, a website, a web application, a desktop application, and a mobile application compatible with a computing device 200.

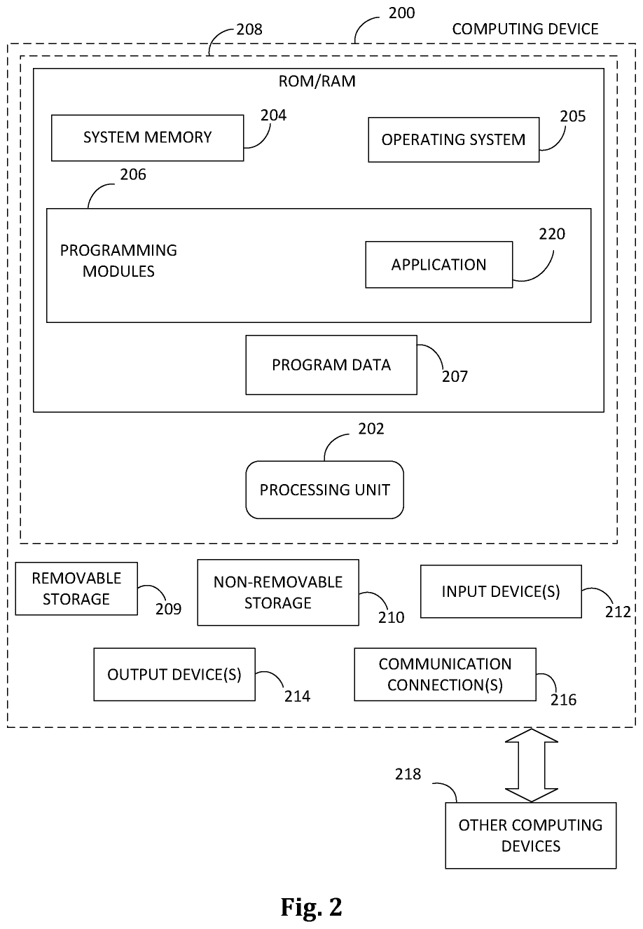

With reference to FIG. 2, a system consistent with an embodiment of the disclosure may include a computing device or a cloud service, such as a computing device 200. In a basic configuration, the computing device 200 may include at least one processing unit 202 and a system memory 204. Further, the at least one processing unit 202 may include a processor. Moreover, the processor may be and/or may include general-purpose processors, specialized processors, machine learning accelerators, multi-core processors, vector processors, digital signal processors, tensor accelerators, neural accelerators, graphics engines, or various kinds of specialized integrated circuits including FPGAs, ASICs, ASSPs, SoCs, and CPLDs. Depending on the configuration and type of the computing device 200, the system memory 204 may comprise, but is not limited to, a volatile memory (e.g., random-access memory (RAM)), non-volatile memory (e.g., read-only memory (ROM)), a flash memory, or any combination. System memory 204 may include an operating system 205, one or more programming modules 206, and a program data 207. Operating system 205, for example, may be suitable for controlling computing device 200's operation. In one embodiment, the one or more programming modules 206 may include image-processing modules, machine learning modules, etc. Furthermore, embodiments of the disclosure may be practiced in conjunction with a graphics library, other operating systems, or any other application program, and are not limited to any particular application or system. This basic configuration is illustrated in FIG. 2 by those components within a dashed line 208.

Computing device 200 may have additional features or functionality. For example, the computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of the computing device 200. Computing device 200 may also have input device(s) 212, such as a keyboard, a mouse, a pen, a sound input device, a touch input device, a location sensor, a camera, a biometric sensor, etc. Output device(s) 214, such as a display, speakers, a printer, etc., may also be included. Further, the input device(s) 212 and the output device(s) 214 may suitable for multimodal interaction with a user. The aforementioned devices are examples, and others may be used.

Computing device 200 may also contain a communication connection 216 that may allow device 200 to communicate with other computing devices 218, such as over a network in a distributed computing environment, for example, an intranet or the Internet. Further, the communication connection may be and/or may include a communication interface, a network interface, etc. Communication connection 216 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein, may include both storage media and communication media.

As stated above, a number of program modules and data files may be stored in the system memory 204, including the operating system 205. While executing on the at least one processing unit 202, the one or more programming modules 206 (e.g., application 220 such as a media player) may perform processes including, for example, one or more stages of methods, algorithms, systems, applications, servers, and databases as described above. The aforementioned process is an example, and the at least one processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computing device and/or computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations, such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage medium readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Further, the computer-readable medium may be and/or may include one or more non-transitory computer readable media. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently, or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

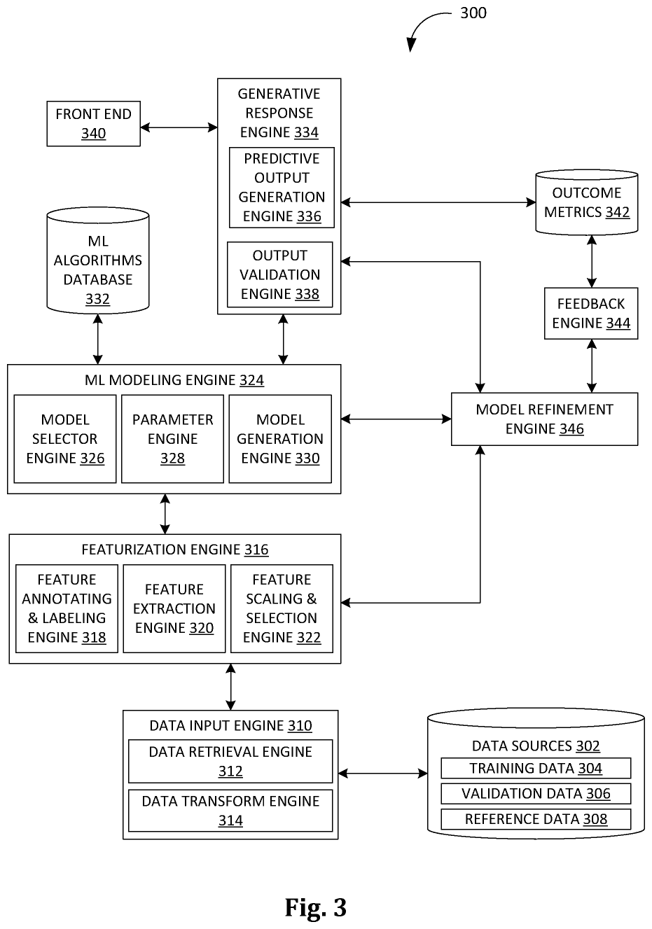

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For, example some components that are illustrated as separate, may be combined with other components and some components may be divided into separate components.

Accordingly, the machine-learning system 300 may include a plurality of interrelated modules and engines configured to implement a machine-learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the data input engine 310 may be implemented on a computing device.

Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the featurization engine 316 may be implemented on the computing device.

Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyper parameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the ML modeling engine 324 may be implemented on the computing device.

Further, the machine-learning system 300 may include a generative response engine 334 configured to produce user-facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the generative response engine 334 may be implemented on the computing device.

Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and the feedback engine 344 provide closed-loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine-learning system 300. Further, the feedback engine 344 may be implemented on the computing device.

Any or each engine of the machine-learning system 300 may be and/or may include a module (e.g., a program module), which may be a hardware unit configured to be used with other components or a part of a program that performs a particular function. Further, any or each engine of the machine-learning system 300 may be implemented using a computing device.

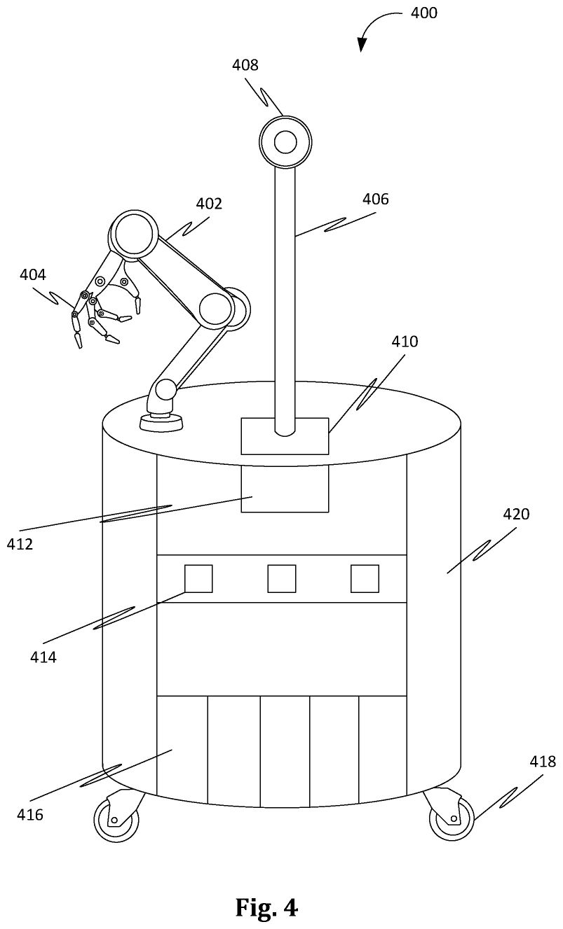

FIG. 4 illustrates a front view of a robotic assistance device 400, in accordance with some embodiments. Accordingly, the robotic assistance device 400 may include a sensor device which may be configured for detecting an environmental parameter associated with an environment. Further, the environment may be associated with the robotic assistance device. Further, the robotic assistance device 400 may include a processing device 414 which may be configured for generating a task command data representing the manipulation task based on the detecting of the environmental parameter. Further, the processing device 414 may be operatively coupled to the sensor device. Further, the robotic assistance device 400 may include a mechanical appendage 402 which may be configured for performing of the manipulation task based on the task command data. Further, the mechanical appendage 402 may be communicatively coupled to the processing device 414. Further, the robotic assistance device 400 may include an actuator device which may be configured for facilitating an actuation of the mechanical appendage 402. Further, the performing of the manipulation task may be further based on the actuation. Further, the actuator device may be operatively coupled to the mechanical appendage 402. Further, the robotic assistance device 400 may include a housing unit 420 which may be configured to support the robotic assistance device 400 on a surface associated with the environment. Further, the housing unit 420 may be further configured for facilitating housing of each of the sensor device, the processing device 414, the actuator device associated with the robotic assistance device 400. Further, the mechanical appendage 402 may be further configured to be attached on the housing unit 420. Further, the housing unit 420 includes a wheel 418 which may be configured for facilitating a mobility associated with the robotic assistance device 400 in relation to the surface.

In some embodiments, the robotic assistance device 400 may further include a communication device which may be configured for receiving a user command data from a user device associated with the user. Further, the generating of the task command data may be further based on the user command data.

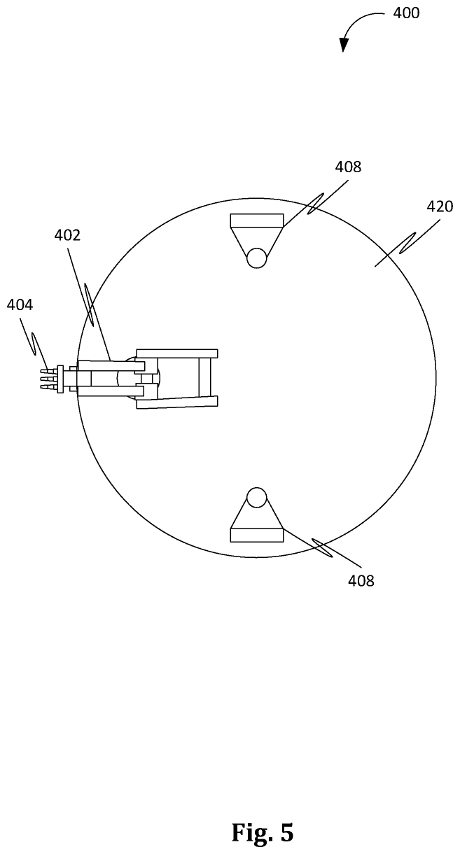

FIG. 5 illustrates a top view of robotic assistance devices, in accordance with some embodiments. In some embodiments, the robotic assistance device 400 may further include a tactile gripper 404 which may be configured for identifying an object parameter in relation an object associated with the manipulation task. Further, the tactile gripper 404 may be further configured to be operatively coupled to the mechanical appendage 404. Further, the performance of the manipulation task may be further based on the identifying of the object parameter.

In some embodiments, the object parameter includes two or more object parameters. Further, the two or more object parameters include one or more of an object weight, an object texture and a grip associated with the object.

In some embodiments, the object includes one or more of a fragile object and an irregular shaped object.

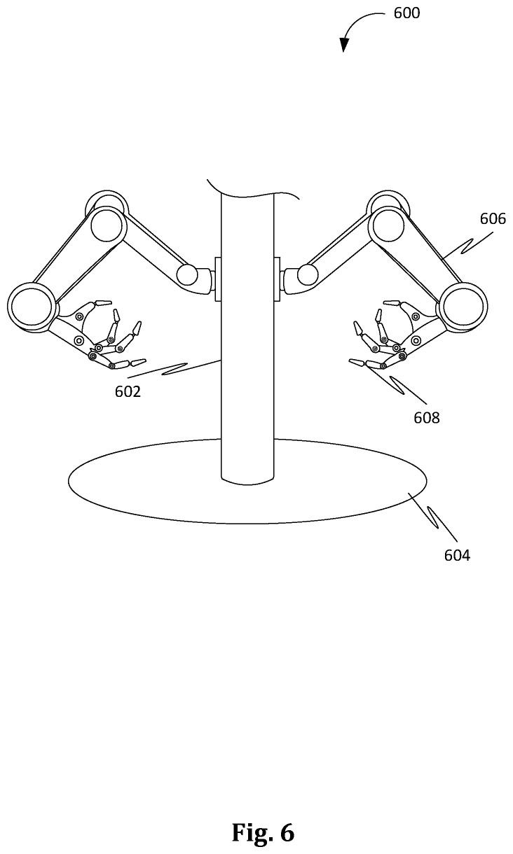

FIG. 6 illustrates a first configuration associated with the attachment of one or more mechanical appendages 606 in a robotic assistance device 600, in accordance with some embodiments. In some embodiments, the manipulation task includes a task operation corresponding to a step in relation to the manipulation task. Further, the task operation includes a sensor elevation operation corresponding to an elevation of the sensor device in relation to the housing unit.

Further, in some embodiments, the robotic assistance device 600 may include a vertical support 602, a housing unit 604, the one or more mechanical appendages 606, and one or more tactile grippers 608.

In some embodiments, the mechanical appendage 402 includes a telescopic vertical appendage 406 which may be configured for facilitating the sensor elevation operation.

In some embodiments, the mechanical appendage 402 includes two or more mechanical appendages. Further, each of the two or more mechanical appendages may be configured for performing of the manipulation task.

In some embodiments, the task operation includes one or more of a lifting operation, a folding operation, a stacking operation and a handling operation associated with the robotic assistance device.

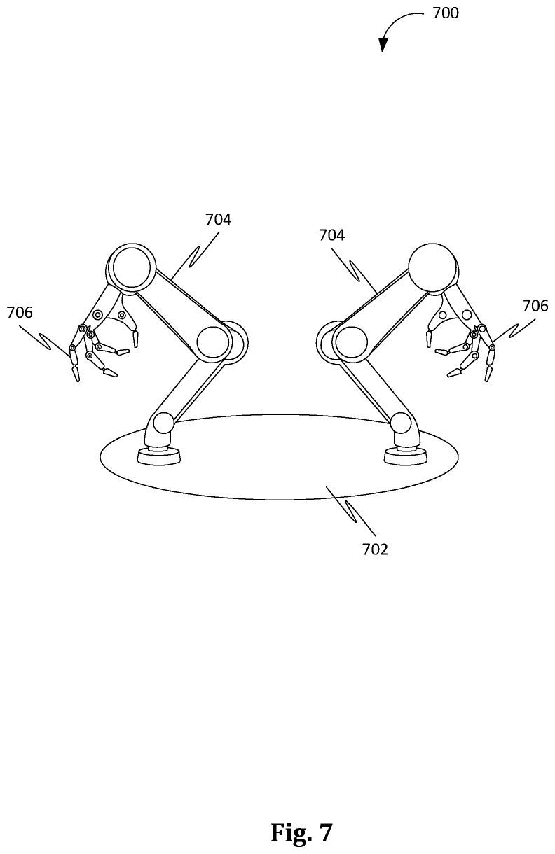

FIG. 7 illustrates a second configuration associated with the attachment of one or more mechanical appendages 704 in a robotic assistance device 700, in accordance with some embodiments. In some embodiments, the mechanical appendage may be associated with a degree-of-freedom corresponding to a quantity in relation to two or more independent movements performed by the one or more mechanical appendages 704.

Further, the robotic assistance device 700 may include a housing unit 702, the one or more mechanical appendages 704, and one or more tactile grippers 706.

In some embodiments, the robotic assistance device may include a camera device 408, a height sensor 410, a charging interface 412, and a battery pack 416.

In some embodiments, the degree-of-freedom includes a six degree-of-freedom.

In some embodiments, the degree-of-freedom associated with each of the two or more mechanical appendages may be configured for facilitating an enhancement of each of a precision and a modularity in relation to the mechanical appendage.

In some embodiments, the task operation includes a bimanual operation. Further, the two or more mechanical appendages may be further configured for facilitating the bimanual operation.

In some embodiments, the tactile gripper includes two or more tactile grippers. Further, the two or more tactile grippers include one or more of a first tactile gripper and a second tactile gripper. Further, the first tactile gripper may be designed to facilitate a replacement in relation to the second tactile gripper.

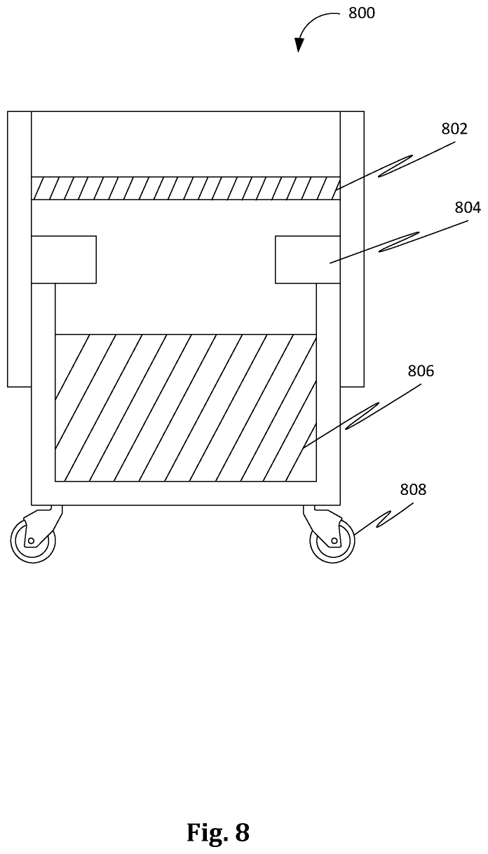

FIG. 8 illustrates a robotic assistance device 800, in accordance with some embodiments. In some embodiments, the robotic assistance device 800 may further include an energy management unit which may be configured for facilitating management one or more of a storage and a distribution of an electrical energy associated with the performance of the manipulation task.

Further, the robotic assistance device 800 may include a processing device 802, a vertical lift system 804, a battery pack 806, and one or more wheels 808.

In some embodiments, the housing of the energy management unit in the housing unit may be configured to facilitate one or more of an anchoring of the robotic assistance device and a lowering of a center-of-gravity associated with the robotic assistance device. Further, the lowering of the center-of-gravity may be configured to mitigate a need for an energy-consuming static balancing device.

In some embodiments, the wheel includes two or more wheels. Further, each of the two or more wheels may be configured for facilitating mobility associated with the robotic assistance device in relation to the surface.

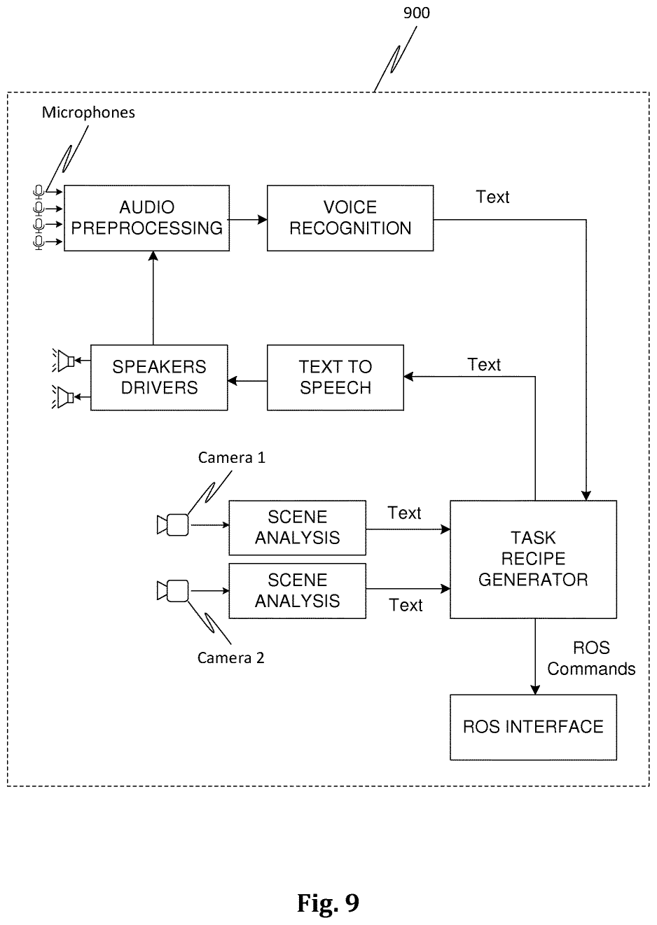

FIG. 9 illustrates a task command generation flow 900 associated with robotic assistance devices, in accordance with some embodiments. In some embodiments, the two or more wheels includes two or more mecanum wheels. Further, each of the two or more mecanum wheels may be configured for facilitating an agile navigation associated with the robotic assistance device in relation to the environment.

In some embodiments, the environment includes a tight indoor environment.

In some embodiments, the mobility includes an omnidirectional mobility.

In some embodiments, the energy management unit includes a rechargeable-battery pack which may be configured for facilitating each of the storage and the distribution of the electrical energy.

In some embodiments, the processing device may be further configured for generating a mobility operation data which may be configured to facilitate the mobility of the robotic assistance device. Further, the generating of the task command data may be further based on the mobility operation data.

In some embodiments, the mobility operation data includes a charging dock headed mobility operation data corresponding to the mobility of the robotic assistance device to a charging dock which may be configured to facilitate charging of the robotic assistance device.

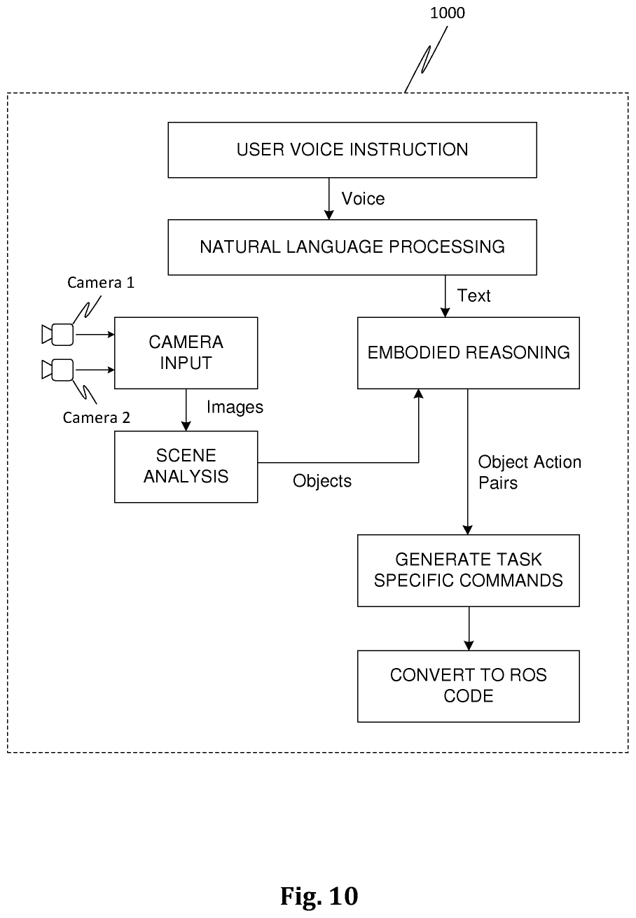

FIG. 10 illustrates a ROS code generation flow 1000 associated with robotic assistance devices, in accordance with some embodiments. In some embodiments, the processing device may be further configured for determining a battery status in relation to the rechargeable-battery pack. Further, the facilitating of the mobility of the robotic assistance device to a charging dock may be further based on the battery status.

In some embodiments, the mobility of the robotic assistance device to a charging dock may be further configured for ensuring one or more of an uninterrupted service and an autonomy associated with the robotic assistance device.

In some embodiments, the sensor device includes a camera device which may be configured for detecting visual content in relation to the environment. Further, the camera device may be further configured to be attached to the housing unit.

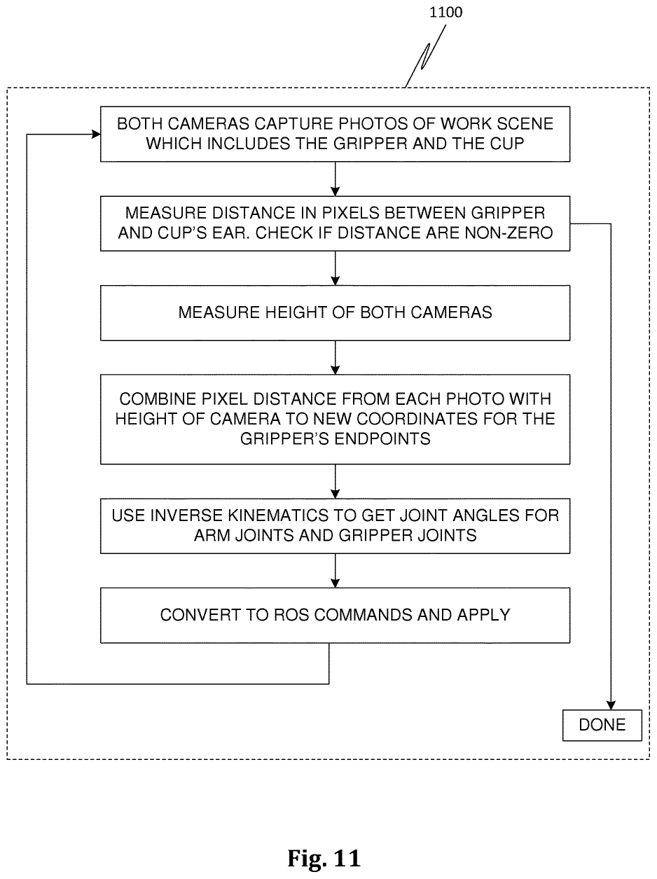

FIG. 11 illustrates a closed-loop grasping feedback flow 1100 associated with robotic assistance devices, in accordance with some embodiments. In some embodiments, the camera device includes a depth-sensing camera device which may be configured for detecting a depth associated with the visual content in relation to the environment.

In some embodiments, the camera device includes two or more camera devices. Further, each of the two or more camera devices may be associated with a camera mounting configuration corresponding to a configuration in relation to the mounting of the camera device on the housing unit.

In some embodiments, the camera mounting configuration includes one or more of a front-facing configuration, a panoramic configuration, and a lateral configuration in relation to the housing unit.

In some embodiments, the sensor device further includes a microphone device which may be configured for detecting an auditory content in relation to each of the user and the environment.

In some embodiments, each of the camera device and the microphone device may be further configured to be attached on the telescopic vertical appendage.

In some embodiments, the processing device may be further configured for generating a 3D environmental mapping data representing a 3D mapping of the environment associated with the robotic assistance device. Further, the generating of the 3D environmental mapping data may be based on the attachment of the camera device on the telescopic vertical appendage.

In some embodiments, the task operation includes a vertical elevation operation corresponding to a vertical elevation of the housing unit.

In some embodiments, the housing unit further includes a telescopic lift which may be configured for facilitating the vertical elevation operation associated with the robotic assistance device.

In some embodiments, the sensor device includes a gesture sensing device which may be configured for detecting a gesture associated with the user. Further, the generating of the task command data may be further based on the detecting of the gesture. Further, the gesture includes one or more of a body gesture and a hand gesture associated with the user.

In some embodiments, the auditory content in relation to the user includes one or more of a voice command and a voice query.

In some embodiments, the processing device may be further configured for generating a device characteristic data representing a characteristic associated with the robotic assistance device.

In some embodiments, the communication device may be further configured for transmitting the device characteristic data to the user device.

In some embodiments, the robotic assistance device may further include a presentation device which may be configured for presenting the device characteristic data. Further, the presentation device may be further configured for facilitating a user interaction in relation to the robotic assistance device.

In some embodiments, the device characteristic data includes one or more of a real-time device feedback data, a diagnostic tool data and a manual override data.

In some embodiments, the processing device may be further configured for generating of an audio output data based on the performing of the manipulation task.

In some embodiments, the audio output data includes one or more of a task confirmation data, a task status update data, a user question clarification data, and a task progress summary data in relation to the manipulation task.

In some embodiments, the environment includes one or more of a household environment and a retail stockroom environment.

In some embodiments, the manipulation task in relation to the household environment includes one or more of a dishwashing task, an organizing task and a kitchen cleanup task associated with the user.

In some embodiments, the generating of the task command data may be further based on an AI module.

In some embodiments, the AI module includes a LLM-based AI module.

In some embodiments, the robotic assistance device includes a domestic service robotic device which may be configured for facilitating a domestic task associated with the household environment.

In some embodiments, the visual content includes a three sixty-degree visual content in relation to the environment.

In some embodiments, the processing device may be further configured for generating a task plan data corresponding to a plan in relation to the performance of the manipulation task. Further, the generating of the task command data may be further based on the task plan data.

In some embodiments, the mechanical appendage may be further configured for mitigating one or more of a mechanical overhead, a volume, a complexity and a maintenance requirement relative to a humanoid-torso based robotic assistance device.

In some embodiments, the attachment of the camera device on the telescopic vertical appendage may be further configured to facilitate an accurate judgement in relation one or more of an object distance and an object shape associated with the object in relation to the environment.

In some embodiments, the environmental parameter includes an obstacle in relation to the mobility associated with the robotic assistance device. Further, the generating of the actuation operation data may be further based on the obstacle.

In some embodiments, the obstacle includes one or more of a person and a pet associated with the user.

In some embodiments, the processing device may be further configured for generating an environment layout data representing a layout of the environment. Further, the generating of the actuation operation data may be further based on the environment layout data.

Further, in some embodiments, the present disclosure provides the robotic assistance device. Further, the processing device may be further configured for generating a task-based training data based on each of the user command data and the detecting of each of the auditory content and the gesture associated with the user. Further, the generating of the task command data may be further based on an ROS framework. Further, the processing device may be further configured for training the AI module based on the task-based training data.

In some embodiments, the processing device may be further configured for generating an object characteristic data corresponding to an object characteristic in relation to the object associated with the manipulation task. Further, the generating of the task command data may be further based on the object characteristic data.

In some embodiments, the object characteristic includes one or more of an object localization, an object classification, an arrangement of the object in relation to the environment, an object orientation, an object pose estimation and an occlusion associated with two or more objects.

In some embodiments, the environmental layout data includes an environmental semantic-segmentation data corresponding to a semantic segmentation of the environment associated with the robotic assistance device.

In some embodiments, the task plan data includes an appendage selection data corresponding to a selection associated with one or more of the two or more mechanical appendages in relation to the performing of the manipulation task.

In some embodiments, the task plan may data further includes a grip strategy data corresponding to a grip strategy in relation to the mechanical appendage which may be configured for performing the manipulation task.

In some embodiments, the surface in relation to the mobility includes one or more of an uneven floor surface and a carpeted floor surface.

In some embodiments, the housing module may further be configured to facilitate mountability of the robotic assistance device in relation to the surface.

In some embodiments, the surface in relation to the mountability includes one or more of a wall surface and a ceiling surface associated with the environment.

In some embodiments, the environment in relation to the mountability includes one or more of a kitchen environment and a workstation environment.

In some embodiments, the energy management unit may be configured to facilitate a wired power-operation. Further, the wired power-operation may be designed for an extended-use environment.

In some embodiments, the energy management unit includes a solar panel externally disposed on the housing unit. Further, the solar panel may be configured to facilitate the charging of the robotic assistance device. Further, the disposing of the solar panel may be associated with a well-lit environment.

In some embodiments, the charging dock headed mobility operation data includes a charger retrieval mobility operation data corresponding to a charger retrieval operation facilitating a retrieval of a charger from the housing unit. Further, the charger retrieval operation may be further configured to be performed by the mechanical appendage.

In some embodiments, the charging dock headed mobility operation data includes a charging outlet identification operation data corresponding to a charging outlet identification operation facilitating an identification of a charging outlet in relation to the environment. Further, the performing of the charging outlet identification operation may be further based on the detecting of the environmental parameter.

In some embodiments, the environmental parameter includes a charging outlet location in relation to the environment.

In some embodiments, the presentation device includes one or more of a heads-up display device and an augmented reality device.

In some embodiments, the gesture includes a sign language gesture corresponding to the gesture associated with a sign language.

In some embodiments, the sign language includes an American sign language.

In some embodiments, the robotic assistance device may further include a storage device which may be configured for storing the task-based training data.

In some embodiments, the sensor device includes a tactile sensor device which may be configured to be disposed on the tactile gripper. Further, the identifying of the object parameter may be further based on the tactile sensor device.

In some embodiments, the tactile sensor device includes one or more of a force sensor device and a contact sensor device. Further, the force sensor device may be configured for detecting a force in relation to the object during the performing of the manipulation task. Further, the contact sensor device may be configured for detecting a contact in relation to the object during the performing of the manipulation task.

In some embodiments, the robotic assistance device may further include a weight ballast configured for facilitating the lowering of the center-of-gravity associated with the robotic assistance device. Further, the weight ballast may further be configured to be housed within the housing unit. Further, the weight ballast may further be configured to be implemented using a dense material. Further, the dense material may comprise a metal-plate.

In some embodiments, the lowering of the center-of-gravity may further be configured for enhancing one or more of a tip-resistance and a stability associated with the robotic assistance device in relation to the performing of the manipulation task.

In some embodiments, the weight ballast may comprise an adjustable-weight ballast corresponding to the weight ballast configured to be adjusted in relation to one or more of the surface and a payload distribution associated with the robotic assistance device.

In some embodiments, the generating of the task command data may further be based on a ROS (Robot Operating System) framework.

In some embodiments, the task command data may comprise one or more of a sensor integration data, a mobility planning data and a nodular interaction data. Further, the sensor integration data may correspond to an integration of the sensor device in relation to the robotic assistance device. Further, the mobility planning data may represent a plan associated with the mobility of the robotic assistance device. Further, the nodular interaction data may correspond to an interaction in relation to two or more nodes comprised in the robotic assistance device.

In some embodiments, the ROS framework may be associated with a ROS tool configured for facilitating one or more of a visualization operation, a debugging operation, a simulation operation, and a management operation associated with the robotic assistance device.

In some embodiments, the ROS tool may comprise one or more of a ROS control and a ROS bag. Further, the ROS control may be configured for performing a hardware abstraction operation in relation to the robotic assistance device. Further, the ROS bag may be configured for facilitating a data logging operation associated with the robotic assistance device.

In some embodiments, the processing device may further be configured for generating a robot control logic data corresponding to a robot control logic associated with the robotic assistance device. Further, the performing of the manipulation task may further be based on the robot control logic data.

In some embodiments, the generating of the robot control logic data may be based on a middleware system. Further, the middleware system may comprise one or more of a YARP, an OROCOS and a genom3. Further, the YARP may be configured for facilitating a distributed communication within the two or more nodes associated with the robotic assistance device. Further, the OROCOS may be configured for facilitating a real-time control operation associated with the performing of the manipulation task. Further, the genom3 may be configured for facilitating a safety-critical operation associated with the robotic assistance device.

In some embodiments, the generating of the robot control logic data may be based on an industrial controller. Further, the industrial controller may comprise a programmable logic controller.

In some embodiments, the generating of the robot control logic data may be based on a custom stack associated with the robotic control device. Further, the custom stack may be associated with a programming library. Further, the programming library may comprise one or more of a MRPT library and a Rust-based framework library.

In some embodiments, the manipulation task may further comprise a self-cleanup task corresponding to a cleanup of the robotic assistance device. Further, the sensor device may comprise a dirt sensor device configured for detecting a dirt on each of the mechanical appendage and the housing unit. Further, the task command data may comprise a self-cleanup command data corresponding to the self-cleanup task. Further, the generating of the self-cleanup command data may be based on the dirt sensor device.

In some embodiments, the processing device may further be configured for generating a performance metric data corresponding to a performance metric associated with robotic assistance device in relation to the performance of the manipulation task.

In some embodiments, the performance metric data may comprise one or more of an internal metric data, a joint load data, a balance tracking data, a task execution data and a kinematic drift assessment data. Further, the internal metric data may correspond to an internal metric associated with the robotic assistance device. Further, the joint load data may correspond to a joint load associated with a joint within the mechanical appendage comprised in the robotic assistance device. Further, the balance tracking data may represent tracking of a balance in relation to the support associated with the housing unit. Further, the task execution data may represent the performance metric associated with the performance of the manipulation task. Further, the kinematic drift assessment data may correspond to a kinematic drift assessment in relation to the performing of the manipulation task.

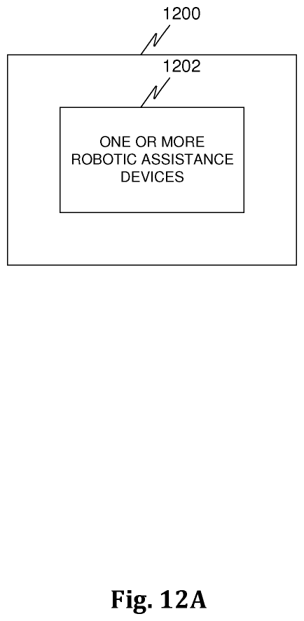

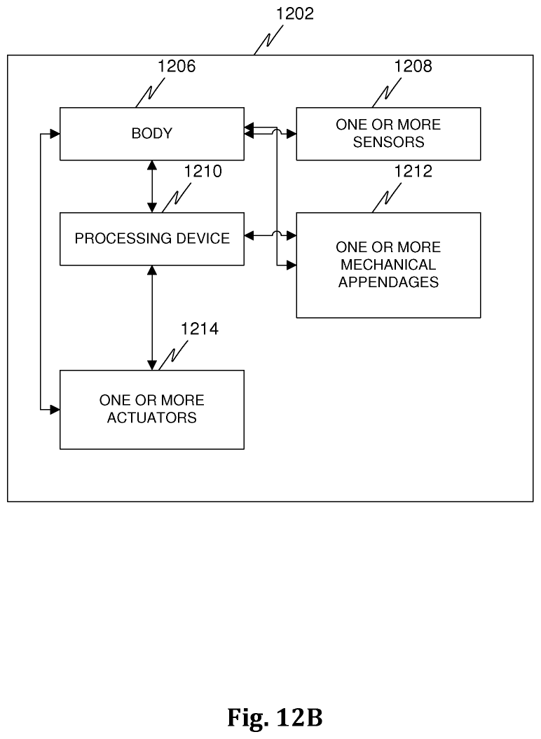

FIG. 12A and FIG. 12B illustrate a block diagram of a system 1200 for performing tasks using skill sharing, in accordance with some embodiments. Accordingly, the system 1200 may include one or more robotic assistance devices 1202. Further, one or more robotic assistance devices 1202 may include a body 1206. Further, one or more robotic assistance devices 1202 may include one or more sensors 1208 coupled to the body 1206. Further, the one or more sensors 1208 may be configured for detecting an environment of the one or more robotic assistance devices 1202. Further, one or more robotic assistance devices 1202 may include a processing device 1210 coupled to the body 1206. Further, the processing device 1210 may be communicatively coupled with the one or more sensors 1208. Further, the processing device 1210 may be further configured for obtaining one or more sensor inputs from the one or more sensors 1208. Further, the processing device 1210 may be further configured for obtaining one or more control logic data of one or more control logics associated with a task. Further, the processing device 1210 may be further configured for adapting the one or more control logic data based on the one or more sensor inputs. Further, the processing device 1210 may be further configured for generating a task command data associated with the task based on the adapting and the detecting. Further, one or more robotic assistance devices 1202 may include one or more mechanical appendages 1212 coupled to the body 1206. Further, the one or more mechanical appendages 1212 may be configured for performing one or more task operations associated with the task. Further, one or more robotic assistance devices 1202 may include one or more actuators 1214 coupled to the body 1206. Further, the one or more actuators 1214 may be operatively coupled with the one or more mechanical appendages 1212. Further, the one or more actuators 1214 may be configured for actuating the one or more mechanical appendages 1212 based on the task command data. Further, the performing of the one or more task operations may be based on the actuating of the one or more mechanical appendages 1212.

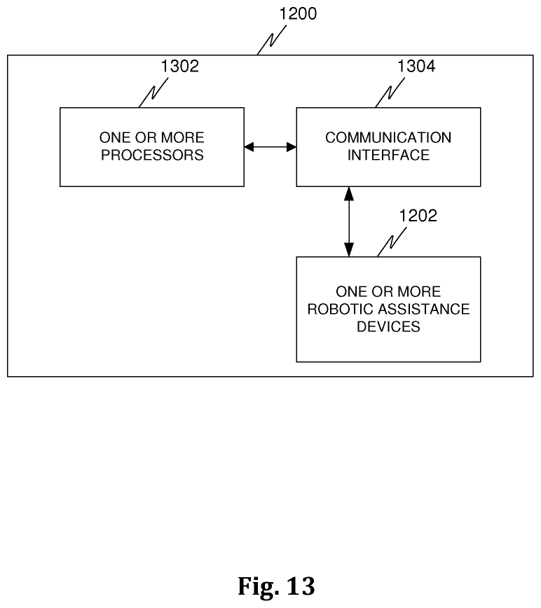

FIG. 13 illustrates a block diagram of the system 1200 for performing tasks using skill sharing, in accordance with some embodiments. Further, in some embodiments, the system 1200 further may include one or more processors 1302. Further, one or more processors 1302 may be configured for obtaining one or more inputs associated with the task from one or more sources. Further, one or more processors 1302 may be configured for analyzing the one or more inputs. Further, one or more processors 1302 may be configured for generating a skill data associated with a skill based on the analyzing of the one or more inputs. Further, the skill data includes the one or more control logic data associated with the one or more control logics. Further, the system 1200 further may include a communication interface 1304 communicatively coupled with the one or more processors 1302. Further, the communication interface 1304 may be configured for transmitting the skill data to the one or more robotic assistance devices 1202. Further, the obtaining of the one or more control logic data may be based on the transmitting of the skill data.

Further, in some embodiments, the processing device 1210 may be further configured for obtaining one or more requirements for the performing of the task based on the transmitting of the skill data. Further, the processing device 1210 may be further configured for performing one or more operations based on the one or more requirements. Further, the processing device 1210 may be further configured for determining a satisfaction of the one or more requirements based on the performing of the one or more operations. Further, the actuating of the one or more mechanical appendages 1212 may be further based on the satisfaction of the one or more requirements.

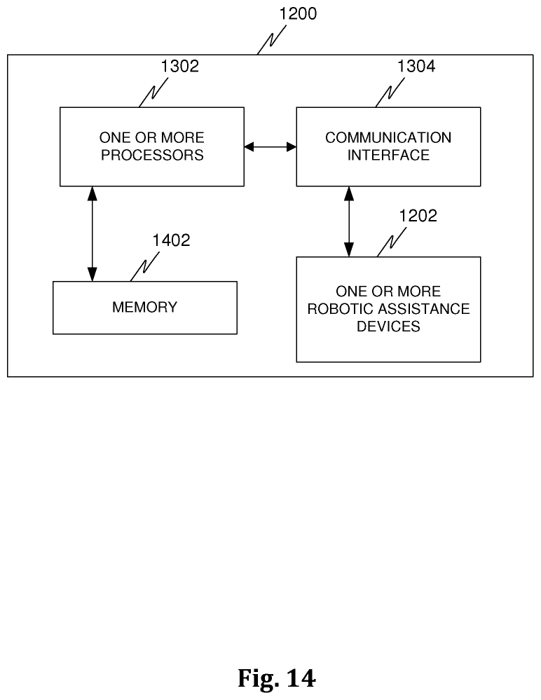

FIG. 14 illustrates a block diagram of the system 1200 for performing tasks using skill sharing, in accordance with some embodiments. In some embodiments, the system 1200 may further include a memory 1402 communicatively coupled with the one or more processors 1302. Further, the memory 1402 may be configured for storing, in association with a version of the skill data, an event log representing a time-ordered sequence of events and an event-log schema identifier defining fields, units, and semantics for entries in the event log. Further, the one or more processors 1302 may be further configured for generating the event log based on the one or more inputs. Further, the event log includes time-aligned events associated with one or more modalities selected from natural-language or narration, gesture input, teleoperation commands, assistive-input signals, augmented-reality authoring events, virtual-reality authoring events, virtual-world interaction events, and perception-derived object tracking or environment mapping.

In some embodiments, the system 1200 further includes a memory 1402 communicatively coupled with the one or more processors 1302. Further, in some embodiments, the memory 1402 may be configured for storing sensor data associated with the task, a structured task plan associated with the task, and one or more task-specific control logic artifacts associated with the task. Further, the one or more processors 1302 may be further configured for generating, based on the one or more inputs and the sensor 1208 data, the structured task plan representing the task. Further, the structured task plan includes one or more parameter slots. Further, the one or more processors 1302 may be further configured for generating, from the structured task plan, a task-specific control logic artifact executable for performing the task. Further, the one or more processors 1302 may be further configured for generating the skill data. Further, the skill data includes the task-specific control logic artifact.

Further, in some embodiments, the memory 1402 may be further configured for storing a recorded or streamed media asset, a time-aligned event trace associated with the recorded or streamed media asset, and a task representation derived from the time-aligned event trace. Further, the communication interface 1304 may be further configured for retrieving the recorded or streamed media asset from a remote content platform or a media repository. Further, the one or more processors 1302 may be further configured for extracting, from the recorded or streamed media asset, the time-aligned event trace. Further, the time-aligned event trace includes one or more of operator actions, object-state transitions, or step markers. Further, the memory 1402 may be further configured for storing a recorded or streamed media asset, a time-aligned event trace associated with the recorded or streamed media asset, and a task representation derived from the time-aligned event trace. Further, the one or more processors 1302 may be further configured for deriving, from the time-aligned event trace, the task representation. Further, the task representation includes explicit step sequencing and termination criteria. Further, the memory 1402 may be further configured for storing a recorded or streamed media asset, a time-aligned event trace associated with the recorded or streamed media asset, and a task representation derived from the time-aligned event trace. Further, the one or more processors 1302 may be further configured for generating the structured task plan based on the task representation.

In some embodiments, the system 1200 may further include a memory 1402 communicatively coupled with the one or more processors 1302. Further, the memory 1402 may be configured for storing one or more versions of the skill data, one or more patches or deltas associated with the one or more versions, and one or more build manifests associated with the one or more patches or deltas. Further, the one or more processors 1302 may be further configured for generating an update associated with the skill data. Further, the communication interface 1304 may be further configured for publishing the skill data to a version-controlled repository, retrieving the skill data from the version-controlled repository, and publishing the update associated with the skill data to the version-controlled repository. Further, publishing the update includes storing a patch or delta for transforming a parent version into a child version and storing, in association with the patch or delta, a build manifest comprising at least an input hash for the parent version, a target domain identifier, and an output hash for the child version.

In some embodiments, the memory 1402 may be further configured for storing a test protocol associated with the skill data, one or more success criteria associated with the test protocol, performance metric data associated with performance of the task, and one or more error classifications associated with an error taxonomy. Further, the one or more processors 1302 may be further configured for generating the performance metric data based on a comparison of one or more measured outcomes associated with performance of the task to the one or more success criteria. Further, the communication interface 1304 may be further configured for publishing, to the version-controlled repository, the update associated with the skill data. Further, the update includes one or more of an error classification selected from the error taxonomy, the patch or delta for transforming the parent version into the child version, or update to one or more parameter bindings or one or more parameter ranges. Further, the update indicates a promotion state or a demotion state for the child version and enables rollback to the parent version.

Further, in some embodiments, the memory 1402 may be further configured for storing successive versions of the skill data, aggregated performance metric data associated with the successive versions, one or more scores associated with the successive versions, one or more indications of convergence, and one or more freeze states associated with one or more parameter ranges. Further, the one or more processors 1302 may be further configured for iteratively analyzing performance of the task across two or more robotic assistance devices and generating one or more updates to the skill data to produce the successive versions. Further, the one or more processors 1302 may be further configured for assigning a score to one or more versions based on the aggregated performance metric data. Further, the one or more processors 1302 may be further configured for retroactively updating a score of a parent version based on descendant performance. Further, the one or more processors 1302 may be further configured for determining that one or more parameter ranges have converged based on changes between successive versions falling below a threshold. Further, a freeze state of the one or more freeze states requires elevated approval or elevated validation to modify a converged parameter range.

In some embodiments, the memory 1402 may be further configured for storing a parameter template corresponding to one or more parameters associated with the skill data, a simulation regression suite derived from one or more parameter ranges of the parameter template, and an evidence bundle associated with validation of the child version. Further, the one or more processors 1302 may be further configured for validating the child version using the simulation regression suite. Further, the simulation regression suite may be configured for emulating at least a portion of an environment of the one or more robotic assistance devices 1202 prior to publishing the child version as trusted or prior to transmitting the skill data for performance of the task by the one or more robotic assistance devices 1202. Further, the evidence bundle includes reproducibility metadata indicating one or more of a simulator identifier, a simulator version, a physics profile identifier, or a random seed value and a minimal reproduction bundle comprising at least a reduced scenario description and a trace segment which may be configured for reproducing a failure condition.

In some embodiments, the memory 1402 may be further configured for storing a safety policy associated with the task and one or more approval states associated with one or more steps of the task. Further, the one or more processors 1302 may be further configured for classifying one or more steps of the task as high-risk based on the safety policy. Further, the communication interface 1304 may be further configured for obtaining human approval prior to publishing a version of the skill data as trusted or prior to transmitting the skill data for performance of the one or more steps classified as high-risk.

In some embodiments, the system 1200 further includes a memory 1402 communicatively coupled with the processing device 1210. Further, in some embodiments, the memory 1402 may be configured for storing one or more gating policies associated with the skill data. Further, the processing device 1210 may be further configured for obtaining one of the one or more gating policies associated with the skill data. Further, the one or more requirements include one or more gating criteria associated with the one or more gating policies. Further, the processing device 1210 may be further configured for blocking the actuating of the one or more mechanical appendages 1212 unless the one or more gating criteria may be satisfied.

In some embodiments, the processing device 1210 may be further configured for performing a validation gate as one of the one or more operations. Further, the one or more gating criteria include one or more validation checks. Further, the one or more validation checks include at least two checks selected from parameter completeness, workspace reachability, collision checking, force limit checking, torque limit checking, end-effector compatibility checking, sensor availability checking, proximity-risk checking including detection of one or more people or animal within a safety envelope, pushback anomaly checking during commanded motion, resistance anomaly checking during commanded motion, and trajectory-safety checking.

Further, in some embodiments, the memory 1402 may be further configured for storing, in association with the skill data, an environment fingerprint or environment metadata describing at least a portion of an environment in which the skill data or the one or more control logics may be generated or validated, and a capability signature indicating one or more required execution capabilities. Further, the one or more processors 1302 may be further configured for generating the environment fingerprint based on one or more environment descriptors derived from the one or more sensor inputs. Further, the environment fingerprint includes a hashed representation of the one or more environment descriptors. Further, the one or more processors 1302 may be further configured for performing a conformance test as one of the one or more operations prior to the actuating of the one or more mechanical appendages 1212. Further, the conformance test blocks the actuating of the one or more mechanical appendages 1212 when a conformance test result indicates incompatibility with the capability signature.

Further, in some embodiments, the one or more robotic assistance devices 1202 include two or more robotic assistance devices. Further, the memory 1402 may be further configured for storing destination-local capability data, local state data, one or more subtasks associated with the structured task plan, one or more synchronization points associated with the one or more subtasks, and a coordination contract associated with the two or more robotic assistance devices. Further, the one or more processors 1302 may be further configured for decomposing the structured task plan into the one or more subtasks for cooperative performance by the two or more robotic assistance devices based on the destination-local capability data and the local state data. Further, the one or more processors 1302 may be further configured for defining the one or more synchronization points among the one or more subtasks. Further, the one or more processors 1302 may be further configured for applying the coordination contract. Further, the coordination contract specifies one or more policies for desynchronization or communication loss. Further, the processing device 1210 of each of the two or more robotic assistance devices may be further configured for performing a conformance check prior to activation of a subtask. Further, the conformance check verifies capability compatibility and safety constraints. Further, the performing of the one or more task operations includes cooperative performance of the one or more subtasks by the two or more robotic assistance devices under a shared safety envelope.

Further, in some embodiments, the one or more processors 1302 may be further configured for determining that a parameter slot of the structured task plan fails a confidence criterion based on one or more of an uncertainty measure associated with binding of the parameter slot or a disagreement among candidate bindings derived from different modalities of the one or more inputs and the sensor 1208 data. Further, the one or more processors 1302 may be further configured for generating a targeted clarification question corresponding to the parameter slot. Further, the one or more processors 1302 may be further configured for obtaining a clarification response. Further, the memory 1402 may be further configured for storing an updated binding associated with the parameter slot and a patch or delta associated with an updated task-specific control logic artifact. Further, the one or more processors 1302 may be further configured for generating the updated task-specific control logic artifact based on the clarification response and the patch or delta. Further, the processing device 1210 may be further configured for. Further, the one or more processors 1302 may be further configured for obtaining the updated task-specific control logic artifact. Further, the one or more processors 1302 may be further configured for performing a validation gate prior to the actuating of the one or more mechanical appendages 1212. Further, the one or more processors 1302 may be further configured for actuating the one or more mechanical appendages 1212 based on the updated task-specific control logic artifact when the validation gate may be satisfied.

Further, in some embodiments, the one or more sensors 1208 include at least two cameras mounted at different positions relative to the body 1206. Further, the memory 1402 may be further configured for storing one or more measured camera-position parameters associated with the at least two cameras and one or more parameter bindings associated with one or more parameter slots of the structured task plan. Further, the processing device 1210 may be further configured for obtaining image-space measurements from images captured by the at least two cameras. Further, the one or more sensors 1208 include at least two cameras mounted at different positions relative to the body 1206. Further, the processing device 1210 may be further configured for computing updated endpoint coordinates for the one or more mechanical appendages 1212 based on the image-space measurements and the one or more measured camera-position parameters. Further, the one or more sensors 1208 include at least two cameras mounted at different positions relative to the body 1206. Further, the processing device 1210 may be further configured for storing the updated endpoint coordinates as a parameter binding for a parameter slot of the structured task plan.

In some embodiments, the structured task plan includes at least one or more object/action pairs, one or more parameter ranges or tolerances, one or more safety criteria associated with one or more steps of the task, and one or more completion criteria associated with one or more steps of the task.

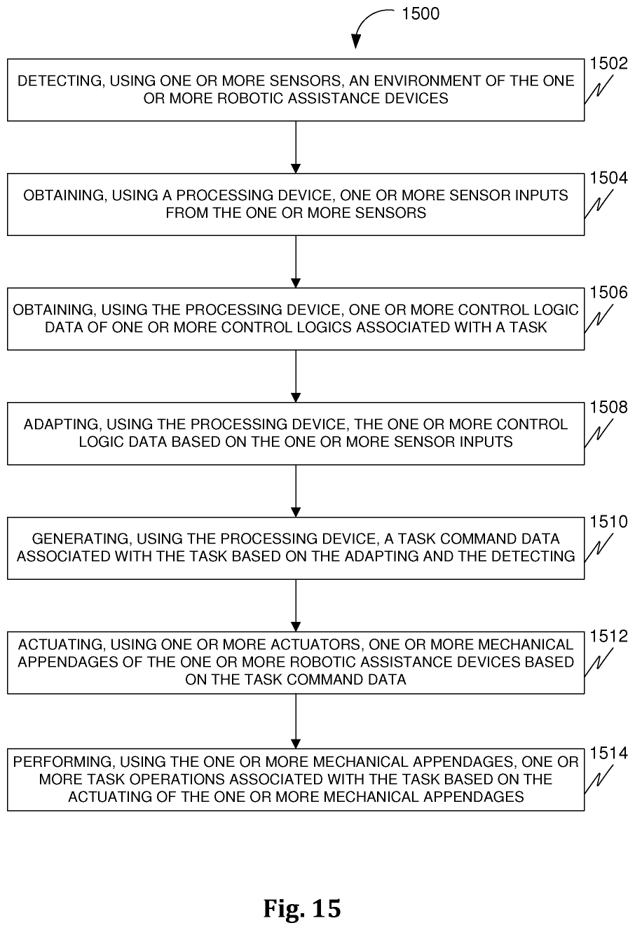

FIG. 15 illustrates a flowchart of a method 1500 for performing tasks using skill sharing, in accordance with some embodiments. Accordingly, the method 1500 may include a step 1502 of detecting, using one or more sensors 1208, an environment of the one or more robotic assistance devices 1202. Further, the method 1500 may include a step 1504 of obtaining, using a processing device 1210, one or more sensor inputs from the one or more sensors 1208. Further, the method 1500 may include a step 1506 of obtaining, using the processing device 1210, one or more control logic data of one or more control logics associated with a task. Further, the method 1500 may include a step 1508 of adapting, using the processing device 1210, the one or more control logic data based on the one or more sensor inputs. Further, the method 1500 may include a step 1510 of generating, using the processing device 1210, a task command data associated with the task based on the adapting and the detecting. Further, the method 1500 may include a step 1512 of actuating, using one or more actuators 1214, one or more mechanical appendages 1212 of the one or more robotic assistance devices 1202 based on the task command data. Further, the method 1500 may include a step 1514 of performing, using the one or more mechanical appendages 1212, one or more task operations associated with the task based on the actuating of the one or more mechanical appendages 1212.

The present disclosure provides a non-transitory computer-readable medium storing instructions for performing tasks using skill sharing. Further, the instructions, when executed by a processing device 1210 of one or more robotic assistance devices 1202, cause the processing device 1210 to obtain one or more sensor inputs from one or more sensors 1208 coupled to a body 1206 of the one or more robotic assistance devices 1202. Further, the one or more sensors 1208 may be configured for detecting an environment of the one or more robotic assistance devices 1202. Further, the instructions, when executed by a processing device 1210 of one or more robotic assistance devices 1202, cause the processing device 1210 to obtain one or more control logic data of one or more control logics associated with a task. Further, the instructions, when executed by a processing device 1210 of one or more robotic assistance devices 1202, cause the processing device 1210 to adapt the one or more control logic data based on the one or more sensor inputs. Further, the instructions, when executed by a processing device 1210 of one or more robotic assistance devices 1202, cause the processing device 1210 to generate task command data associated with the task based on the adapting and the detecting of the environment. Further, the instructions, when executed by a processing device 1210 of one or more robotic assistance devices 1202, cause the processing device 1210 to control one or more actuators 1214 coupled to the body 1206 and operatively coupled with one or more mechanical appendages 1212 coupled to the body 1206 to actuate the one or more mechanical appendages 1212 based on the task command data. Further, one or more task operations associated with the task may be performed based on the actuating of the one or more mechanical appendages 1212.

Although the invention has been explained in relation to its preferred embodiment, it is to be understood that many other possible modifications and variations can be made without departing from the spirit and scope of the invention as hereinafter claimed.

What is claimed is:

1. A system for performing tasks using skill sharing, the system comprising:
one or more robotic assistance devices comprising:
a body;
one or more sensors coupled to the body, wherein the one or more sensors are configured for detecting an environment of the one or more robotic assistance devices;
a processing device coupled to the body, wherein the processing device is communicatively coupled with the one or more sensors, wherein the processing device is further configured for:
obtaining one or more sensor inputs from the one or more sensors;
obtaining one or more control logic data of one or more control logics associated with a task;
adapting the one or more control logic data based on the one or more sensor inputs; and
generating a task command data associated with the task based on the adapting and the detecting;
one or more mechanical appendages coupled to the body, wherein the one or more mechanical appendages are configured for performing one or more task operations associated with the task; and
one or more actuators coupled to the body, wherein the one or more actuators are operatively coupled with the one or more mechanical appendages, wherein the one or more actuators are configured for actuating the one or more mechanical appendages based on the task command data, wherein the performing of the one or more task operations is based on the actuating of the one or more mechanical appendages.

2. The system of claim 1 further comprising:
one or more processors configured for:
obtaining one or more inputs associated with the task from one or more sources;
analyzing the one or more inputs; and
generating a skill data associated with a skill based on the analyzing of the one or more inputs, wherein the skill data comprises the one or more control logic data associated with the one or more control logics; and
a communication interface communicatively coupled with the one or more processors, wherein the communication interface is configured for transmitting the skill data to the one or more robotic assistance devices, wherein the obtaining of the one or more control logic data is based on the transmitting of the skill data.

3. The system of claim 2, wherein the processing device is further configured for:
obtaining one or more requirements for the performing of the task based on the transmitting of the skill data;
performing one or more operations based on the one or more requirements; and
determining a satisfaction of the one or more requirements based on the performing of the one or more operations, wherein the actuating of the one or more mechanical appendages is further based on the satisfaction of the one or more requirements.

4. The system of claim 2 further comprising a memory communicatively coupled with the one or more processors, wherein the memory is configured for storing, in association with a version of the skill data, an event log representing a time-ordered sequence of events and an event-log schema identifier defining fields, units, and semantics for entries in the event log, wherein the one or more processors are further configured for generating the event log based on the one or more inputs, wherein the event log comprises time-aligned events associated with at least one modality selected from natural-language or narration, gesture input, teleoperation commands, assistive-input signals, augmented-reality authoring events, virtual-reality authoring events, virtual-world interaction events, and perception-derived object tracking or environment mapping.

5. The system of claim 2 further comprising a memory communicatively coupled with the one or more processors, wherein the memory is configured for storing sensor data associated with the task, a structured task plan associated with the task, and one or more task-specific control logic artifacts associated with the task; wherein the one or more processors are further configured for:
generating, based on the one or more inputs and the sensor data, the structured task plan representing the task, wherein the structured task plan comprises one or more parameter slots;
generating, from the structured task plan, a task-specific control logic artifact executable for performing the task; and generating the skill data, wherein the skill data comprises the task-specific control logic artifact.

6. The system of claim 5, wherein the memory is further configured for storing a recorded or streamed media asset, a time-aligned event trace associated with the recorded or streamed media asset, and a task representation derived from the time-aligned event trace; wherein the communication interface is further configured for retrieving the recorded or streamed media asset from a remote content platform or a media repository, wherein the one or more processors are further configured for:
extracting, from the recorded or streamed media asset, the time-aligned event trace, wherein the time-aligned event trace comprises at least one of operator actions, object-state transitions, or step markers;
deriving, from the time-aligned event trace, the task representation, wherein the task representation comprises explicit step sequencing and termination criteria; and
generating the structured task plan based on the task representation.

7. The system of claim 2 further comprising a memory communicatively coupled with the one or more processors, wherein the memory is configured for storing one or more versions of the skill data, one or more patches or deltas associated with the one or more versions, and one or more build manifests associated with the one or more patches or deltas, wherein the one or more processors are further configured for generating an update associated with the skill data, wherein the communication interface is further configured for publishing the skill data to a version-controlled repository, retrieving the skill data from the version-controlled repository, and publishing the update associated with the skill data to the version-controlled repository, wherein publishing the update comprises storing a patch or delta for transforming a parent version into a child version and storing, in association with the patch or delta, a build manifest comprising at least an input hash for the parent version, a target domain identifier, and an output hash for the child version.

8. The system of claim 7, wherein the memory is further configured for storing a test protocol associated with the skill data, one or more success criteria associated with the test protocol, performance metric data associated with performance of the task, and one or more error classifications associated with an error taxonomy, wherein the one or more processors are further configured for generating the performance metric data based on a comparison of one or more measured outcomes associated with performance of the task to the one or more success criteria, wherein the communication interface is further configured for publishing, to the version-controlled repository, the update associated with the skill data, wherein the update comprises at least one of an error classification selected from the error taxonomy, the patch or delta for transforming the parent version into the child version, or update to at least one parameter binding or at least one parameter range, wherein the update indicates a promotion state or a demotion state for the child version and enables rollback to the parent version.

9. The system of claim 8, wherein the memory is further configured for storing successive versions of the skill data, aggregated performance metric data associated with the successive versions, one or more scores associated with the successive versions, one or more indications of convergence, and one or more freeze states associated with one or more parameter ranges, wherein the one or more processors are further configured for:
iteratively analyzing performance of the task across a plurality of robotic assistance devices and generating one or more updates to the skill data to produce the successive versions;
assigning a score to at least one version based on the aggregated performance metric data;
retroactively updating a score of a parent version based on descendant performance; and
determining that one or more parameter ranges have converged based on changes between successive versions falling below a threshold, wherein a freeze state of the one or more freeze states requires elevated approval or elevated validation to modify a converged parameter range.

10. The system of claim 8, wherein the memory is further configured for storing a parameter template corresponding to one or more parameters associated with the skill data, a simulation regression suite derived from one or more parameter ranges of the parameter template, and an evidence bundle associated with validation of the child version, wherein the one or more processors are further configured for validating the child version using the simulation regression suite, wherein the simulation regression suite is configured for emulating at least a portion of an environment of the one or more robotic assistance devices prior to publishing the child version as trusted or prior to transmitting the skill data for performance of the task by the one or more robotic assistance devices, wherein the evidence bundle comprises reproducibility metadata indicating at least one of a simulator identifier, a simulator version, a physics profile identifier, or a random seed value and a minimal reproduction bundle comprising at least a reduced scenario description and a trace segment configured for reproducing a failure condition.

11. The system of claim 8, wherein the memory is further configured for storing a safety policy associated with the task and one or more approval states associated with one or more steps of the task, wherein the one or more processors are further configured for classifying at least one step of the task as high-risk based on the safety policy, wherein the communication interface is further configured for obtaining human approval prior to publishing a version of the skill data as trusted or prior to transmitting the skill data for performance of the at least one step classified as high-risk.

12. The system of claim 3 further comprising a memory communicatively coupled with the processing device, wherein the memory is configured for storing one or more gating policies associated with the skill data, wherein the processing device is further configured for:
obtaining one of the one or more gating policies associated with the skill data, wherein the one or more requirements comprise one or more gating criteria associated with the one or more gating policies; and
blocking the actuating of the one or more mechanical appendages unless the one or more gating criteria are satisfied.

13. The system of claim 12, wherein the processing device is further configured for performing a validation gate as one of the one or more operations, wherein the one or more gating criteria comprise one or more validation checks, wherein the one or more validation checks comprise at least two checks selected from parameter completeness, workspace reachability, collision checking, force limit checking, torque limit checking, end-effector compatibility checking, sensor availability checking, proximity-risk checking including detection of at least one person or animal within a safety envelope, pushback anomaly checking during commanded motion, resistance anomaly checking during commanded motion, and trajectory-safety checking.

14. The system of claim 12, wherein the memory is further configured for storing, in association with the skill data, an environment fingerprint or environment metadata describing at least a portion of an environment in which the skill data or the one or more control logics are generated or validated, and a capability signature indicating one or more required execution capabilities, wherein the one or more processors are further configured for:
generating the environment fingerprint based on one or more environment descriptors derived from the one or more sensor inputs, wherein the environment fingerprint comprises a hashed representation of the one or more environment descriptors; and
performing a conformance test as one of the one or more operations prior to the actuating of the one or more mechanical appendages, wherein the conformance test blocks the actuating of the one or more mechanical appendages when a conformance test result indicates incompatibility with the capability signature.

15. The system of claim 5, wherein the one or more robotic assistance devices comprise a plurality of robotic assistance devices, wherein the memory is further configured for storing destination-local capability data, local state data, one or more subtasks associated with the structured task plan, one or more synchronization points associated with the one or more subtasks, and a coordination contract associated with the plurality of robotic assistance devices, wherein the one or more processors are further configured for:
decomposing the structured task plan into the one or more subtasks for cooperative performance by the plurality of robotic assistance devices based on the destination-local capability data and the local state data;
defining the one or more synchronization points among the one or more subtasks; and
applying the coordination contract, wherein the coordination contract specifies at least one policy for desynchronization or communication loss, wherein the processing device of each of the plurality of robotic assistance devices is further configured for performing a conformance check prior to activation of a subtask, wherein the conformance check verifies capability compatibility and safety constraints, wherein the performing of the one or more task operations comprises cooperative performance of the one or more subtasks by the plurality of robotic assistance devices under a shared safety envelope.

16. The system of claim 5, wherein the one or more processors are further configured for:
determining that a parameter slot of the structured task plan fails a confidence criterion based on at least one of an uncertainty measure associated with binding of the parameter slot or a disagreement among candidate bindings derived from different modalities of the one or more inputs and the sensor data;
generating a targeted clarification question corresponding to the parameter slot; and
obtaining a clarification response, wherein the memory is further configured for storing an updated binding associated with the parameter slot and a patch or delta associated with an updated task-specific control logic artifact, wherein the one or more processors are further configured for generating the updated task-specific control logic artifact based on the clarification response and the patch or delta, wherein the processing device is further configured for:
obtaining the updated task-specific control logic artifact;
performing a validation gate prior to the actuating of the one or more mechanical appendages; and
actuating the one or more mechanical appendages based on the updated task-specific control logic artifact when the validation gate is satisfied.

17. The system of claim 5, wherein the one or more sensors comprise at least two cameras mounted at different positions relative to the body, wherein the memory is further configured for storing one or more measured camera-position parameters associated with the at least two cameras and one or more parameter bindings associated with one or more parameter slots of the structured task plan, wherein the processing device is further configured for:
obtaining image-space measurements from images captured by the at least two cameras;
computing updated endpoint coordinates for the one or more mechanical appendages based on the image-space measurements and the one or more measured camera-position parameters; and
storing the updated endpoint coordinates as a parameter binding for a parameter slot of the structured task plan.

18. The system of claim 5, wherein the structured task plan comprises at least one or more object/action pairs, one or more parameter ranges or tolerances, one or more safety criteria associated with at least one step of the task, and one or more completion criteria associated with at least one step of the task.

19. A method for performing tasks using skill sharing, the method comprising:
detecting, using one or more sensors, an environment of one or more robotic assistance devices;
obtaining, using a processing device, one or more sensor inputs from the one or more sensors;
obtaining, using the processing device, one or more control logic data of one or more control logics associated with a task;
adapting, using the processing device, the one or more control logic data based on the one or more sensor inputs;
generating, using the processing device, task command data associated with the task based on the adapting and the detecting;
actuating, using one or more actuators, one or more mechanical appendages of the one or more robotic assistance devices based on the task command data; and
performing, using the one or more mechanical appendages, one or more task operations associated with the task based on the actuating of the one or more mechanical appendages.

20. A non-transitory computer-readable medium storing instructions for performing tasks using skill sharing, wherein the instructions, when executed by a processing device of one or more robotic assistance devices, cause the processing device to:
obtain one or more sensor inputs from one or more sensors coupled to a body of the one or more robotic assistance devices, wherein the one or more sensors are configured for detecting an environment of the one or more robotic assistance devices;
obtain one or more control logic data of one or more control logics associated with a task;
adapt the one or more control logic data based on the one or more sensor inputs;
generate task command data associated with the task based on the adapting and the detecting of the environment; and
control one or more actuators coupled to the body and operatively coupled with one or more mechanical appendages coupled to the body to actuate the one or more mechanical appendages based on the task command data, wherein one or more task operations associated with the task are performed based on the actuating of the one or more mechanical appendages.
